(19) United States
(12) Patent Application Publication
(10) Pub. No.: US 2015/0052058 A1
(43) Pub. Date: Feb. 19, 2015

(54) Auction for medical image diagnostic services

(71) Applicants: John Samuel McCown, Florence, SC (US); James Edward Munn, Florence, SC (US)

(72) Inventors: John Samuel McCown, Florence, SC (US); James Edward Munn, Florence, SC (US)

(21) Appl. No.: 13/987,656

(22) Filed: Aug. 19, 2013

(51) Int. Cl. G06Q 50/22; G06Q 10/06; G06F 19/00; G06Q 30/08

(52) U.S. Cl. CPC G06Q 50/22; G06Q 30/08; G06Q 10/063114; G06F 19/321
USPC 705/51; 705/2

(57) ABSTRACT

A medical image interpretation services system and method is disclosed. The system or method determines a calculated workload based on reference workload values for the medical procedure codes associated with the medical image exams that a medical image interpreter has already won or has a probability of winning. The system or method can prevent a medical image interpreter (such as a radiologist, a pathologist, or a dermatologist) from bidding if the calculated workload exceeds workload limits set by the medical image interpreter or set by the system.

This application is related to U.S. Provisional Patent Application Ser. No. 61/742,838, filed 20 Aug. 2012, which is incorporated herein by reference.

### FIELD OF INVENTION

This invention relates to computer-based client-server business processes transacted between medical professionals and medical facilities wherein the processes include an auction for services, the processes are typically transacted over the internet, and the processes are typically transacted between medical professionals such as radiologists, pathologists, and dermatologists who provide medical image interpretation services and medical facilities such as hospitals, medical imaging centers, and doctors offices that produce images such as x-ray images, digital radiography images, ultrasound images, magnetic resonance images, positron emission tomography images, computed tomography images, endoscopy images, mammograms, nuclear medical images, computed radiography images, and digital photos. The medical facilities contract with the medical professionals to read/interpret these images.

### BACKGROUND OF THE DISCLOSURE

In most cases in the USA, radiologic interpretations of medical images are performed exclusively by qualified credentialed physicians contracted with a specific medical facility, such as a hospital, medical group practice, individual physician, or medical imaging facility. Even in large hospitals, only a limited level of sub specialization can be achieved since each provider has access to a limited number of studies within an area of sub specialization. Tele medicine is typically only used when there is no qualified credentialed provider on-site. With the increasing capacity of broadband internet communications, standardization of the interface between healthcare computer systems (Digital Imaging and Communications in Medicine (DICOM) standard), and similarity of and standardization of credentialing of medical professionals (such as certification by The Joint Commission-formerly JCAHO), cloud-based computer systems could be used so that providers can share work across a wider network. By exposing qualified physicians to a larger pool of available work, these qualified physicians could sub specialize to a greater degree, which can improve healthcare quality. Also, the current medical practice can lead to highly variable charges for services, even within a facility dependent upon rates that have been contracted by the US government, individual insurance companies, and other contracting parties. A cloud-based system could be built to auction medical services and goods, which can standardize pricing and drive down costs while improving quality through sub specialization.

It is desired to have an internet-based auction system that matches medical facilities (such as hospitals, imaging centers, and physician offices) with medical providers through an online bidding process. The server for this system could interface with medical providers through a client-server architecture in which the client computers could be computers or mobile devices, these computers or mobile devices could use web browsers or application programs (apps), and the connection between server and client could be an internet connection. It would be desirable if the server for this system was interfaced with a distribution system such as a cloud hosted PACS (picture archiving and communication system) that distributes the images to qualified professionals that have signed up to use the system. The system could then receive information about studies (medical image exams) from the PACS and this information about studies (medical image exam meta data) to qualified credentialed professionals (such as radiologists) for competitive bidding. These qualified certified professionals could then bid on single or multiple medical image exams at once. Once a medical image exam is auctioned, the auction system could assign the medical image exam to the qualified certified professional within the distribution system. In the case of radiology, the radiologist is the qualified certified professional, who can interpret the images and sign the report in a specified time. The specified time is different based on the priority (such as stat, ASAP, routine) of each medical image exam. Once the radiologist has interpreted a medical image exam, this interpretation can be transcribed and included as part of the information associated with the medical image exam. After the radiologist signs the report on the PACS, the web-based auction server can bill the facility for the interpretation. The web-based auction server can then pay the qualified certified professional after receiving payment from the medical facility. By providing a system where providers can work together in a vastly larger network, a level of sub specialization not currently available can be achieved and the cost for these services can be markedly lowered through competitive bidding. Such a system could markedly improve quality, while at same time lowering the costs for medical services. In addition, even rural medical facilities can achieve a level of quality for these services surpassing what is available today in even much larger medical facilities.

### BRIEF DESCRIPTION OF THE DRAWINGS

The present invention can be better understood on reading the following detailed description of non-limiting embodiments thereof, and on examining the accompanying drawings, in which:

FIG. 1 shows a PACS attached to a medical image interpretation services auction management system;

FIG. 2 illustrates workflow in the database of the auction management system;

FIG. 3 shows interfaces for typical users of a medical image interpretation services auction management system;

FIG. 4 shows user access levels and permissions for a medical image interpretation services auction management system;

FIG. 5 shows how a purchasing facility can control service provider access to purchasing facility data in an the auction management system;

FIG. 6 shows how a service provider (reader/interpreter of medical images) can control purchasing facility access to their service provider data in an auction management system;

FIG. 7 illustrates an auction process flow and logic;

FIG. 8 illustrates a multi bid process flow and logic;

FIG. 9 depicts programming namespaces in the auction management system;

FIG. 10 shows the tasks performed by a PACS engine;

FIG. 11 shows the tasks performed by an exchange engine;

FIG. 12 shows the tasks performed by a multibid engine;

FIG. 13 shows the tasks performed by of a work engine;

FIG. 14 shows the workflow logic for problem reporting;

FIG. 15 shows a Signup process;

FIG. 16 shows a “Signup—Register” screen;

FIG. 17 shows a “Signup: Verify Email” screen;

FIG. 18 shows a “Signup: Email Verified” screen;

FIG. 19 shows a “Reader: Create Profile” screen;

FIG. 20 shows a “Facility: Create Profile” screen;

FIG. 21 shows an “Account: Login” screen;

FIG. 22 shows an “Account: Change Password” screen;

FIG. 23 shows an “Account: Change Password Success” screen;

FIG. 24 shows a “Live Exchange” screen;

FIG. 25 shows a “Live Exchange: Bid” screen;

FIG. 26 shows “Filters for Reader” screen;

FIG. 27 illustrates how to create a multibid job to prevent having to place single bids;

FIG. 28 shows a “My Bid Status: Summary” screen;

FIG. 29 shows a “My Bid Status: Active” screen;

FIG. 30 shows a “My Bid Status: Won” screen;

FIG. 31 shows a “My Bid Status: Won: Report a Problem” screen;

FIG. 32 shows a “My Bid Status: Finalized” screen;

FIG. 33 shows a “Settings: General” screen;

FIG. 34 shows a “Settings: General: Edit RVU” screen;

FIG. 35 shows a “Settings: General: Increase Call Reports CR” screen;

FIG. 36 shows a “Settings: General: Increase Call Reports Non CR: screen;

FIG. 37 shows a “Settings: Bid Settings” screen;

FIG. 38 shows a “Settings: Multibid Job” screen;

FIG. 39 shows a “Settings: Imaging Centers” screen;

FIG. 40 shows a “Profile: Contact Info” screen;

FIG. 41 shows a “Profile: Certification/Education” screen;

FIG. 42 shows a “Profile: Certification/Education: Add Education” screen;

FIG. 43 shows a “Profile: Certification/Education: Edit Education” screen;

FIG. 44 shows a “Profile: Certification/Education: Edit ABR Certification” screen;

FIG. 45 shows a “Profile: Certification/Education: Edit other” screen;

FIG. 46 shows a “Profile: State Licenses” screen;

FIG. 47 shows a “Profile: State Licenses: Add New License” screen;

FIG. 48 shows a “Profile: State Licenses: Edit License” screen;

FIG. 49 shows a “Profile: Malpractice Insurance” screen;

FIG. 50 shows a “Profile: Malpractice Insurance: Add New Insurance” screen;

FIG. 51 shows a “Profile: Malpractice Insurance: Edit Insurance” screen;

FIG. 52 shows an “Our Studies” screen;

FIG. 53 shows a “Facility Filters” screen;

FIG. 54 shows a “Check Study Status” screen;

FIG. 55 shows a “Settings: Auction Times” screen;

FIG. 56 shows a “Settings: Auction Amounts” screen;

FIG. 57 shows a “Settings: Readers” screen for managing medical image interpreters;

FIG. 58 shows a “Settings: Users” screen;

FIG. 59 shows a “Profile: State Licenses: Add New License” screen;

FIG. 60 shows a “Profile: Contact Info” screen;

FIG. 61 shows a “Profile: Contact Info: Edit Facility” screen;

FIG. 62 shows a “Profile: Contact Info: Edit Admin” screen;

FIG. 63 shows a “Profile: Billing” screen;

FIG. 64 shows a “Profile: Billing: Edit” screen;

FIG. 65 shows an “Accounting” screen;

FIG. 66 shows an “Administration: Quality Control” screen;

FIG. 67 shows an “Administration: Reader Fee Schedule” screen;

FIG. 68 shows an “Administration: IC Fee Schedule” screen;

FIG. 69 shows an “Administration: Check Study Status: screen;

FIG. 70 shows an “Accounting: Reader” screen;

FIG. 71 shows an “Accounting: IC” screen;

FIG. 72 shows a “General: Workload” screen;

FIG. 73 shows a “General: Readers” screen;

FIG. 74 shows a “General: Facilities” screen;

FIG. 75 shows a “General: Codes” screen; and

FIG. 76 shows a “General: Custom Codes: screen.

It should be understood that the drawings are not necessarily to scale. In certain instances, details that are not necessary for an understanding of embodiments of the invention or that render other details difficult to perceive may have been omitted. It should be understood that the invention is not necessarily limited to the particular embodiments illustrated herein.

### DETAILED DESCRIPTION OF THE PREFERRED EMBODIMENT

In the following description, specific details are set forth in order to provide a clear and thorough understanding of embodiments of the invention. Preferred embodiments of the present invention are illustrated in the Figures, like numerals being used to refer to like and corresponding parts of the various drawings. The examples and Figures displayed hereafter are to illustrate the different functionalities associated with the invention, and demonstrate the extent by which the invention can be implemented. One purpose of the invention is to provide a computer implemented client-server based system and method for auctioning and managing medical exams. These medical image exams can also be called medical exams, exams, medical studies, and studies. Medical image exams can include reports prepared by a medical image examiner and these reports can also be called readings or medical image interpretations, and can include medical diagnoses. One embodiment of the invention allows for the auction of medical image interpretation services. Radiologists, pathologists, and dermatologists, as well as other medical personnel could provide these image interpretation services. The images to be interpreted could include x-ray images, digital radiography images, ultrasound images, magnetic resonance images, positron emission tomography images, computed tomography images, endoscopy images, mammograms, nuclear medicine images, computed radiography images, and digital photos. Such an auction system or method could also be used for other medical exams as well as auctioning other medical or non-medical services (such as other professional services) or goods. The server for this system could interface with medical providers through a client-server architecture in which the client computers could be computers or mobile devices, these computers or mobile devices could use web browsers or application programs (apps), and the connection between server and client could be an internet connection.

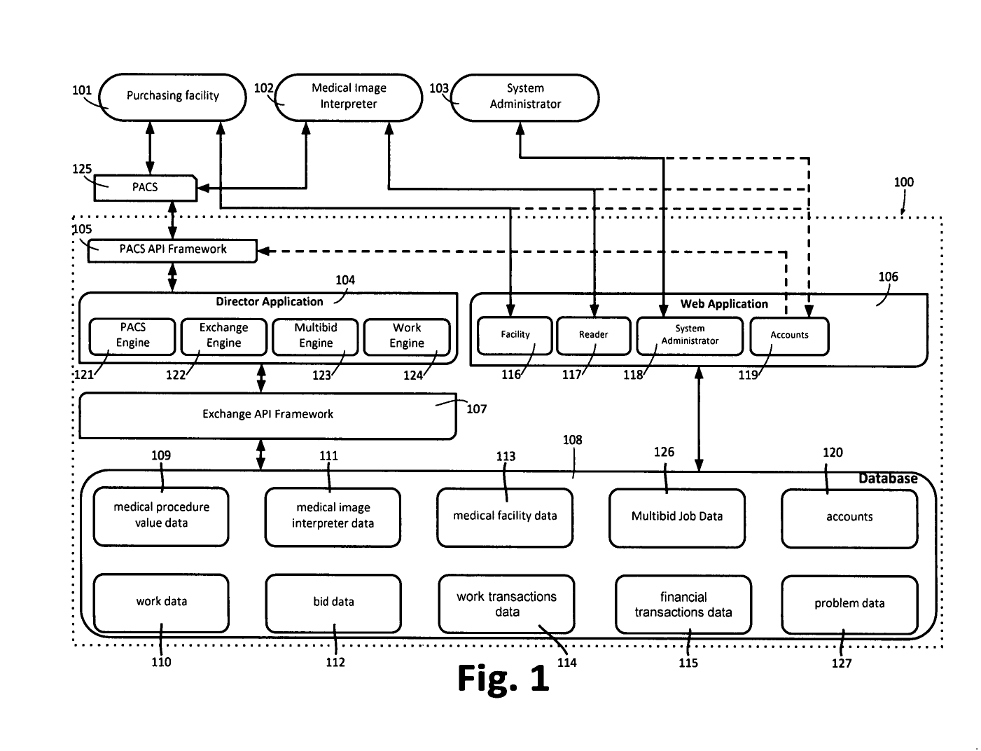

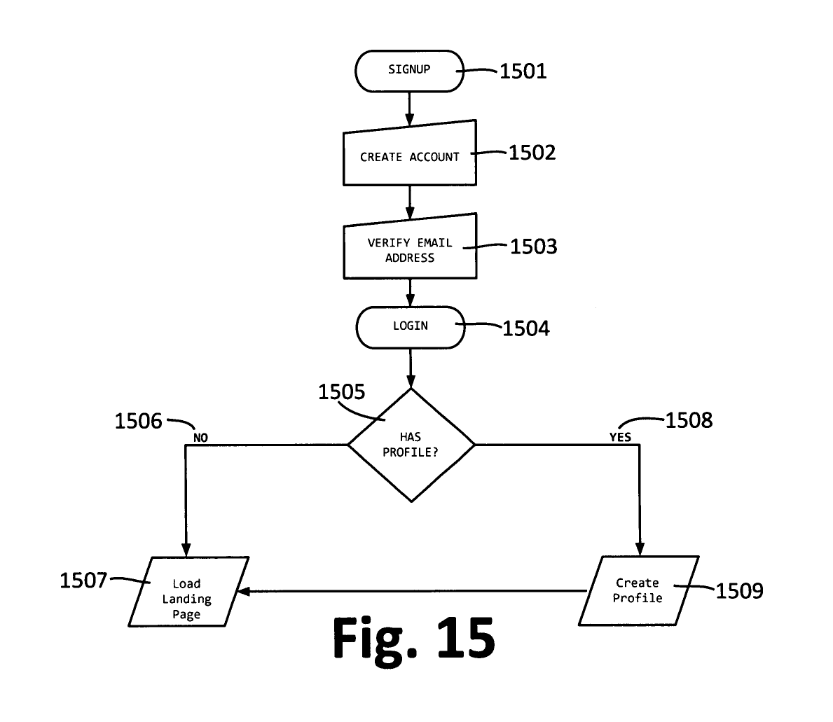

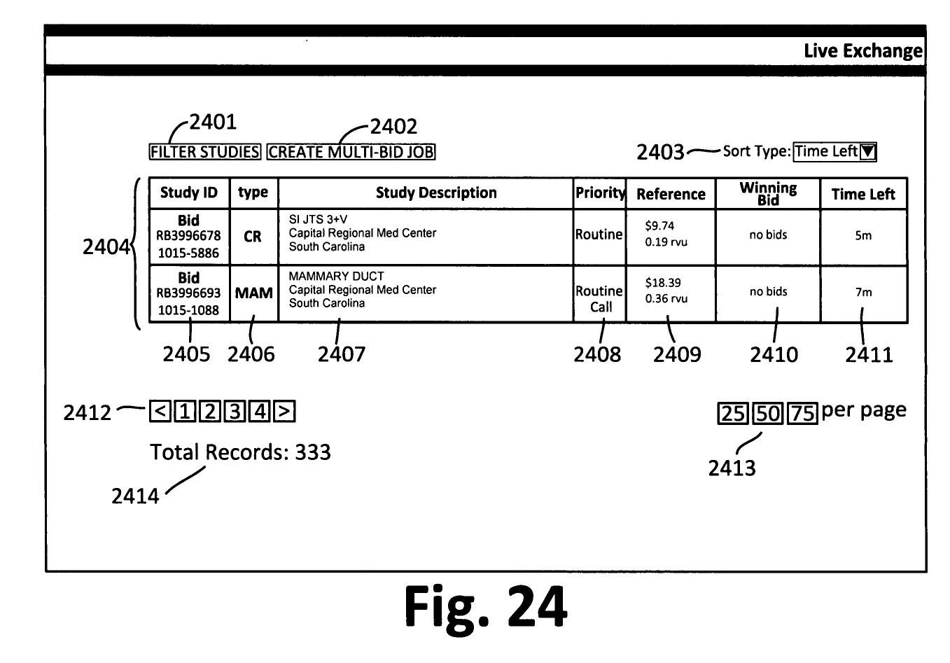

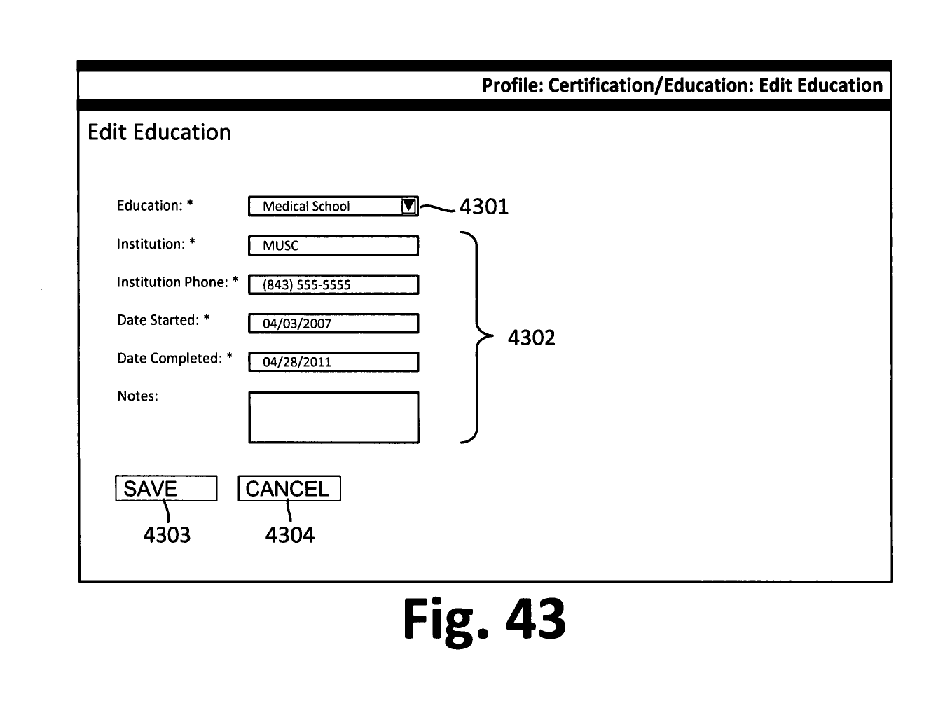

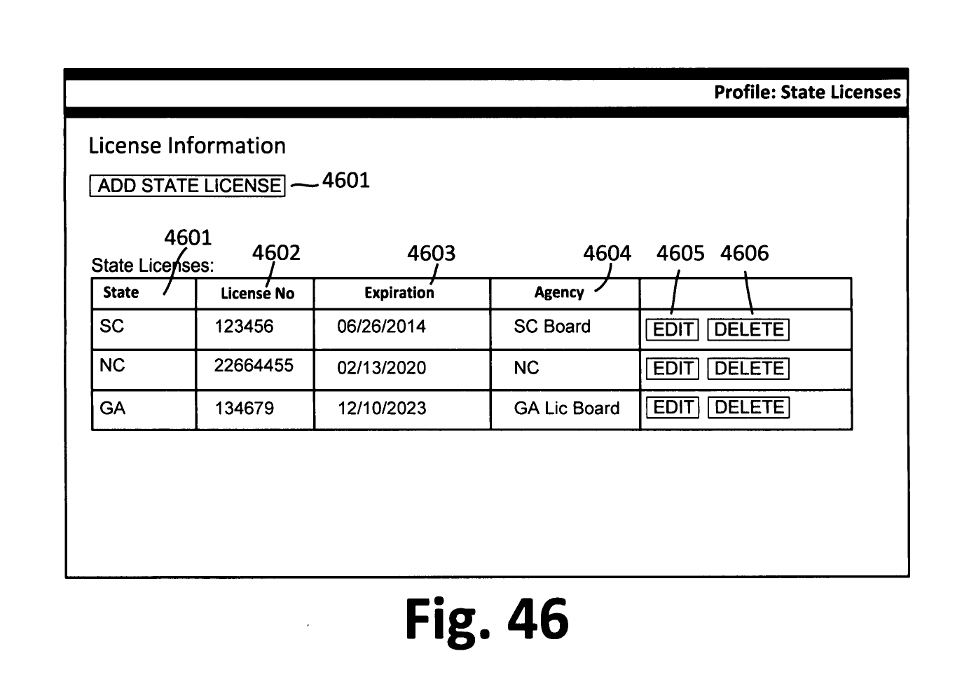

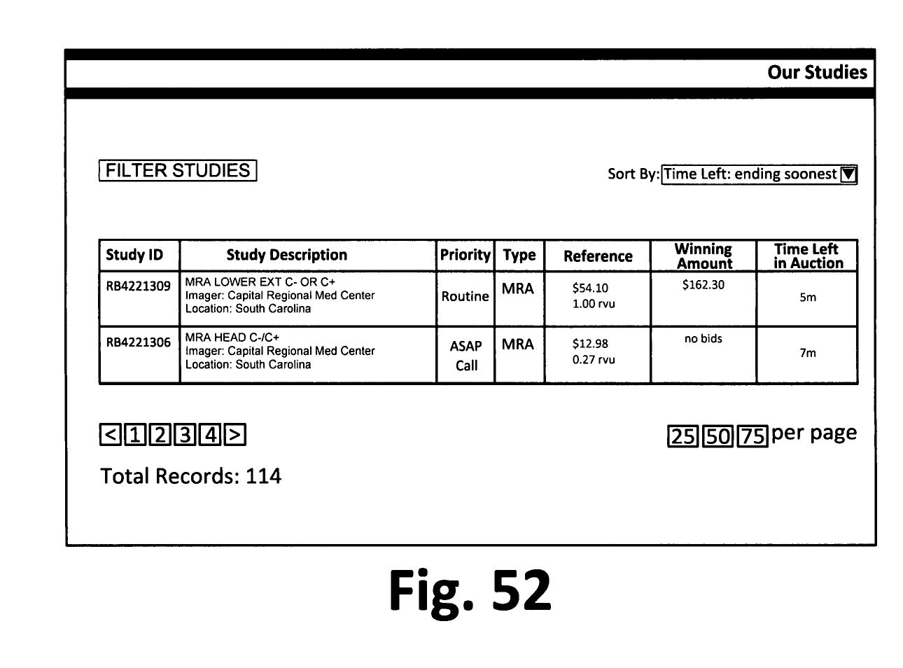

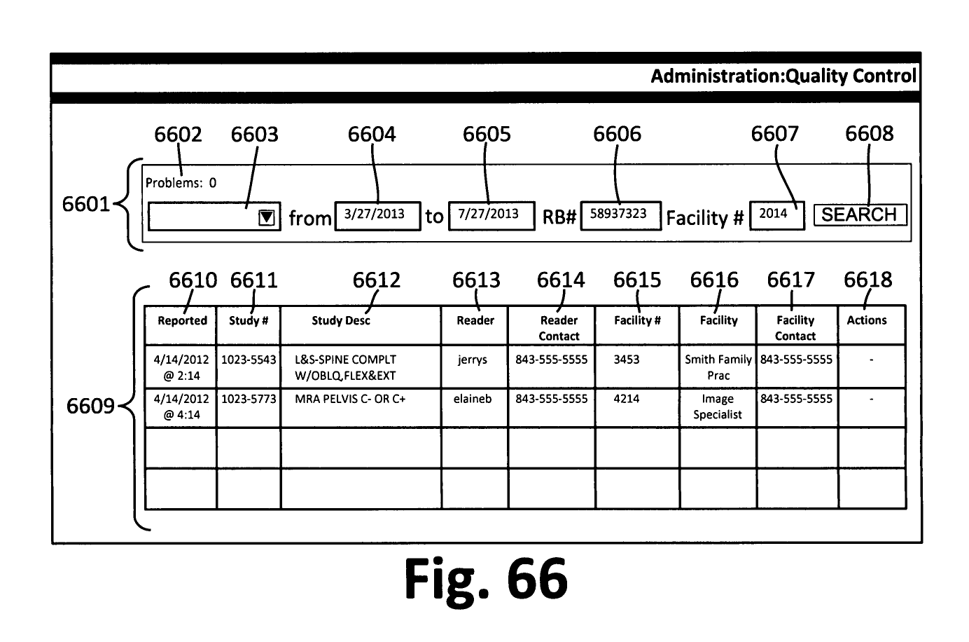

The computer functionality of the system and method is described in FIGS. 1 through 14. The sign-up screens are described in FIGS. 15 through 23. Embodiments of the present invention can have interfaces to three main types of users:
(a) medical professionals providing the services, who are typically physicians and who can also be referred to as readers or medical image interpreters, the web interface functionality for which is described with reference to FIGS. 24 through 51;
(b) technologists and facility administrators or other personnel who work for a medical facility that purchases the services from the medical professionals by submitting studies, (medical image exams) the web interface functionality for which is described with reference to FIGS. 52 through 65; and
(c) system administrators who manage the overall administration of the system or method as described with reference to FIGS. 66 through 76.

FIG. 1 shows an embodiment of a medical image interpretation services auction management system at 100. The auction management system 100 comprises a director application 104, a web application 106, and a database 108. The web application 106 connects directly to the database 108. The director application 104 connects to the database 108 through an exchange Application Programming Interface (API) framework 107. Typical users of the system include purchasing facilities 101, medical image interpreters (readers) 102, and system administrators 103. The web application 106 provides interfaces to these users and these specific web interfaces for the purchasing facilities, medical image interpreters, and system administrators are shown at 116, 117, and 118, respectively. All three of these users can also connect to the accounts web interface shown at 119. The accounts web interface 119 handles functions that are common to all three users, such as recording usernames, passwords, and contact information into the accounts 120 section of the database 108. The auction management system 100 is configured to work with a Picture Archiving and Communications System (PACS) 125, which typically has interfaces to the purchasing facility 101 and medical image interpreter 102. Typically, the PACS connection to the purchasing facility includes a direct digital electronic connection to the imaging machines (CT Scanner, MRI, etc) in the purchasing facility 101. In the embodiment shown, the director application 104 connects to the PACS through a PACS Application Programming Interface (API) framework 105. The director application 104 comprises a PACS engine 121, an exchange engine 122, a multibid engine 123, and a work engine 124. The database 108 is configured to store medical procedure value data 109, work data 110, medical image interpreter data 111, bid data 112, medical facility data 113, work transactions data 114, financial transactions data 115, accounts data 120, multibid job data 126, and problem data 127.

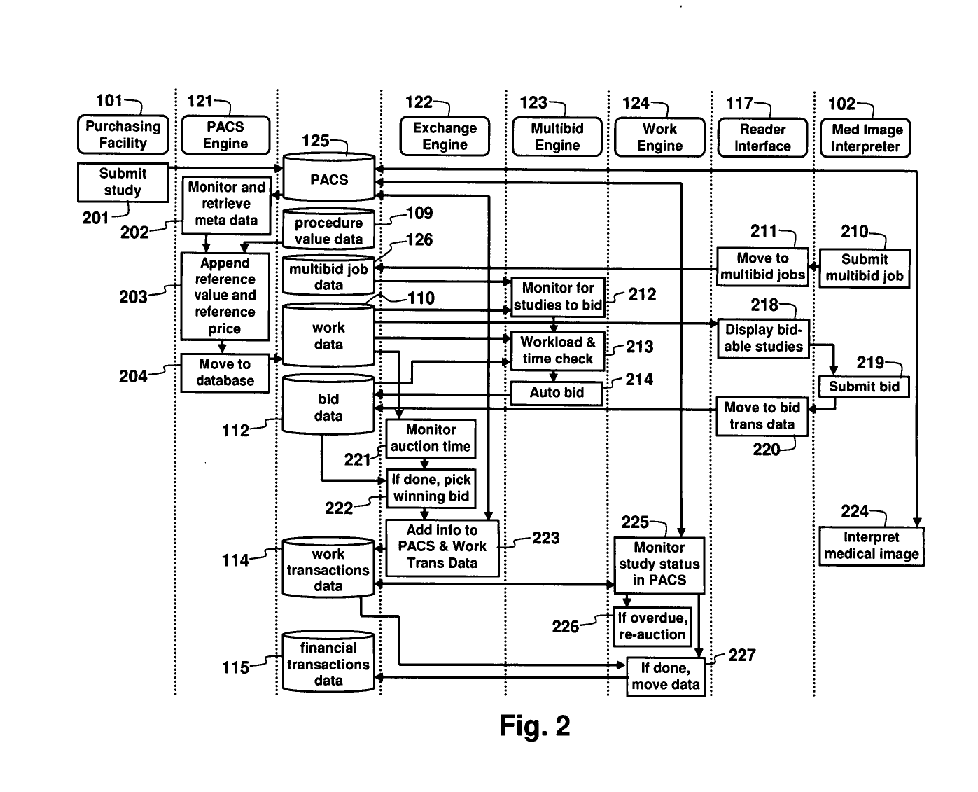

FIG. 2 shows an overview of some of the main processes performed by the medical image interpretation services auction management system that was shown at 100 in FIG. 1, in conjunction with the PACs 125, the purchasing facility 101, and the medical image interpreter 102. In FIG. 2, some of the names of items have been shortened to fit the space available, but all items with the same number in FIG. 1 and FIG. 2 are identical. In FIG. 2, some of the key tasks performed by the purchasing facility 101, the PACS engine 121, the exchange engine 122, the multibid engine 123, the work engine 124, the reader interface 117, and the medical interpreter interface 102 are shown in columns separated by dotted lines. These different elements work with data in the PACS 125 and key section of the database that was shown at 108 in FIG. 1, such as the medical procedures value data 109, the multibid job data 126, the work data 110, the bid data 112, the work transactions data 114, and the financial transactions data 115. For the sake of simplifying the diagram, the PACS API framework, 105 in FIG. 1, and the exchange API framework, 107 in FIG. 1, have been omitted from the process flow in FIG. 2. In general, the process steps shown in FIG. 2 are performed in time-sequential order, with those steps occurring higher up in the flow chart occurring before those lower down in the flow chart.

Referring to FIG. 1 and FIG. 2, a purchasing facility 101 (such as a hospital, medical imaging center, or doctor's office) enters the information for a medical image exam (also known as a medical study, an exam, a medical exam, a study, a medical diagnosis, a medical reading, or a medical image interpretation) into the PACS 102, a step called “submit study”, 201 in FIG. 2. This medical image exam information provided in the submit study 201 step typically comprises one or more medical images and associated text data. The associated text data includes categorization information for the medical image exam and this categorization information for a medical image exam can be called medical image exam meta data. Once the medical image exam information (medical images and associated text data) arrives in the PACS 102, the PACS engine 121 in the director application 104 grabs the medical image exam meta data related to the medical image exam through the PACS API framework 105. This step is shown as “monitor and retrieve meta data” 202 in FIG. 2. The meta data retrieved by the PACS engine 121 in step 202 can include: a purchasing facility name or purchasing facility identifier; the state in which the purchasing facility is located, time information, a modality or modality identifier; an urgency or urgency identifier; a medical image exam status information; a medical image interpreter name or medical image interpreter identifier; a yes/no or true/false indicator for whether results need to be phoned in, and a medical code or medical code identifier; wherein:
time information can include a time when the medical image exam was placed in the PACs,
modality can be defined as the type of device that is used to perform an exam such as an ultrasound machine or CT (computerized axial topography) scanner and it can include sub modality, which is frequently a body system or body part such as neurological or chest, respectively;
urgency can be defined as how soon a report on the medical image exam must be completed, such as stat (from the Latin “statim” which means immediately), ASAP (as soon as possible), or routine;
medical image exam status information can include data that shows whether the medical image exam is being tracked in the auction management system, whether a medical image exam has been deleted, whether a medical image interpreter (reader) has been assigned, whether the assigned medical image examiner has viewed the medical image; whether the assigned medical image interpreter has a reported problem, whether a report has been dictated as part of the medical image exam, whether the dictated report has been transcribed, whether the report is in draft mode, whether the medical image exam is complete, and whether the medical image interpreter has signed/approved the report; and
medical code can also be called a medical procedure code or a medical diagnosis code. Current Procedural Terminology (CPT) is one example of a medical code. Current Procedural Terminology (CPT) is standardized number in the medical field to identify specific exams or procedures, and can be used as a unique medical image exam type identifier. Medical code can refer to another standardized system or nomenclature such as the International Statistical Classification of Diseases and Related Health Problems Codes, typically called ICD codes. There are multiple kinds of ICD codes, examples of which include ICD-6, ICD-7, ICD-8, ICD-9, ICPM, ICD-9-CM, ICD-10, ICD-10-CM, ICD-10-CA, and ICD-11. Other medical codes in use in the healthcare field include Healthcare Common Procedure Coding System (HCPCS) codes, ICPC-2 (used by primary care physicians), International Classification of Sleep Disorders codes, North American Nursing Diagnosis Association (NANDA) codes, Diagnostic and Statistical Diagnosis of Mental Disorders (DSM) codes published by the American Psychiatric Association, Online Mendelian Inheritance of Man (OMIM) codes for diseases with a genetic component, READ codes used in the UK healthcare system, and Systematized Nomenclature of Medicine (SNOMED) codes. Custom medical codes could also be created by a reader (medical image interpreter), by a purchasing facility, or by another entity associated with the field of use of the auction management system.

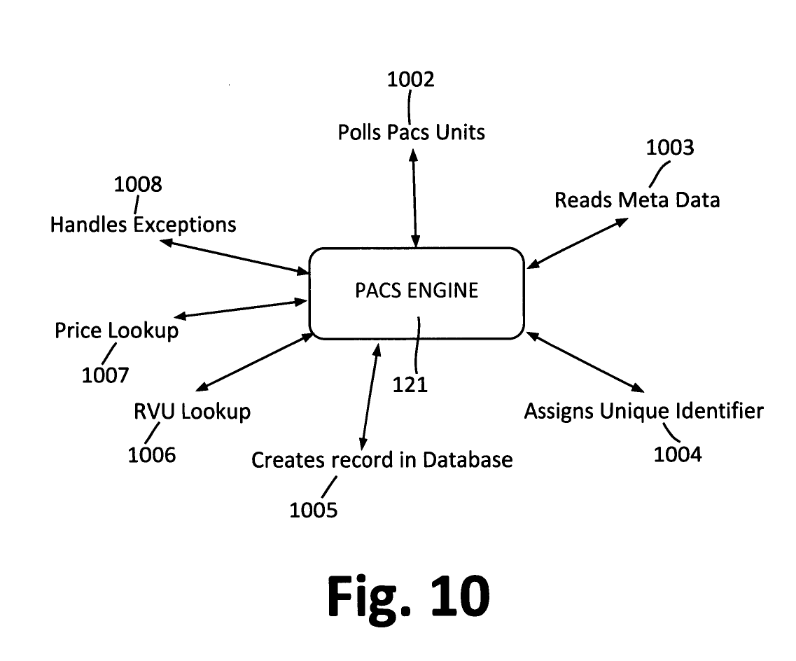

In the preferred embodiment of the present invention, once the PACS engine 121 has retrieved the meta data 202, the PACS engine 121 then accesses the medical procedures value data 109 to append a reference value and a reference price 203 to the medical image exam meta data and the resulting data is then moved through an exchange API framework 107 to a work data storage location 110 in the database 108, a step shown at 204. The system can be structured so that, confidential patient text data is never transmitted to the director application 104. The step of appending reference values and reference prices 203 will also be described in greater detail with reference to FIG. 10. It is based on the existence of publicly available data that relates reference prices and/or reference values to medical codes. In the preferred embodiment, this data is stored as one or more relational tables as procedure value data 109. The reference prices stored as part of the medical procedure value data 109 can be any reference economic value of a procedure, such as the rate at which the United States Medicare program will reimburse a particular medical procedure as defined by a CPT code or a CPT code and a modality. The reference values stored as part of the medical procedure value data 109 can be any set of numbers or formulas that allow the auction management system to compare the inputs or outputs of the medical codes in an meaningful way. One relative values example is the system of Relative Value Units (RVUs) used in the United States Medicare reimbursement formula for physician services. In the US Medicare system, a medical service is scored under the resource-based relative value scale (RBRVS) to determine a payment. The payment formula used by the US Government for Medicare Reimbursement contains three RVUs, one for physician work, one for practice expense, and one for malpractice insurance expense. Currently, the US Center for Medicare and Medicaid Services maintains the fee schedule and methodology for estimating RVUs and relies on the American Medical Association's Specialty Society Relative Value Scale Update Committee (RUC) for advice and recommendations regarding changes. The RUC has been particularly important in providing input regarding the RVU physician work values. The rigor with which RVUs are developed makes them a good surrogate for understanding the relative value of medical codes for applications other than Medicare reimbursement. In particular, the physician work RVUs can be used to determine both the economic value of a procedure and the workload involved in performing this procedure. Note that if the medical image exam meta data received from the PACS does not include time information, this time information can be added as part of the appending process step 203. In particular, it is important that the medical image exam meta data that is moved to the database in step 204 should include a time stamp that can be used later in the process to determine when the auction time for a medical image exam has expired. In the preferred embodiment, this time stamp is stored in the work data 110 as part of the medical image exam meta data.

Further referring to FIG. 1 and FIG. 2, once medical image exam meta data has been placed into the work data section 110 of the database 108 via the exchange API framework 107, the other engines in the director application 108 can do their work. As the medical image exam progresses through the system 100, database information is changed and work is performed. Ultimately the purchasing facility 101 receives a dictated and approved medical image exam. In the preferred embodiment, the auction process is next. The auction process comprises steps 210, 211, 212, 213, 214, 218, 219, 220, 221, 222, and 223 in FIG. 2. In the auction process, a medical image interpreter 102 can submit bids (a) directly or (b) indirectly:
(a) In the direct bidding process, a medical image interpreter 102 reviews a display of bidable studies 218 presented by the reader interface 117 (which is part of the web application 106) based on polling the work data 110. The medical image interpreter 102 then submits a bid 219 to the reader interface 117, which moves the bid 220 to the bid data 112 in the database 108. Note that the medical image interpreter 102 cannot place a bid if the medical image interpreter has reached a workload limit.
(b) In the indirect bidding process, a medical image interpreter 117 submits a multibid job 210 to the reader interface 117, which then moves the multibid information 211 provided the by the medical image interpreter 102 to the multibid job data 126 in the database 108. The multibid engine 123 can then automatically submit bids by monitoring the work data 110 for studies (medical image exams) to bid, a step shown at 212, verifying that workload and time limits have not been reached, a step shown at 213, and then applying the data that had been supplied to the multibid job data 126 to those studies to bid. If this monitoring for studies to bid 212 finds a match, and the workload and time limits have not been reached 213, the multibid engine 123 autobids (i.e. automatically or autonomously bids) the study (medical image exam) by placing a bid value into the bid data 112, a step shown at 214.

In the mean time, the exchange engine 122 is monitoring auction times, a step shown at 221. More specifically, in this step 221, the exchange engine 122 identifies any studies (medical image exams) in the work data 110 for which the current time is less than the scheduled ending time of the auction. If any studies in the work data 110 have passed their auction time, the exchange engine determines the winning bid, a step shown at 222. Having determined the winning bid 222, the exchange engine 122 then adds information to the PACS 125 that identifies that the auction has ended and informs, the PACS of who the winning bidder is, a step shown at 223. Additionally, in step 223, the exchange engine 122 adds information to the work transactions data 114 that identifies that this is a study that is ready to be monitored by the work engine 124. The exchange engine 122 can also send a message to the medical image interpreter 102 informing him/her that he/she has won the auction for this study (medical image exam). Typically, the medical image interpreter 102 will be online at the time he/she has won the study and will be able to see this message through the reader interface 117. Alternatively, the fact that the medical image interpreter 102 has won a bid can be shown on a screen available to a medical image interpreter when he/she requests information about his/her backlog.

Having won the auction, the medical image interpreter 102 can interpret the medical image, a step shown at 224. This action is typically performed by the medical interpreter 102, directly with the PACS 125, and the auction management system 100 does not need to be directly involved. In the preferred embodiment, the auction management system 100 does monitor the status of the study in the PACS, a step shown at 225, and this step is performed by the work engine 124. The work engine monitors the study status in the PACS 225 and looks for two things:
(a) Is the study completed, i.e. has the medical image interpreter completed the medical image exam, dictated a report, phoned his/her findings (if requested), and signed the final version of the report? If the study status shows that the work on the medical image exam has been done, the data for the medical image exam is moved to the financial transactions data 115 section of the database 108, a step shown at 227.
(b) Has the time for the medical image exam expired without the study (medical image exam being completed, i.e. is the medical image exam overdue? If the medical image exam is overdue, the study (medical image exam) is re-auctioned, and other actions may also be taken, a step shown at 226. The work engine 124 compares the time allowed for the completion of the study (medical image exam) by the medical image interpreter 224 with the current time.

It should be noted that the auction management system 100 can also include an archiving process, which is not illustrated in FIG. 1 or FIG. 2. During this archiving process data from completed studies (medical image exams) can be moved into archives for audits and historical purposes. This operation is typically performed on a routine basis.

In addition to the medical image exam status information that was described previously with reference to the medical image exam meta data, the preferred embodiment of the present invention described in FIG. 1 and FIG. 2 can store other status information such as:
a. User status, examples of which can include whether the user is active or inactive, whether the user has been suspended, whether the user has been disabled, whether the user has started the sign-up process, whether the system is waiting for the user to respond to a verification email, and whether the user's credentials are being verified. User status would typically be stored as part of the accounts data 120 in the database 108.
b. Medical image exam import status, examples of which can include whether a medical image exam should be skipped (not handled by the system), whether a medical image exam has already been sent to the PACS engine, and whether a medical image exam has a error. Medical image exam status information would typically be stored as part of the work data 110 in the database 108.
c. Medical image exam bid status for a specific medical image interpreter (reader) and a specific medical image exam. The medical image exam bid status can show whether this is a winning bid, whether the bid is outbid by another bid, or whether there is some other reason that this bid cannot win. Medical image exam bid status would typically be stored as part of the bid transaction data 126 in the database.
d. Multibid job status, examples of which would be whether a multibid job has been created, whether a multibid job is running, whether a multibid job is idle, whether a multibid job has been paused because a limit (such as an RVU limit) has been reached, whether a multibid job has been stopped by the medical image interpreter or a system administrator, and whether a multibid job has been completed, either because the time is up or limit on the requested RVUs has been reached. The multibid job status would typically be stored as part of the multibid job data 126 in the database 108.
e. Other status information such as whether the PACS 125 is running and whether the system 100 is in active or standby mode.

Security for the auction management system can be provided in several ways. Communication between the PACS 125 and the database 108 (through the PACS API Framework 105, the director application 104, and the Exchange API framework 107) can be encrypted using an encryption algorithm such as Transport Layer Security (TLS), its predecessor Secure Sockets Layer (SSL), or any other cryptography method or protocol capable of being understood by anyone skilled in the art. Communication between a client computer and the server computer that houses the database 108 can be encrypted using an encryption algorithm such as Transport Layer Security (TLS), its predecessor Secure Sockets Layer (SSL), or any other cryptography method or protocol capable of being understood by anyone skilled in the art. Particularly sensitive information such as passwords/salt hashes can be encrypted when stored in the database 108. Furthermore the PACS API can be structured so that sensitive patient information such as patient names, patient addresses, patient Social Security Numbers, and patient ages are never transacted or stored in the auction management system. Similarly, for financial transactions, the system can be structured with APIs that ensure that no credit card data is ever transacted or stored in the auction management system.

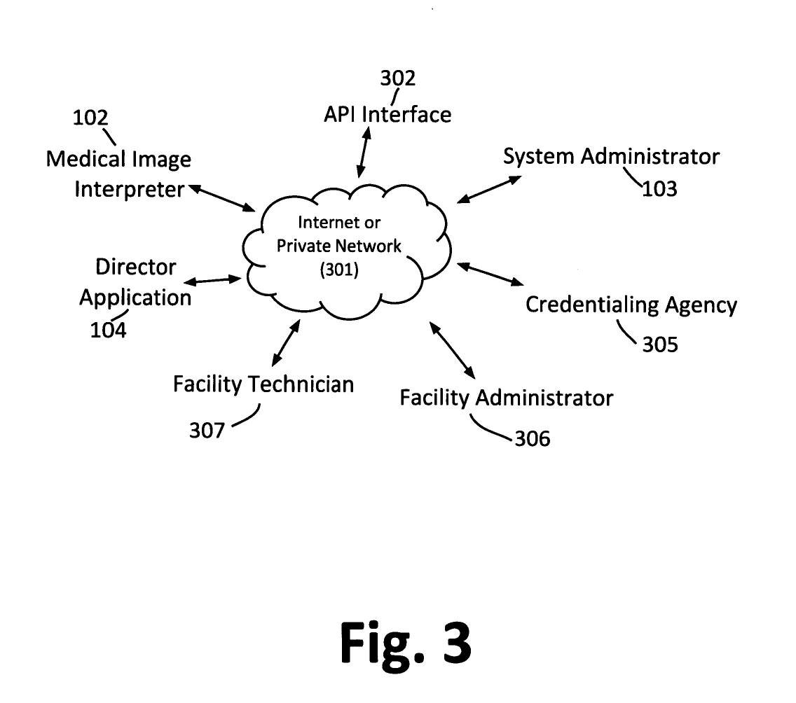

FIG. 3 is a schematic identifying potential user types of the web application (106 in FIG. 1). These user types can include a facility technician 307 and a facility administrator 306 who are part of a purchasing facility (101 in FIG. 1), a medical image interpreter 102, and a system administrator 103 in FIG. 1. These user types can also include other types of users not mentioned with regard to FIG. 1, such as a credentialing agency user 305. These user types can include electronic users such as the director application 104 or API interfaces to the web application 302. These electronic and human user types can interface with the other parts of the system shown in FIG. 1 via the internet, via a private network 301, or via any other electronic interface capable of being understood by anyone skilled in the art. Typically the human users will interface via a client computer and the database, shown as 108 in FIG. 1, will be on a server computer. The client computer can be a desktop computer, a laptop computer, a mobile device or any other electronic interface device capable of being understood by anyone skilled in the art.

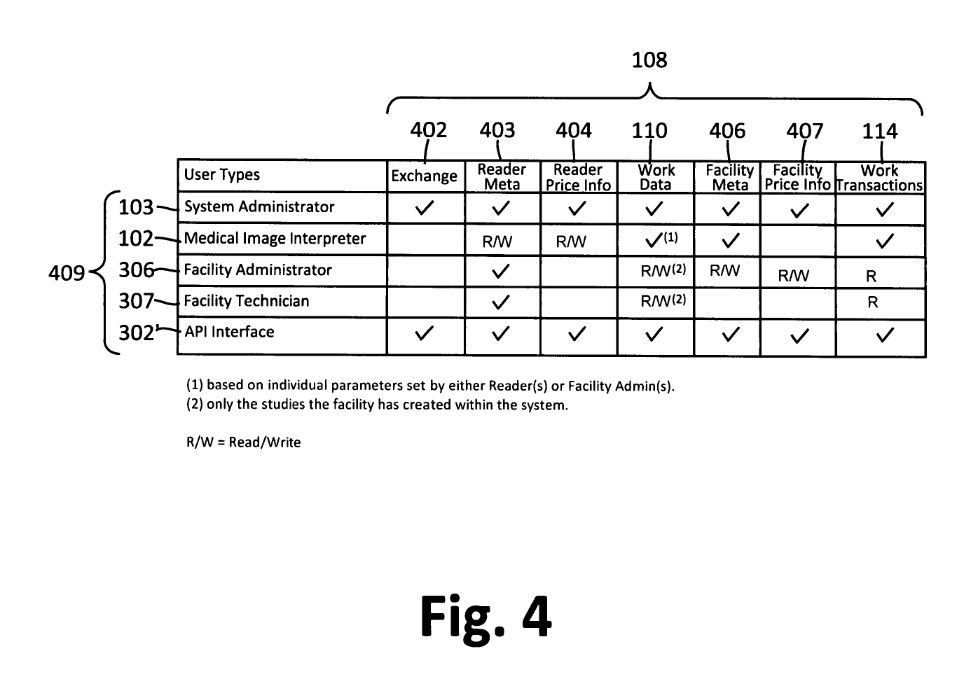

FIG. 4 is a table showing the relationship between some examples of typical user types 409 and the database information 108 available to each user type. In one embodiment the reader meta data 403, typically stored as part of the medical interpreter data 111 in FIG. 1, can include a reader (medical image interpreter) identifier such as a system-generated identifier or US Social Security Number, a user name, a maximum workload desired, user status information as described previously with reference to FIG. 1, licensure information, insurance information, certification information, and filters wherein:
the maximum workload desired can be expressed based on the same relative price or relative value information discussed previously, examples of which include US Medicare Reimbursement Rates and RVU physician work values;
the licensure information can include the states in which a medical image interpreter is licensed to practice medicine, the relevant state license numbers, the relevant license expiration data, whether this licensure has been verified, and any notes related to licensing;
the insurance information can include malpractice insurance policy numbers, insurance company names, and whether this insurance has been verified;
the certification information can include whether the medical image interpreter is a resident, whether the medical image interpreter is eligible for board certification, whether a medical image interpreter is board certified, whether a medical image interpreter is credentialed through a process that is compliance with an organization like JCAHO, and additional specialization or certification the medical image examiner might have such as a Certification of Additional Qualification (CAQ) in Nuclear Medicine, a CAQ in Neuroradiology, a CAQ in Interventional Radiology, American Board of Nuclear Medicine specialization, a CAQ in Pediatrics, body CT specialization, body MRI specialization, cardiac medicine specialization, chest radiology specialization, emergency medicine specialization, gastrointestinal specialization, genitourinary specialization, interventional medicine specialization, pediatrics specialization, mammography specialization, MSK specialization, nuclear medicine specialization, and ultrasound specialization; and
the filters can include information for identifying purchasing facilities for which the medical image interpreter would and would not like to bid and for identifying medical codes or modalities that the medical image interpreter would or would not like to bid.

Further referring to FIG. 4, in one embodiment the reader price information 404, typically stored as part of the medical interpreter data 111 in FIG. 1, can include information that relates medical code information and modalities to default bid amounts. The reader price information 404 can also include adjustment factors that should be applied to bids based on urgency and whether or not results need to be phoned in. The reader price information 404 can also store current balances from the reader (medical image examiner) or due to the reader. Similarly, the facility price information 407, typically stored as part of the medical facility data 113 in FIG. 1, can include information that relates medical code information and modalities to default maximum prices. The facility price information 407, can also include allowable adjustment factors that can be applied to maximum prices based on urgency and whether or not results need to be phoned in. The facility price information 407 can also store current balances due from the purchasing facility.

Also referring to FIG. 4, in one embodiment the facility meta data 406, typically stored as part of the medical facility data 113, can include purchasing facility name information, identification information such as a US Employer ID, primary contact information, billing and payment information, facility status information previously described with reference to FIG. 1, location information such as the state in which the facility is located, time information, medical image examiner certification requirements, and pricing information wherein:
the billing and payment information can include information on where and how the purchasing facility should be billed, whether the facility pays by check, cash or credit cards and what the payment terms are, and the physical bill to address, if needed;
the time information can include the amount of time allowed for the auction process (i.e. before a medical image interpreter is selected) based on urgency and how much time is allowed from the time the medical image exam is awarded to a medical image interpreter before the medical image exam is overdue based on urgency,
the medical image examiner certification requirements can include whether the medical image interpreter can be a resident, whether the medical image interpreter must be eligible for board certification, whether a medical image interpreter must be board certified, whether a medical image interpreter must be credentialed by an organization like JCAHO, and certifications the medical image examiner might be required to have such as CAQ Nuclear Medicine, CAQ Neuroradiology, CAQ Interventional Radiology, American Board of Nuclear Medicine, CAQ Pediatrics, body CT certification, body MRI certification, cardiac medicine certification, chest radiology certification, emergency medicine certification, gastrointestinal certification, genitourinary certification, interventional medicine certification, pediatrics certification, mammography certification, MSK certification, nuclear medicine certification, and ultrasound certification; and
the pricing information can tie to a specific price schedule that should be applied for charging the purchasing facility for the services provided by the medial image interpretation services auction management system, 100 in FIG. 1.

Referring to FIG. 1, FIG. 2, and FIG. 4, the work data 110 includes the medical image exam meta data that was discussed with reference to FIG. 1 and FIG. 2. This meta data will typically include a unique identifier for each set of medical image exam meta data so that data can be related to this unique identifier, and therefore each specific medical image exam. The meta data also includes the reference value and reference price information that was added in step 203 in FIG. 2. The work data 110 can also include an identifier for the PACS 125 from which the meta data came, a reader (medical image interpreter) identifier indicating which medical image interpreter won the auction, the starting bid for the auction, the winning bid (amount winning medical image examiner will receive for their work), the number of times the medical image exam has been auctioned, a timestamp indicating when the medical image exam meta data was loaded into the work data 110, the start time of the auction, and the ending time of the auction. In the preferred embodiment, the ending time of the auction can be determined by adding the amount of time allowed for the auction process based on urgency data stored as part of the facility meta data 406 to the time when the medical image exam meta data was loaded into the work data 110.

Further referring to FIG. 1, FIG. 2, and FIG. 4, the work transactions data 114 includes information so that the information for a medical image exam that was stored in the work data 110 can be retrieved. Additionally, the work transactions data 114 includes an identifier for which medical image interpreter is assigned to complete the medical image exam, the current status of the medical image exam as provided by the PACS 125 through the PACS API Framework 105, the time the medical image exam became available to the medical image interpreter, a time by which the medical image exam must be completed, and a time by which the additional grace time has run out and more serious action must be taken. In the preferred embodiment, the time by which the medical image exam must be completed can be determined by adding the amount of time allowed for the interpreting the medical image exam based on urgency data stored as part of the facility meta data 406 to the time the medical image exam became available. The time by which the additional grace time has run out can be determined by adding the amount of grace time allowed to the time by which the medical image exam must be completed. The grace time can be a single default value, it can be a default value based on urgency or it can be a value specified by urgency by the purchasing facility and stored in the facility meta data 406.

Exchange data 402 is the last type of data shown in FIG. 4. The exchange data 402 is all of the data stored in the database 108 that has not been categorized as belonging in any of the other groupings. Referring to FIG. 4 and FIG. 1, examples of exchange data 402 can include medical procedure value data 109, financial transactions data 115, accounts data 120, and default values that might be used in various parts of the system 100.

Further referring to FIG. 4, in one embodiment, the system administrator 103 can see all aspects of the system, 402, 403, 404, 110, 406, 407, and 114. A medical image interpreter 102 can see all information in the system except the exchange data 402 and the facilities price info 407. The medical image interpreter 102 can read and write the reader meta data 403 and the reader price info 404. The medical image interpreter 102 can only see work transactions data 114 for the studies (medical image exams) for which they are the winning bidder. Facility administrators 306 cannot see the reader price info 404 set by a medical image interpreter 102 or the work data 110 for an individual medical image interpreter 102. Facility administrators 306 can read and write the facility meta data 406, the facility price info 407, and the work data 110 for the studies (medical image exams) generated by their purchasing facility 101. A facility technician 307 can only see contact information for a medical image interpreter 102 if that medical image interpreter 102 has a medical image exam for their purchasing facility in the auction. A facility technician 307 will typically be the person who creates the work data 110 as part of generating the medical image of the patient. The facility administrator 306 and the facility technician 307 can only see work transactions data 114 for the studies (medical image exams) submitted by their purchasing facility 101. The API interfaces 302 are permission based and therefore may be able to see all information based on the requestor's permission. It should be noted that having access to the API interfaces 302 is not sufficient for having access to any part of the database, 108 in FIG. 1. In addition to having access to the API interfaces 302, specific access to a part of the database requires an additional authentication key and password.

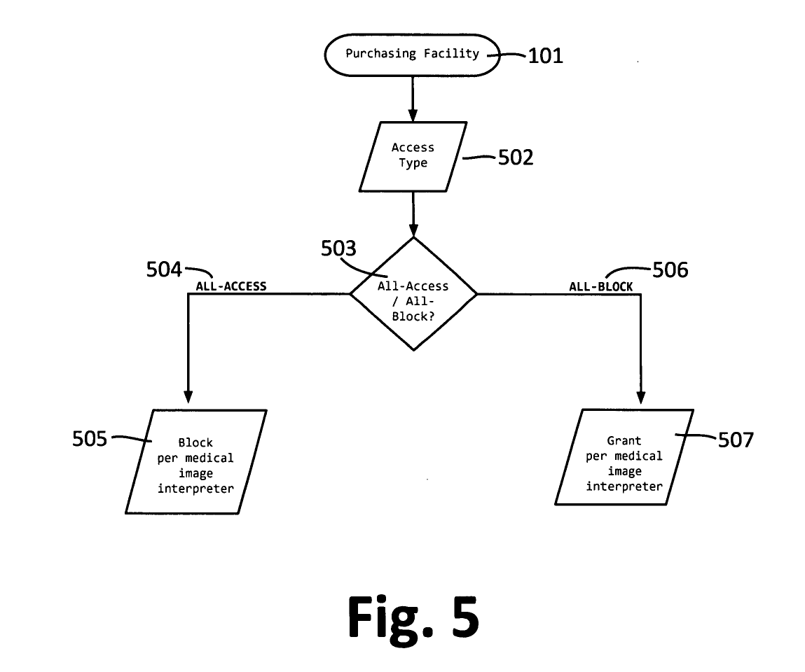

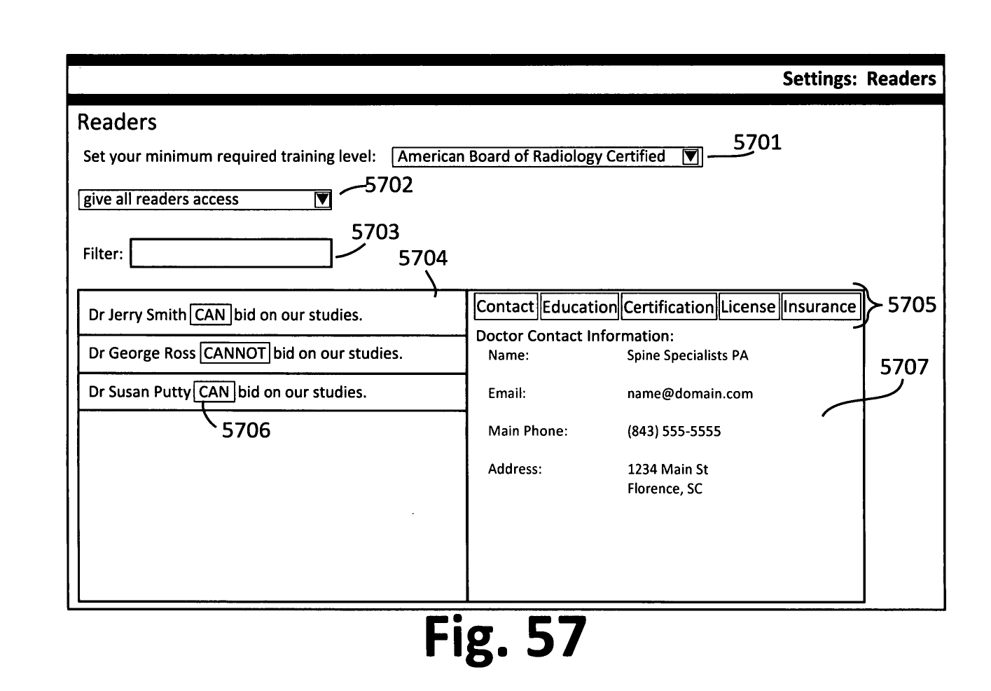

FIG. 5 shows how a purchasing facility 101 can control which medical image interpreters, 102 in FIG. 1, can see the medical image exam meta data for their facility, based on access type 502. The process shown in FIG. 5 is performed through the web application (106 in FIG. 1) and is described in detail later with reference to FIG. 57. Referring to FIG. 5, the purchasing facility 101 can choose 503 one of the following two alternatives as the default filter:
(a) The default setting can be that 504 all eligible medical image interpreters have access to the medical image exam data from this facility and individual medical image interpreters being blocked 505. Typically, an eligible medical image interpreter is a medical image interpreter who is licensed in the same state as the location where the purchasing facility is located and who has the correct credentials to perform medical image exams for this purchasing facility.
(b) The default setting can be that all medical image interpreters are blocked 506 and that only have access default 506 and grant individual medical image interpreters the ability to access the medical image meta data 507 for this purchasing facility 101.

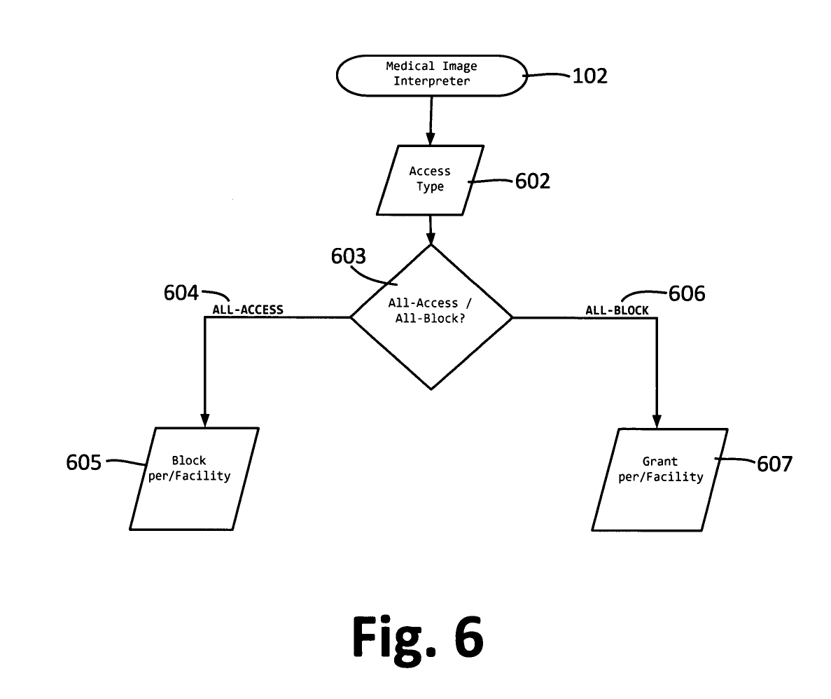

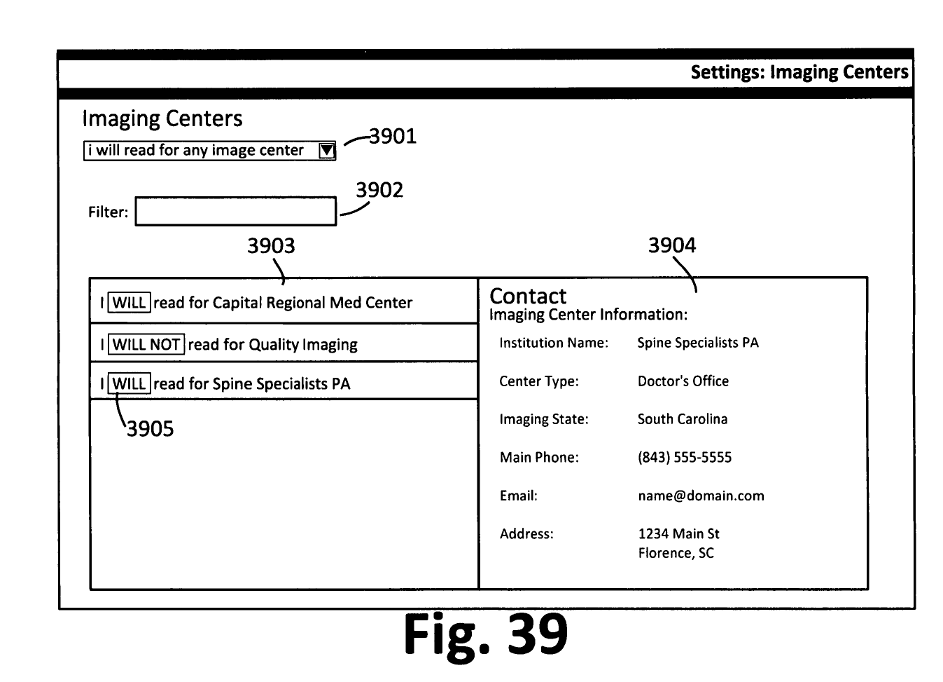

FIG. 6 is much like FIG. 5, except from the perspective of the medical image interpreter 102. FIG. 6 shows how a medical image interpreter 102 can choose 603 the purchasing facilities, 101 in FIG. 1, whose medical image exams they can see and bid on by setting a default access type 602. Note that the medical image exams a medical image interpreter can view are also filtered based on a match between the medical image interpreter's state licensure and credentials, compared with facility location and credential/certification requirements. The medical image interpreter can choose to set all-access 604 and block per facility 605 or set all-block 606 and grant per facility 607. The process shown in FIG. 6 is performed through the web application (106 in FIG. 1) and is described in detail later with reference to FIG. 39.

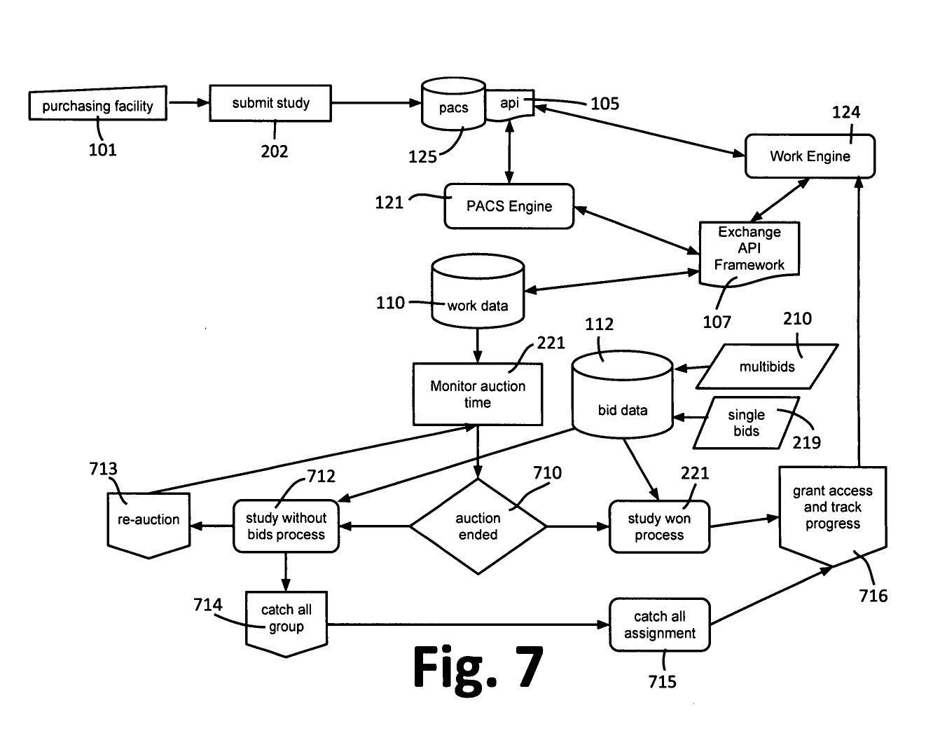

FIG. 7 shows the auction process flow. A purchasing facility 101 performs a study (medical image exam) on patient, submitting 202 the study (medical image exam) to the PACS 125. The PACS engine 121, via the PACS API framework 105, monitors the PACS 125. When the PACS engine 121 sees a new study (medical image exam), it will update the work data 110 via the exchange Application API framework 107. More specifically, the PACS engine 121 grabs medical image exam meta data, as described with reference to FIG. 1 and FIG. 2, related to the medical image exam through the PACS API framework 105 and moves it through the exchange API framework 107 to a work data storage location 110 in the database, 108 in FIG. 1. Medical image interpreters, 102 in FIG. 1 and FIG. 2, can submit single bids 219 or multibid jobs 210 via the reader interface, 117 in FIG. 1 and FIG. 2. The exchange engine, 122 in FIG. 1 and FIG. 2, monitors the time available for the auction 221 by looking at the time stamp included when the study (medical image exam) was placed in the work data 110. When the time available for the study has expired 710, the exchange engine determines if the study has not received a bid 712. If a study has not received a bid, the study (medical image exam) is re-auctioned 713. Should a study (medical image exam) fail to receive any bids after going through the exchange a predetermined amount of times, this study (medical image exam) will fall into a catch-all group 714 and assigned 715 accordingly, ensuring that all studies (medical image exams) are read/interpreted by a qualified reader (medical image interpreter). At this point, that study (medical image exam) will follow the same processes as studies that did have bids. Once the study (medical image exam) is won 221, access will be granted 716, via the work engine 124, to the winning reader (medical image interpreter). This access is granted through the exchange API framework 107 and the PACS API framework 105.

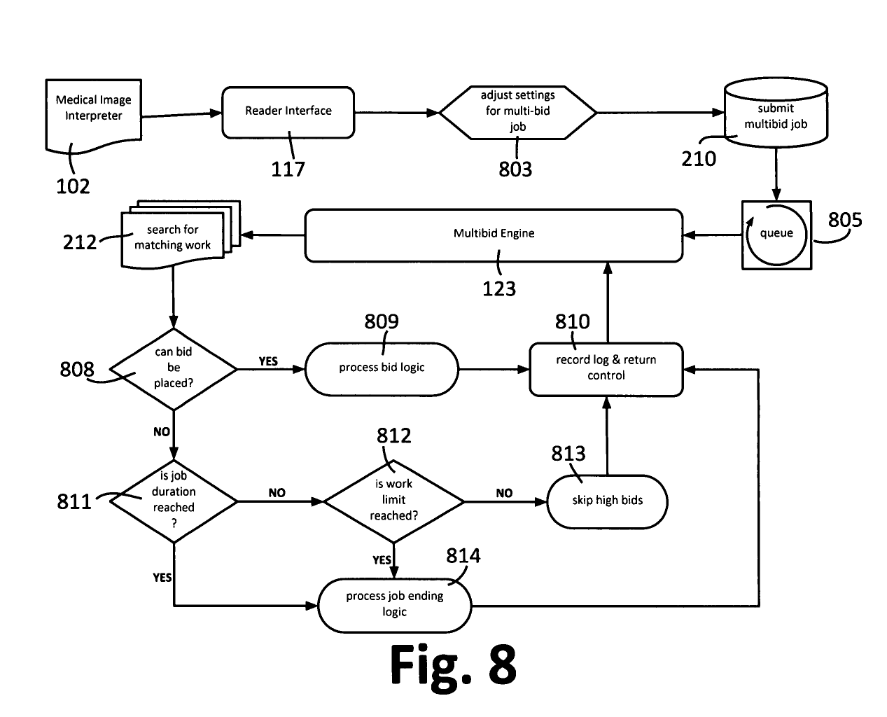

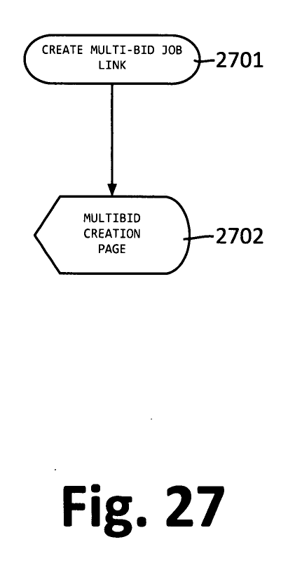

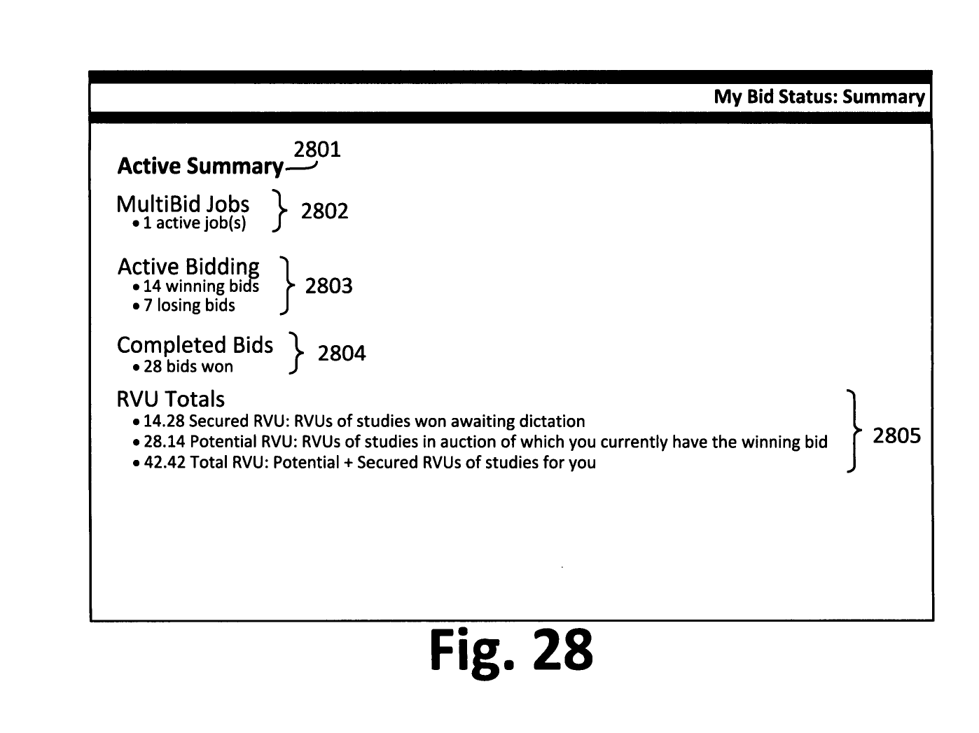

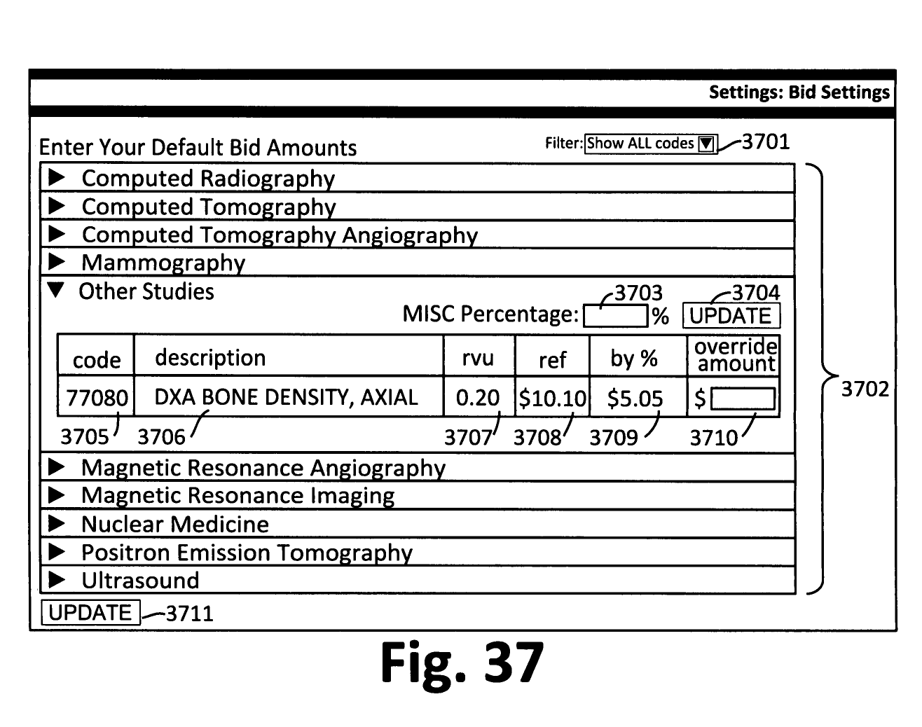

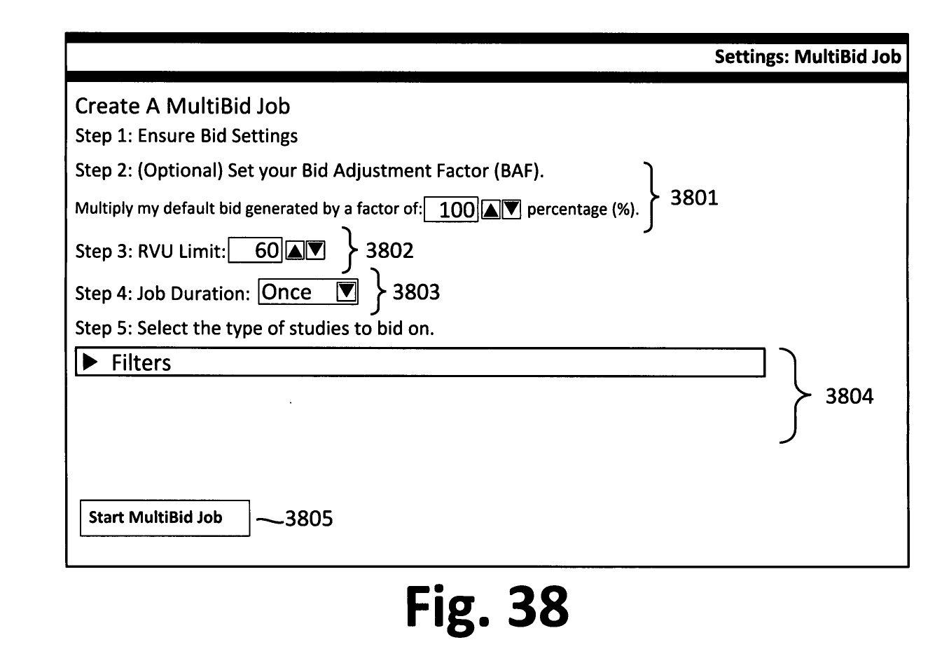

FIG. 8 depicts the multibid process. In this process, the medical image interpreter 102 logs into the reader interface 117 in the web application, 106 in FIG. 1, and clicks on a link to start a multibid job. The medical image interpreter 102 can then adjust settings 803 for the multibid job based on his/her preferences. This adjustment of settings 803 is further outlined with reference to FIG. 27, FIG. 37, and FIG. 38. Once the multibid job has been submitted 210 by the medical image interpreter 102, it is transferred to a multibid queue 805 stored in the multibid job data, 126 in FIG. 1 and FIG. 2. Next, the multibid engine 123 starts searching for matching work 212 taking into consideration variables such as state the medical image interpreter is licensed to practice in, whether the facility has blocked the medical image interpreter, and whether a work limit has been reached for the medical image interpreter. If a bid can be placed 808, the director can process bid logic 809 for this medical image interpreter using the settings that were placed during the multibid job creation, which are further described with reference to FIG. 27, FIG. 37, and FIG. 38. Once a bid has been placed, the multibid engine 123 can record this bid in a log file 810 and proceed to the next study (medical image exam), repeating this process as many times as necessary. The multibid engine 123 can stop processing the multibid job 814 if the medical image interpreter cancels it, if the duration of the job is reached 811, or the work limit has been reached 812. If there are no bids low enough 813, the multibid job will be placed back on the queue stack to be processed. Note that the combination of steps 811 and 812 is the same as step 213 on FIG. 2, and that FIG. 8 shows more of the steps in the multibid process than it was possible to fit into FIG. 2. Referring to FIG. 2, FIG. 8, and FIG. 38, the medical image interpreter sets a workload limit by setting an RVU limit, as shown at 3802 in FIG. 38. This workload limit is stored as part of the multibid job data, 126 in FIG. 2. The workload check step, 812 in FIG. 8, that is part of workload and time check 213, in FIG. 2, compares the RVU limit that was set by the medical image interpreter using the screen shown in FIG. 38 (which is part of the reader interface, 117 in FIG. 1) with the sum of the RVUs that the medical image interpreter needs to complete. Note that there is also a system RVU limit that will be discussed in greater detail with reference to FIG. 28. This system RVU limit overrides the RVU limit set by the medical image interpreter if a medical image interpreter tries to set too high of a limit, ensuring that a medical image interpreter cannot try to “game the system” by bidding all jobs and then not being able to do the work. The sum of the RVUs that the medical image interpreter needs to read can be determined by adding the RVU values of the studies (medical image exams) that the medical image interpreter has won to the RVU values of the studies (medical image exams) that the medical image interpreter has the potential to win. The studies that the medical image interpreter has won can be determined by identifying studies in the work data 110 or the work transactions data, that have the medical image interpreter's identifier stored as the winning bidder. The studies that the medical image interpreter has the potential to win can be determined by looking at studies in the bid data 112 that have not reached the end of the auction time, for which the medical image examiner in the lowest bidder. The RVU values for both the studies won and the studies potentially won can be determined from data that is stored with the work data, 110 in FIG. 2.

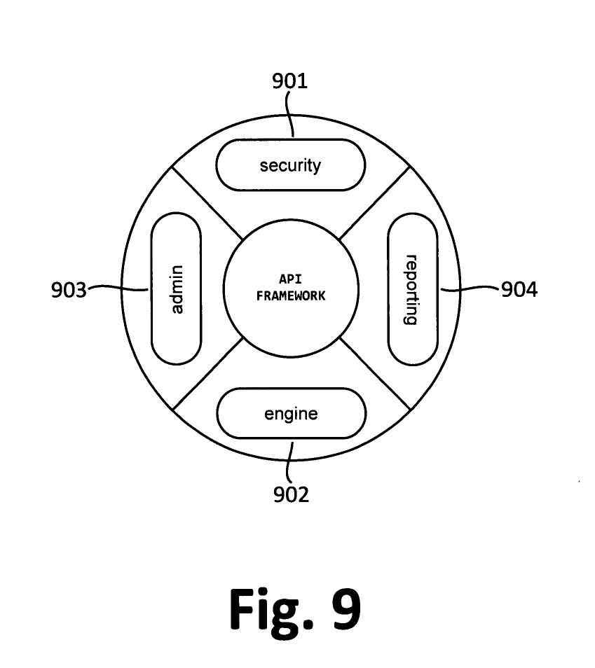

FIG. 9 depicts the API namespaces. Currently the web application, director application, and API framework can be divided into four key areas: security 901; reporting 904; engine 902; and administration 903. Applications determine user permissions in the security namespace. This ensures that users are only allowed to see what they are supposed to see. Reporting and data exports are handled in the reporting namespace. Bid processing logic is handled in the engine namespace. The admin namespace is for system administrators and is where the system itself is managed.

FIG. 10 illustrates the processes performed by the PACS engine 121 and provides some additional detail not presented in FIG. 1 and FIG. 2. The PACS engine 121 is part of the director application, 104 shown in FIG. 1. In the preferred embodiment, the PACS engine 121 polls the PACS 1002, through the PACS API framework, 105 in FIG. 1, to look for any medical image exam meta data (as described with reference to FIG. 1 and FIG. 2) that may have changed or been added. If a new medical image exam meta data is found, the PACS engine 121 reads the meta data 1003, assigns a unique identifier 1004 to this meta data, performs an RVU (relative value unit) lookup 1006 by accessing the medical procedure value data (109 as described with reference to FIG. 1 and FIG. 2), performs a price lookup 1007 in which US Medicare reimbursement rates are added to the meta data, and creates a record in the database 1005 (work data, 110 in FIG. 1 and FIG. 2). The record stored in the work data 110 includes the a time stamp, meta data, the RVU, and the price. More specifically, this record in the database from the PACS engine 121 is a record that is placed into the work data, 110 in FIG. 1. The PACS engine 121 also handles any exceptions 1008, examples of which might be any of the following problems with the medical image exam meta data (a) an unreadable field, (b) a missing purchasing facility identifier, (c) a missing identifier for the state in which the facility is located, (d) a missing medical procedure code, (e) a medical procedure code that is not in the medical procedure value data, (f) a status indicator showing that there is an error or reason not to read the record or (g) any other field that is missing or has an error in it. These handled exceptions 1008 are stored in the database, 108 in FIG. 1, and available as part of the exchange data, 302 in FIG. 3, that is visible to a system administrator.

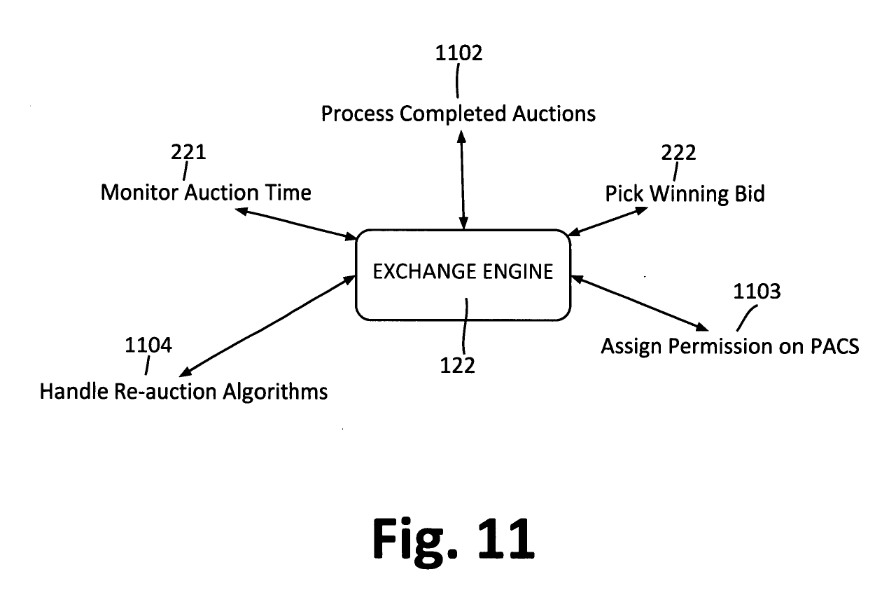

FIG. 11 illustrates the processes performed by the exchange engine 122. The exchange engine 122 is part of the director application, 104 shown in FIG. 1. The exchange engine 122 is responsible for moving studies (medical image exams) through the auction process as was described with reference to FIG. 1, FIG. 2, and FIG. 7 to the point in time when a winning medical image examiner has been assigned and the study (medical image exam) can be monitored in the PACS by the work engine, 124 in FIG. 1 and FIG. 2. Referring to FIG. 11, during the time when a study (medical image exam) is being auctioned, the exchange engine 122 monitors the auction time 221. Once the auction time has expired, the exchange engine 122 picks the winning bid 222. Once the winning bid has been selected, the exchange engine 122 assigns permission to the winning reader on the PACS system 1103, noting this in the database 108, by taking the following actions: (a) the medical image exam status information stored in the work data, 110 in FIG. 1, is changed to show that a medical image interpreter has been assigned, (b) the medical image interpreter id is added to the medical image exam meta data that is stored in the work data, 110 in FIG. 1; (c) the status of the medical image exam data in bid data, 112 in FIG. 1, is similarly updated; and (d) time stamps showing when these changes were made are stored in the work data, 110 in FIG. 1, and bid data, 112 in FIG. 1. The process of assigning permission to the winning reader 1103 also includes communicating the updated medical image exam status information and the medical image interpreter id to the PACS, 125 in FIG. 1, through the PACS API framework, 105 in FIG. 1. The exchange engine 122 also processes completed auctions 1102, which can include steps such as (a) verifying that the medical image interpreter has an account on the PACS and (b) creating an entry in the work transactions data, 114 in FIG. 1, to begin tracking the study (medical image exam). The exchange engine 122 also handles re-auction algorithms for any studies (medical image exams) that received no bids by putting the study back into the auction process and assigning new start and end times. If a study (medical image exam) has been auctioned the maximum number of times specified by the system, then the study is assigned into a special group and account as was described with reference to FIG. 7.

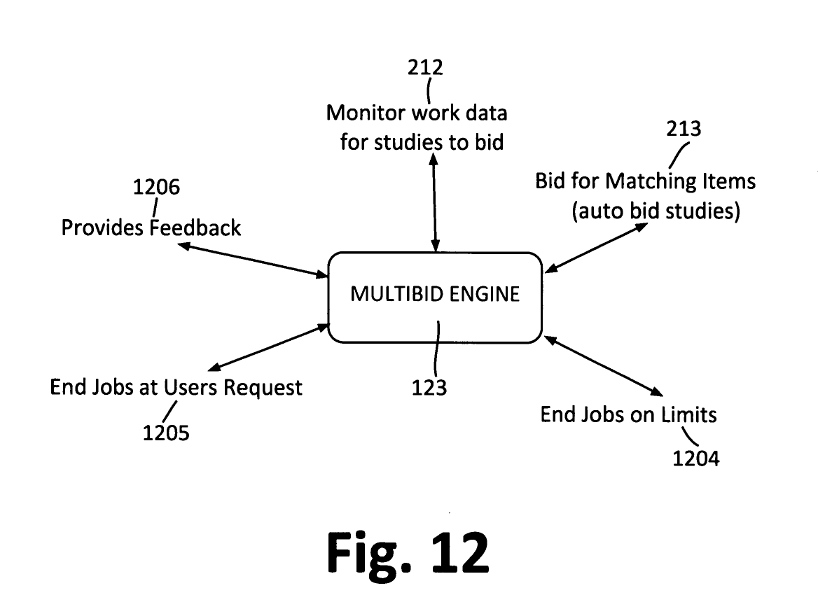

FIG. 12 illustrates the processes performed by the multibid engine 123. The multibid engine is part of the director application, 104 shown in FIG. 1. The multibid engine 123 monitors the work data 110 to look for studies that it can bid 212. In the process of doing 212, the multibid uses the multibid job queue 805, that was discussed with reference to FIG. 8. The work data is stored in 110 in FIG. 1 and FIG. 2. The multibid job queue 805 is stored as part of the multibid job data 126 in FIG. 1 and FIG. 2. The multibid engine 123 places bids for matching items by autobidding studies 214 on behalf of the reader (medical image interpreter). These bids are automatically placed into the bid data, 112 in FIG. 1. The multibid engine 123 can pause processing and provide feedback 1206 to a reader (medical image interpreter) that no studies (medical image exams) are available for the reader to bid on. When pausing processing, the multibid engine 123, can pause for a fixed length of time and then automatically resume. By pausing and resuming in this way the multibid engine reduces the number of potentially wasted CPU cycles. The multibid engine 123 can end a multibid job at the request of a reader (medical image interpreter) 1205. The multibid engine 123 ends multibid jobs 1204 due to work or time limits and this process can occur in the following ways:
(a) The multibid engine 123 can calculate that an RVU limit has been reached and can set the multibid job status, described with reference to FIG. 1, to indicate that an RVU limit has been reached.
(b) Each multibid job has an end time. The multibid engine 123 can determine if the end time has been reached and set the multibid job status, described with reference to FIG. 1, to indicate that the end time has been reached.

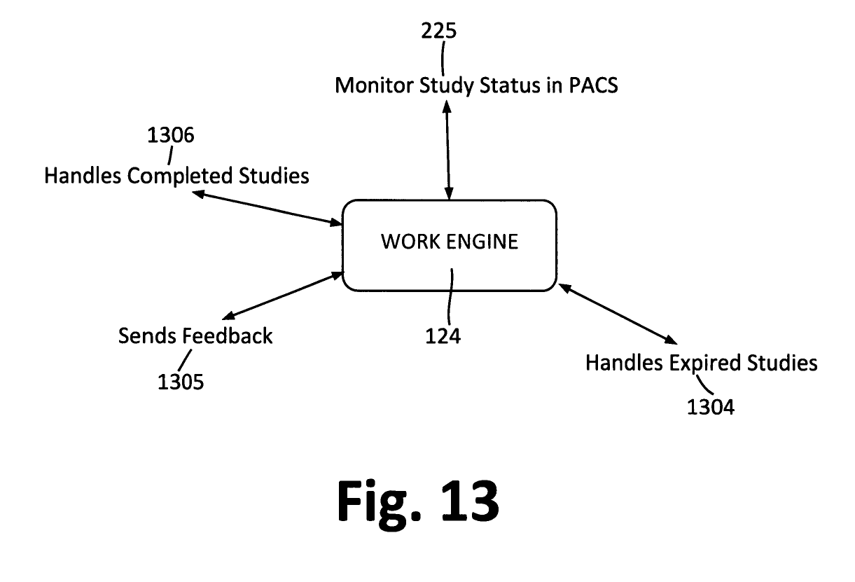

FIG. 13 illustrates the processes performed by the work engine 124. The work engine 124 is part of the director application, 104 shown in FIG. 1. The work engine 124 monitors study status in the PACS 225 for studies (medical image exams) that have successfully been auctioned and were assigned to a medical image interpreter. It does this monitoring of study status 225 by polling the PACS for status and then comparing the medical image exam status information that is in the PACS, 125 in FIG. 1 and FIG. 2, with the medical image exam status information that is stored in the work data, 110 in FIG. 1 and FIG. 2. If there is a difference in medical image exam status between these two locations, the work engine 124 updates the medical image exam status in the work data, 110 in FIG. 1, and adds a new record into the work transactions data 114 that shows the change. If the status in the PACS, 125 in FIG. 1, has changed to show that a medical image exam has been completed (i.e. the medical image exam has been approved), the work engine 124 handles this completed study 1306 by adding a new record into the work transactions data 114 that shows that the study (medical image exam) has been completed. The work engine 124 handles expired studies 1304 by comparing the time by which a study (medical image exam) is required to be read/interpreted with the current time. If the work engine 124 determines that a medical image exam is overdue, the work engine 124 sends feedback 1305 in the form of an email to the reader (medical image examiner) reminding him/her that he/she is late. If the work engine 124 determines that a medical image exam is overdue and the grace time after the overdue time has expired, the work engine handles this expired study 1304 by: (a) changing the status of the study from one that is tracked by the work engine 124 to one that is not tracked by the work engine 124; (b) removing the reader's (medical image examiner's) permissions to read/interpret the study (medical image exam) from the PACS, 125 in FIG. 1, and the work data, 110 in FIG. 1; (c) setting the user status for this reader (medical image examiner) to inactive, which prevents the reader (medical image interpreter) from bidding on any further studies; (d) putting the study (medical image exam) back into the auction process; and (e) sending an email to the reader (medical image examiner) letting him/her know that his/her permission to read/interpret this study has been revoked and that he/she cannot bid on any further studies until he/she is reactivated.

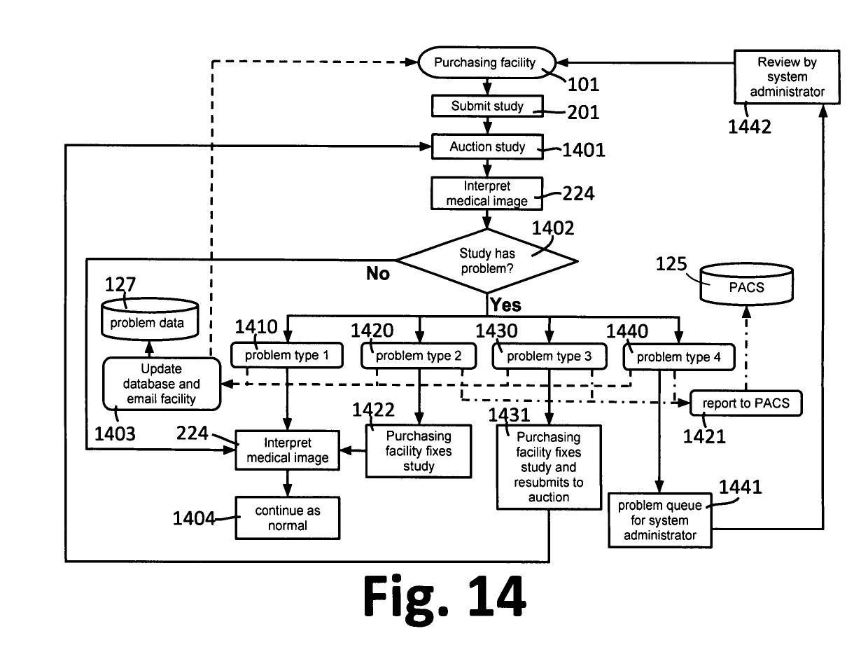

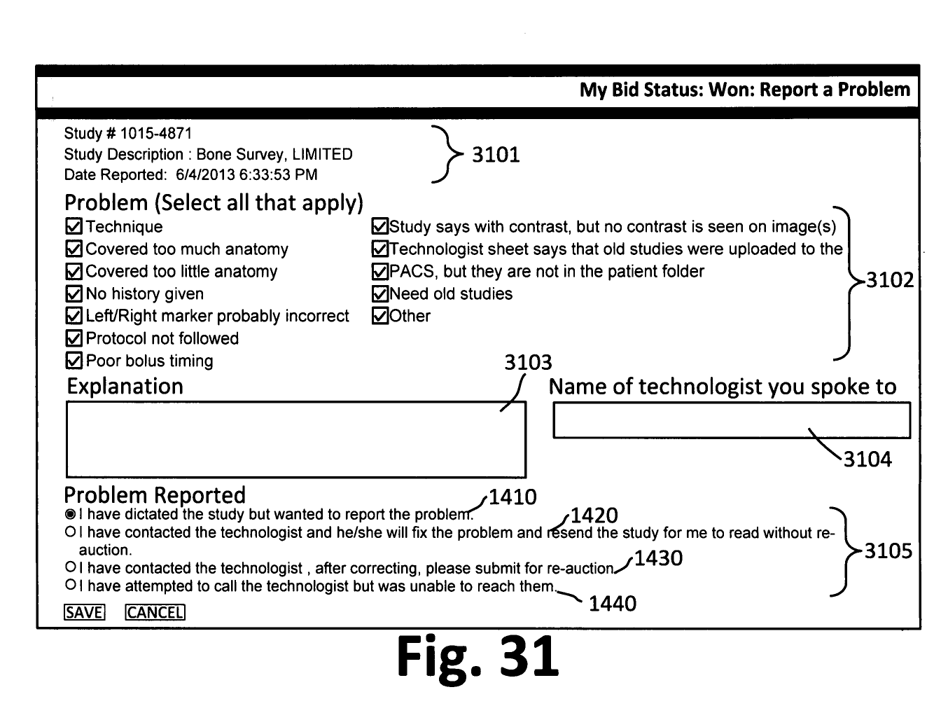

FIG. 14 illustrates problem reporting functionality in one embodiment of the present invention. This problem reporting functionality is also further detailed with reference to FIG. 31. After a study (medical image exam) is submitted 201 by a purchasing facility 101, as was previously described with reference to FIG. 1 and FIG. 2, the study (medical image exam) is auctioned 1401. The study auction step 1401 can be the same as the combination of steps 202, 203, 204, 205, 210, 211, 212, 213, 214, 218, 219, 220, 221, 222, and 223 that were described with reference to FIG. 2. Then, the medical image interpreter 102 interprets the medical image 224, as was described with reference to FIG. 2. If during the process of interpreting a medical image, the study (medical image exam) has a problem 1402, the medical image examiner can use the reader interface, 117 in FIG. 1, to report and categorize a problem. FIG. 31 shows an embodiment of a screen in the reader interface, 117 in FIG. 1, that can be used for reporting a problem. Referring to FIG. 14 and FIG. 31, the medical image interpreter can select summary information about the problem 3102 using check box fields, he/she can provide a more detailed explanation 3103, and he/she can name the technologist who was contacted at about the problem 3104. All of this information (3102, 3103, and 3104) can be stored by the reader interface, 117 in FIG. 1, into the problem data, 127 in FIG. 1. The action of saving the data can also send an email to the purchasing facility 101, as is illustrated by step 1403 in FIG. 14. In one embodiment of the present invention, if a study has a problem 1402, the next steps in the process can be selected through radio buttons, 3105 in FIG. 31, on a form. In the embodiment shown in FIG. 14 and FIG. 31, there are four problem types, shown at 1410 (type 1), 1420 (type 2), 1430 (type 3), and 1440 (type 4). In the embodiment shown, all problem types are recorded in the database and emailed to the facility 1403. Typically those emails are sent to the facility administrator, 306 in FIG. 3, in that facility. Other process steps depend upon which problem type was selected using the form shown in FIG. 31:
(a) Problem type 1 (1410) can be used for situations in which a medical image interpreter has identified a problem with the study (medical image exam), but has chosen to read the study (interpret the medical image) 224 anyway. With problem type 1, the process continues as normal 1404, per the steps that were described with reference to FIG. 2.
(b) Problem type 2 (1420) can be used for situations in which the medical image interpreter is unable to read the study (medical image exam) and requests that the facility fix the study (medical image exam). With problem type 2, the problem is also reported to the PACS, a step shown at 1421. Referring to FIG. 1 and FIG. 14, the report to the PACS 1421 can be made by the reader interface 117 changing the status of the study (medical image exam) in the work data 110, and the work engine 124, which monitors the work data 110, updating the status of the medical image exam meta data in the PACS 125. The report to the PACS 1421 can also be made by the reader interface 117 changing the status of the study (medical image exam) in the work transactions data 114, and the work engine 124 updating the status of the medical image exam meta data in the PACS 125. These transactions are typically performed through the PACS API framework 105 and exchange API framework 107 that were shown with reference to FIG. 1. Once the type 2 problem 1407 has been reported using steps 1403 and 1421, the medical image examiner waits until the purchasing facility fixes the study, a step shown at 1422. Once the study is fixed, the medical image examiner, can further interpret the medical image 224 and the process continues as normal 1404.
(c) Problem type 3 (1430) can be used for situations in which the medical image interpreter is unable to read the study (medical image exam) and requests that the study (medical image exam be re-auctioned. For example, the study (medical image exam) may have been mis-coded to be a CPT code that the medical image interpreter is not willing to interpret or not willing to interpret for the bid amount he/she submitted. For a type 3 problem, the process is similar to a type 2 problem except that for a type 3 problem the purchasing facility fixes and resubmits the study to the auction, a step shown at 1431. The study will typically be fixed in the PACS 125, to be resubmitted via the submit study step 201 shown in FIG. 2.
(d) Problem type 4 (1440) can be used for situations in which the medical image interpreter is unable to read the study (medical image exam) and was unable to make contact (via phone, etc) with the purchasing facility. In this case, the medical image interpreter can use the screen shown in FIG. 31 to update the database, email the facility, and report to the PACS as was done with reference to Problem types 2 and 3, and the problem is further escalated by placing it on a problem queue for the system administrator, a step shown at 1441. The system administrator can then use the system administrator interface, 118 in FIG. 1, to review the problem 1442 and contact the purchasing facility 101 for resolution. The problem queue for the system administrator 1441 can be implemented as a status indicator in the in the work data, 110 in FIG. 1. Note that in one embodiment of the present invention the amount of time allowed for interpreting a medical image exam is reduced by the RVUs for this medical image exam when the medical image exam is placed back into the auction after a problem type 4 has been identified and a similar approach can be used for other situations in which a medical image exam is auctioned more than once.

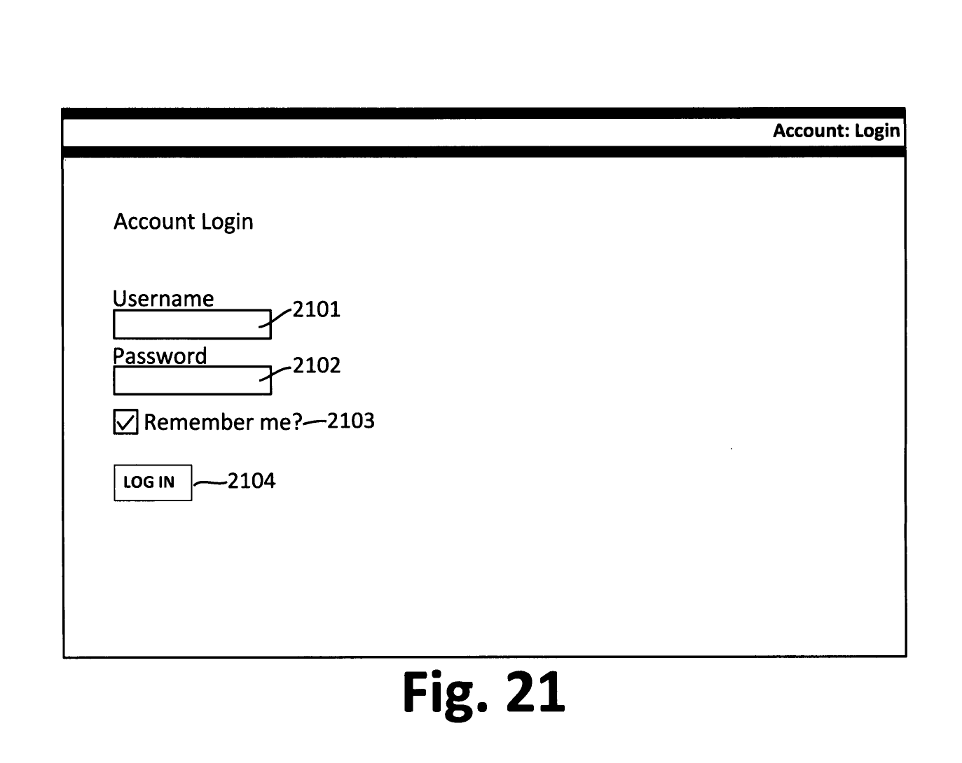

FIG. 15 depicts the signup process 1501. When an anonymous web user clicks on the signup button, they are allowed to create an account 1502. They must verify the email address 1503 prior to logging in. Once logged in 1504 (see reference to FIG. 21), the system verifies whether or not they have completed their profile 1505. If not, they are redirected to create their individual profile 1509. Once the individual profile is completed, the system takes them to their landing page 1507. After a system administrator reviews the profile, and verifies key information, they are allowed to begin using the bidding system. The signup process can be implemented using the accounts interface, shown at 119 in FIG. 1.

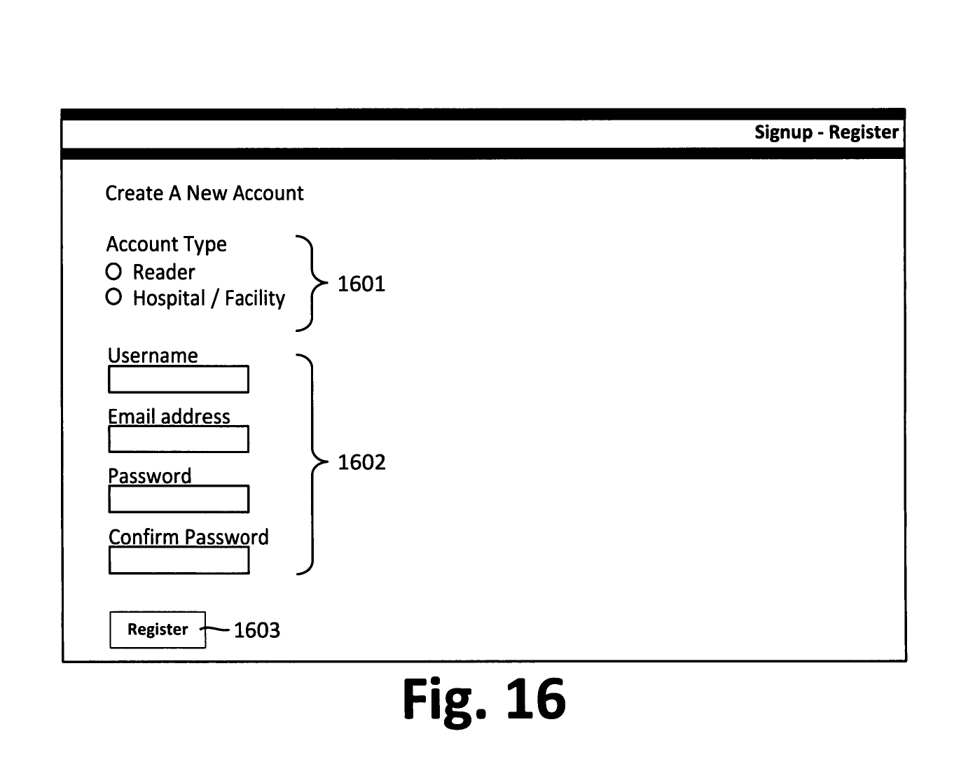

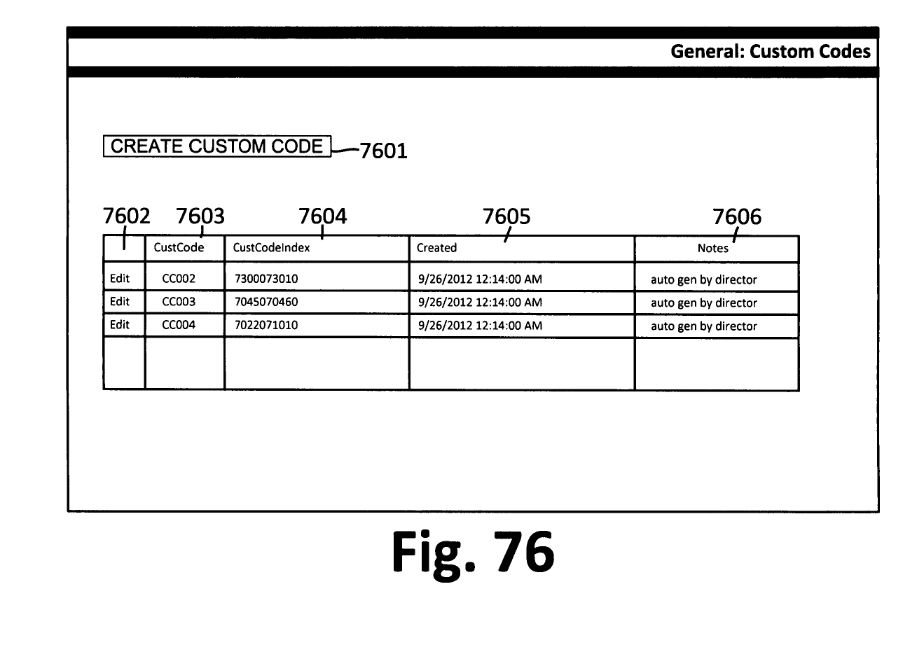

FIG. 16 through 76 show screens that can be used in an auction management system. These screens are typically displayed on a client computer and the data that is transacted is typically processed through the web application (106 in FIG. 1) and ultimately stored in the database (108 in FIG. 1).

FIG. 16 is the “signup—register” screen where users enter their username, email address, and password. A user has the choice of signing up as a reader (medical image interpreter) or a facility 1601. If the user signs up as a reader (medical image interpreter) then the user enters his/her personal information. To complete the initial signup process, a user must provide login credentials 1602. The user then clicks the register/submit button 1603, which begins the verification process. The “sign-up register” screen is typically displayed on a client computer and the data that is transacted is typically processed through the web application (106 in FIG. 1) and ultimately stored in the database (108 in FIG. 1).

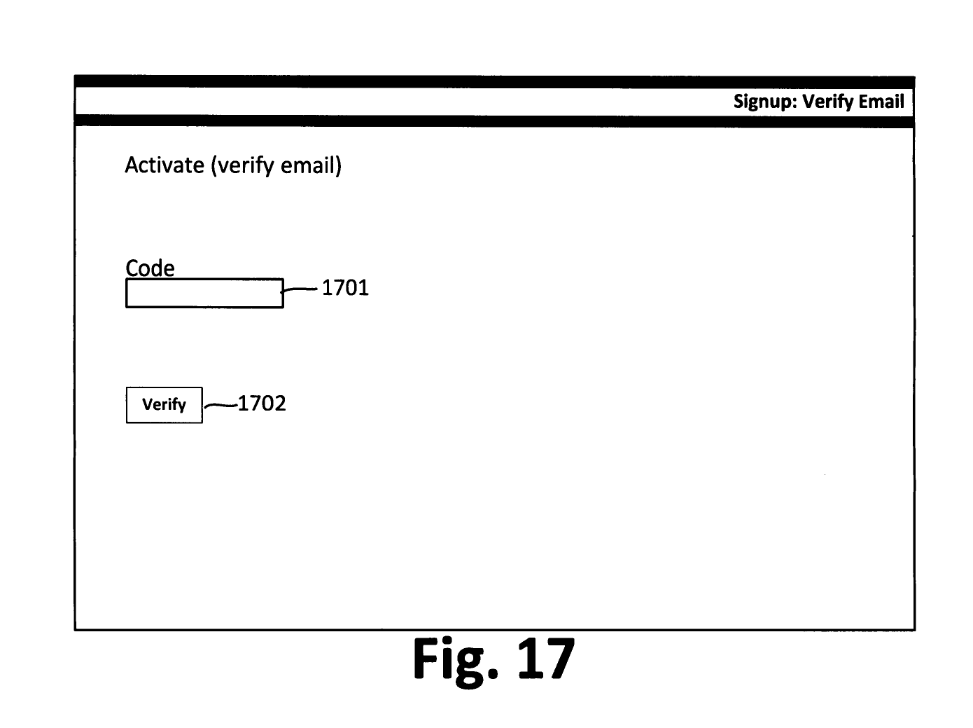

FIG. 17 shows the “signup: verify email” screen, presented after a user signs up. The “signup: verify email” screen instructs the user to check his/her email for an activation code 1701. This email also provides the user with a way to view and accept the user agreement and privacy policy. A user must enter this code and click “Verify” 1702. This procedure ensures that the user has access to the email address that was entered in the previous screens.

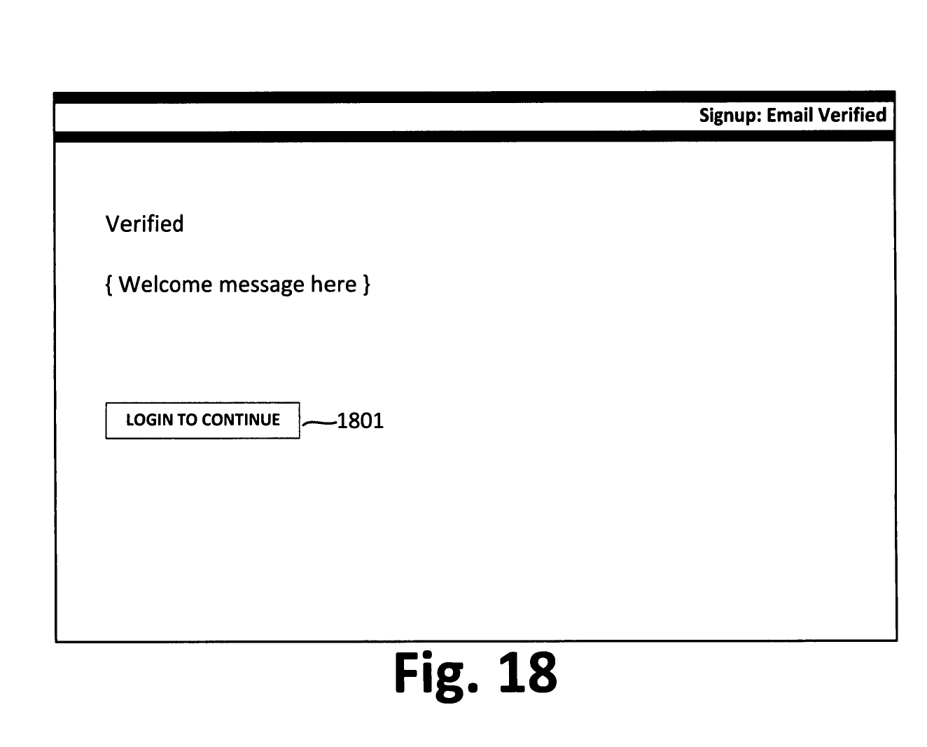

FIG. 18 shows that, once a user is verified, the user is shown a screen confirming that his/her login has been verified. The user is then allowed to login 1801 and to create his/her profile.

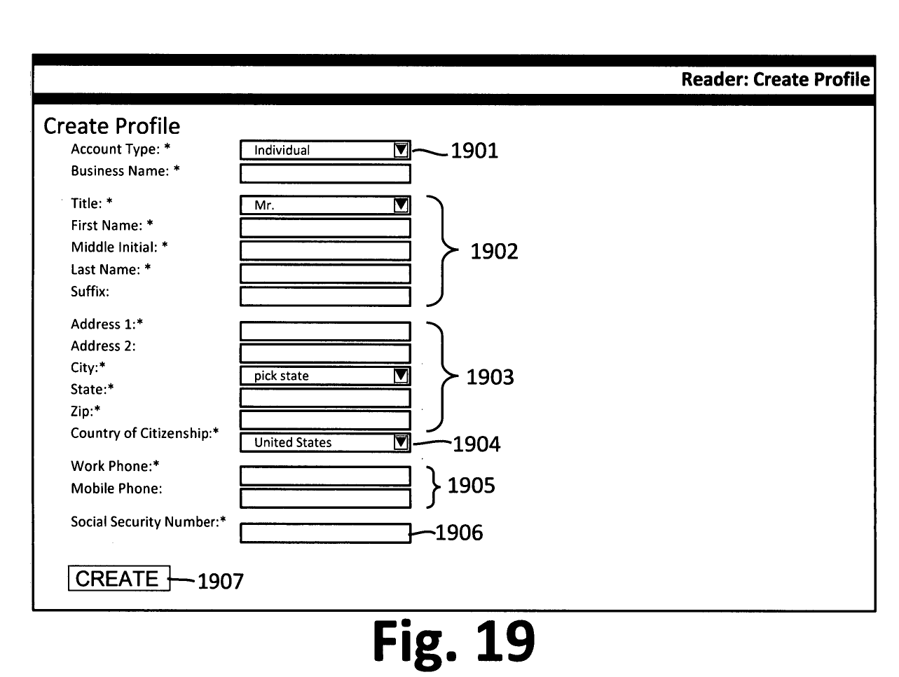

FIG. 19 shows how readers (medical image interpreters) can create their profiles after verification. Readers (medical image interpreters) must choose an account type, which can be either an individual or group 1901. This choice allows a group of individuals to be paid collectively. The reader (medical image interpreter) profile includes name fields 1902, address information 1903, citizenship information 1904, work and mobile phone numbers 1905, and Social Security Number field 1906 that can be used for tax reporting. Once the reader (medical image interpreter) has entered all the information he/she can click the create button 1907 at the bottom of the screen.

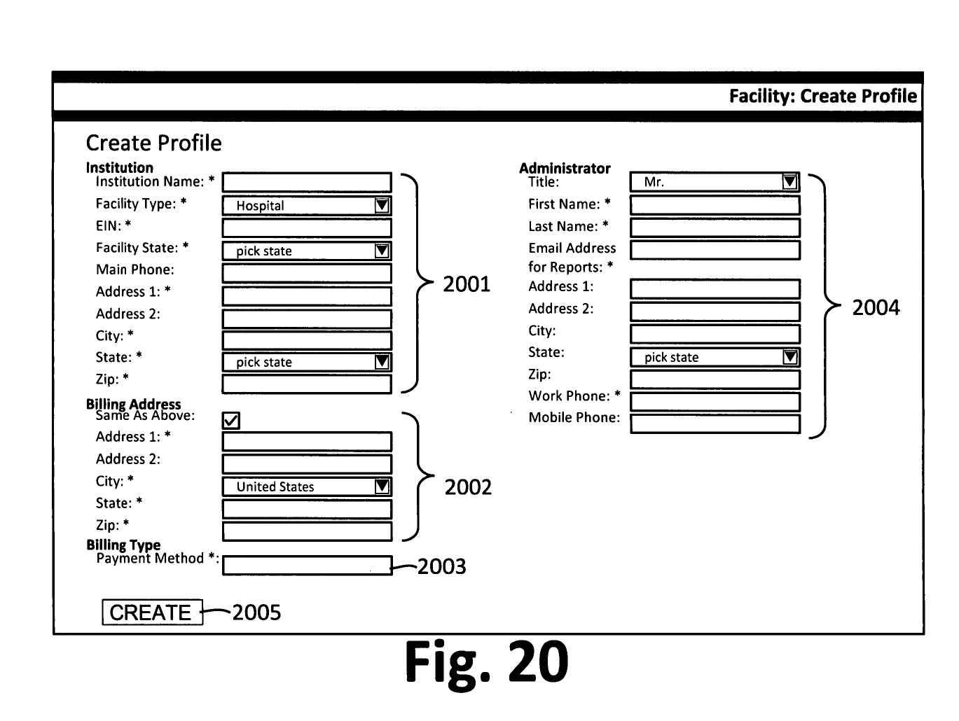

FIG. 20 shows how facilities can create their profiles after verification. A facility must enter information about their institution or organization 2001, billing address information 2002, payment methods information 2003, and information about the facility administrator 2004. Once this information has been entered, the user from a facility can create 2005 his/her profile.

FIG. 21 depicts the account login screen. Users, both readers (medical image interpreters) and facility users, enter their usernames 2101 and passwords 2102 to login. There is a “remember me” checkbox 2103 on the screen so a user doesn't need to enter username, password and click the log in button 2104 every time the user visits the application. This “remember me” checkbox places a small cookie on the user's computer.

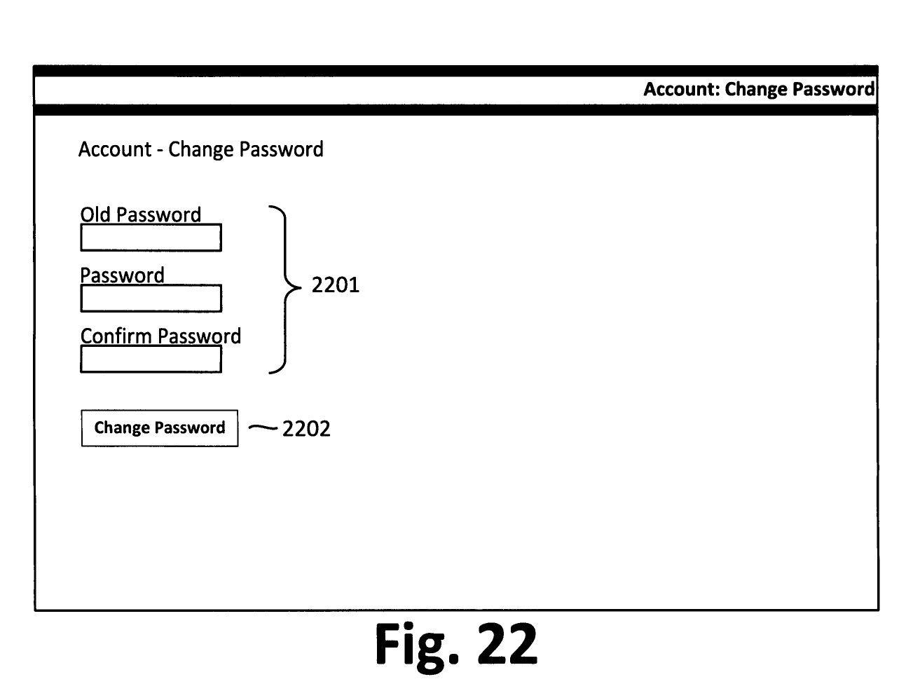

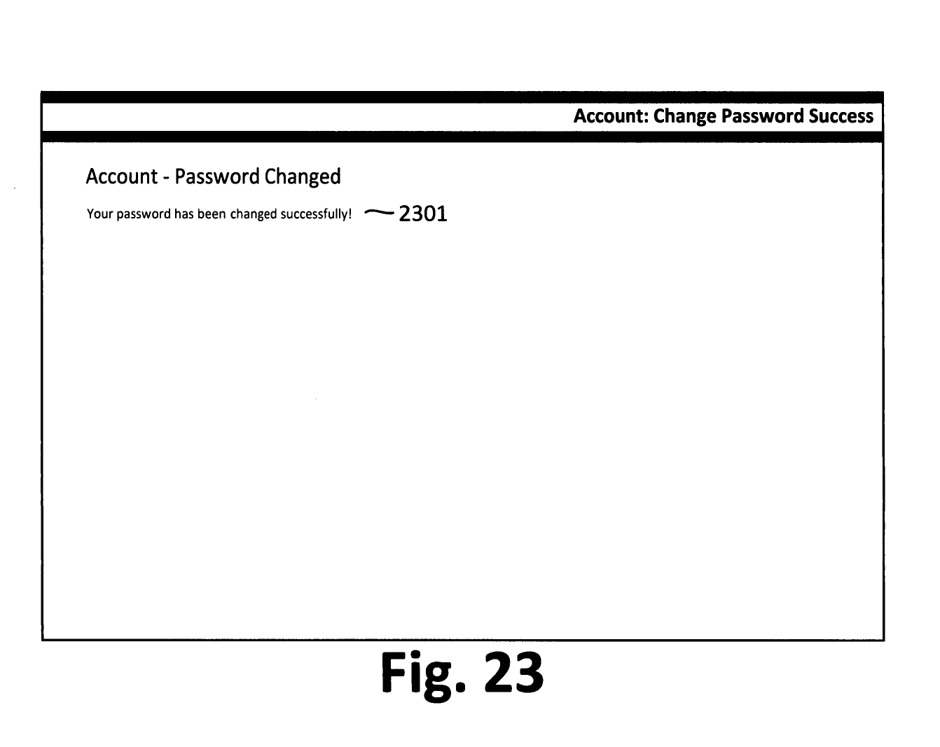

FIG. 22 illustrates the change password screen. Users must enter their old password and new password 2201 to change their password using the “Change Password” button 2202. FIG. 23 depicts a successfully changed password (2301).

FIG. 24 through FIG. 51 provide details of functionality that can be available to readers (medical image interpreters) through a medical image interpreter interface in the system. FIG. 24 is the live exchange page listing all studies (medical image exams) currently within the auction. Both logged in readers (medical image interpreters) and facilities (that send studies/medical image exams to be interpreted) can have a similar screen. The user (medical image interpreter or facility) can select “filter studies” 2401 to display a list of filters that can be applied to the information presented on this screen. Examples of filters can include radiology modalities and subsets of these radiology modalities. A radiology modality is the type of device that is used to perform an exam such as an ultrasound machine or CT (computerized axial topography) scanner. Subsets of a modality are more specific types of exams, frequently a body system or body part such as neurological or chest, respectively. It is conceived that in another embodiment of the invention, filters could be used specifically to the items being auctioned. Selecting create “Multibid Job” 2402 takes the user to a screen where a “Multibid Job” can be entered, as will be described later. The “sort by” 2403 drop-down box lets the user select from sorting by time left in the auction or by the time that the study (medical image exam) was sent to auction. The output is displayed in a table 2404. Each study (medical image exam) coming from a facility is assigned a unique identification number (or accession number). In addition, if a facility sends studies (medical image exams) with accession numbers already assigned 2405 their accession number is also displayed in this column. This allows identification of studies (medical image exams) both by the users (medical image interpreters and facilities) and administrators of the system. The type (or modality) of each study (medical image exam) is displayed 2406. The study (medical image exam) description column 2407 lists the description for each study (medical image exam) that is sent by the PACS as well as the facility and state that the study (medical image exam) came from. The study (medical image exam) priority column 2408 typically includes whether or not a study (medical image exam) is routine, stat, or ASAP, and whether or not the results need to be called (call report). The reference column 2409 lists a standardized pay rate within the system that can be used for reference. The RVU (relative value unit) for each study (medical image exam), indicating the amount of work required for a study (medical image exam), is listed. This RVU (relative value unit) provides a standardized way of calculating and tracking the volume of work a bidding user (a radiologist in the current example) has won or has the potential to win. The winning bid column 2410 lists the current winning bid. It also indicates whether or not the current reader (medical image interpreter) is winning the bid, the lowest bid they have entered, or if the study (medical image exam) has been bid on at all. The last column 2411 indicates how much longer the study (medical image exam) will be in the auction. There are buttons for navigating and displaying the pages, 2412 and 2413. There's also a display of the total number of studies (medical image exams) 2414.

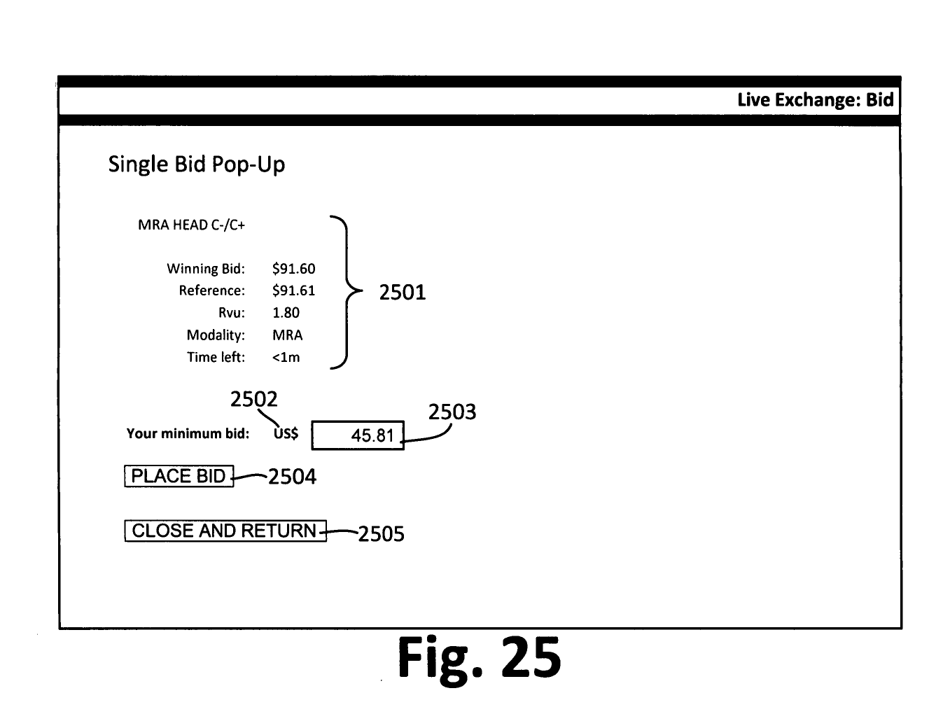

FIG. 25 is the live exchange bid pop-up window. For the study (medical image exam) being bid on, this window lists the study (medical image exam) description, the starting bid from the facility, the reference amount, RVU (relative value unit), modality, and the time left in the auction 2501. The “your minimum bid” field (in US dollars —2502 is automatically populated with the default bid 2503 that the reader (medical image interpreter) entered on his/her profile settings. The reader (medical image interpreter) can place the bid with his/her default bid or can enter another value to change the bid. After clicking “place bid” 2504 and “close and return” (2505), the system tells the reader (medical image interpreter) if he/she has the winning bid or has been underbid by another medical image interpreter in the automated system.

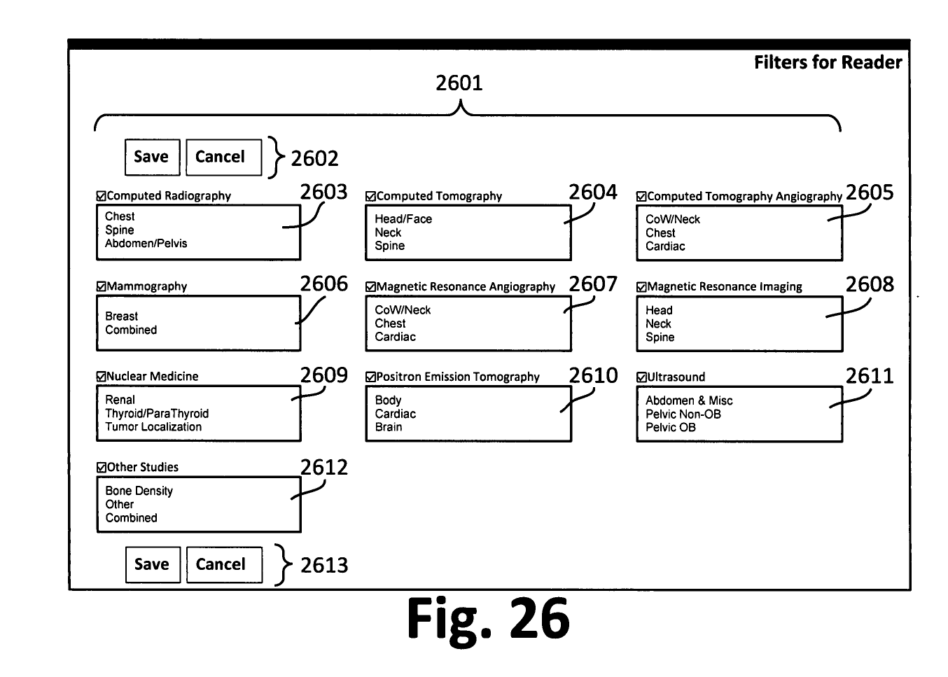

FIG. 26 is the filter pop-up 2601 that allows the user (medical image interpreter or facility) to be able to filter the screen display by modalities and sub modalities, 2603-2612. An example of a modality type is MRI (Magnetic Resonance Imaging). Within each modality are sub modalities such as chest, spine, and extremity. This filter pop-up has save and cancel buttons at the top and the bottom of the screen, 2602 and 2613.

FIG. 27 demonstrates the link 2701 to the Multibid Job creation page 2702 described in reference to FIG. 38.

FIG. 28 is the “My bid status” summary screen 2801 which shows the reader (medical image interpreter) if there are any Multibid Jobs currently running 2802. The “My bid status” screen also provides a button to stop a Multibid Job in progress. The “My bid status” screen shows the number of active winning bids, the number of active losing bids 2803, and the number of studies (medical image exams) that have been won, but not yet dictated 2804. The “My bid status” screen additionally shows RVU (relative value unit) totals 2805. Note that RVU stands for Relative Value Unit, which is a standardized measure of work and other valuation in the medical field. RVU can be defined as a standardized measurement determined by a third party that specifies the amount of work and other valuation in a first task in comparison to a second task. It can be conceived that embodiments of the present invention can use other measurements of work. The use of RVUs can allow the system to determine parameters such as:
a. Secured RVUs, which is the sum of the RVUs of studies (medical image exams) that have been won and are awaiting dictation.
b. Potential RVUs, which are the RVUs of studies (medical image exams) still in the auction that the user currently has the winning bid on. The user may or may not win these studies (medical image exams), which is why they are termed “Potential RVUs”.
c. Total RVUs, which is the sum of the Potential and the Secured RVUs for the reader (medical image interpreter).

Tracking the Secured and Potential RVU limit provides multiple benefits including but not limited to the following:
a. The reader (medical image interpreter) placing bids can set a default overriding RVU limit for all of his/her bids and set a lower RVU limit when placing a Multibid Job so that at any point in time he/she does not win more work than he/she wants.
b. The system administrators can set an overriding RVU limit so that readers (medical image interpreters) do not accidentally win more work or end up with more work in their queue than they can process in the time they have available.
c. Setting an overriding RVU limit prevents a reader (medical image interpreter) from sabotaging the system by placing a low bid on all the available items. The single and multibid bidding ability of a reader (medical image interpreter) can also be automatically turned off if his/her total RVUs reach a set limit.

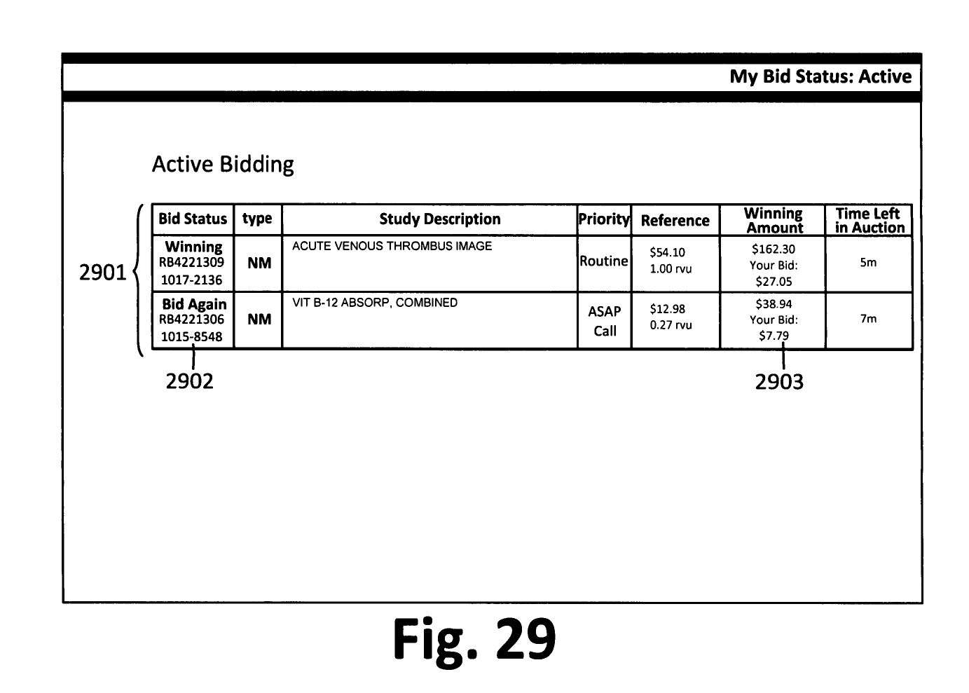

FIG. 29 is the “my bid status: active” screen which lists all studies (medical image exams) currently in the auction which the reader (medical image interpreter) has bid on 2901. The “my bid status: active” screen also displays whether the reader (medical image interpreter) is winning or losing the bid 2902 and the current winning amount for the bid 2903. The “my bid status: active” screen can display additional information about each study (medical image exam) as described with reference to FIG. 24. If a reader (medical image interpreter) is losing a bid, he/she she can place a new bid from the screen by clicking a link.

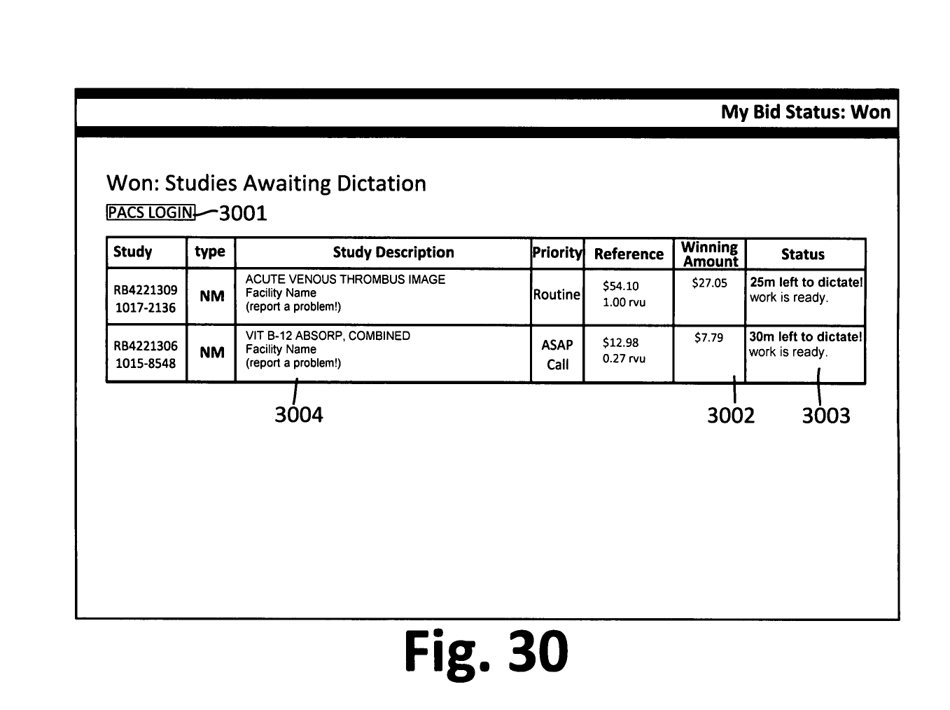

FIG. 30 is the “my bid status: won” screen which shows all studies (medical image exams) that the reader (medical image interpreter) has won but not yet provided the service for. The reader (medical image interpreter) has a PACS login button 3001 that allows him/her to be taken directly to the PACS login screen where he/she can complete his/her work. The “my bid status: won” screen also displays the auction price at which the reader (medical image interpreter) won the study (medical image exam) 3002 and how long he/she has left to provide the service for each individual study (medical image exam) 3003. Facilities and the system administrators can set time limits on different types of studies (medical image exams) so that readers (medical image interpreters) can no longer bid if they don't finish their work on time. In addition, if the readers (medical image interpreters) don't perform their work on time, studies (medical image exams) can be removed from them and re-auctioned. Readers (medical image interpreters) can also report problems with a study (medical image exam) by clicking the “report problem” link under the description of each study (medical image exam) 3004. Other study (medical image exam) data is listed as previously described.

FIG. 31 demonstrates the ability to report-a-problem. The unique study (medical image exam) information is listed at 3101 and comprises some of the information included in the medical image exam meta data discussed previously. On the screen, the reader (medical image interpreter) can select from a list of the most common types of problems with a study (medical image exam) 3102 or enter free-form text describing another problem 3103. The “report a problem” screen also allows the reader (medical image interpreter) to enter the name of the technologist (i.e. facility tech or individual that sent the study) they spoke with to report the problem 3104. With each problem the reader (medical image interpreter) can select from one of four options on how the study (medical image exam) is handled 3105 and the problem can be processed as was described with reference to FIG. 14 and as summarized below:
1. Problem type 1 (1410), the status of the study (medical image exam) is not changed because they are just reporting a minor problem but will still dictate the study (medical image exam).
2. Problem type 2 (1420), “I contacted the technologists and he/she will fix the problem and resend study (medical image exam) for me to read without re-auction.” If the reader (medical image interpreter) selects this option, the timer on the study (medical image exam) is stopped since the user is not expected to dictate the study (medical image exam) until it has been completed correctly. In addition, the study (medical image exam) status is automatically switched from “undictated” status to “incomplete” in the PACS. Once the technologist has corrected the problem, the technologist can switch the study (medical image exam) status back to “undictated”, at which time the timer resumes. Note that the study (medical image exam) is not sent back through the auction when this option is selected.
3. Problem type 3 (1430) “I contacted the technologist, after correcting, please submit for re-auction.” If a reader (medical image interpreter) selects this option, the study (medical image exam) is removed from the list of studies (medical image exams) to be performed by the reader (medical image interpreter) and the timer is stopped. The status of the study (medical image exam) is changed to “incomplete”. When the technologist corrects the problem and changes it back to “undictated”, the study (medical image exam) is put back in the auction.
4. Problem type 4 (1440) “I attempted to call technologist but was unable to reach them” pauses the timer and flags the study (medical image exam) for further action by the system administrator on an administration screen.

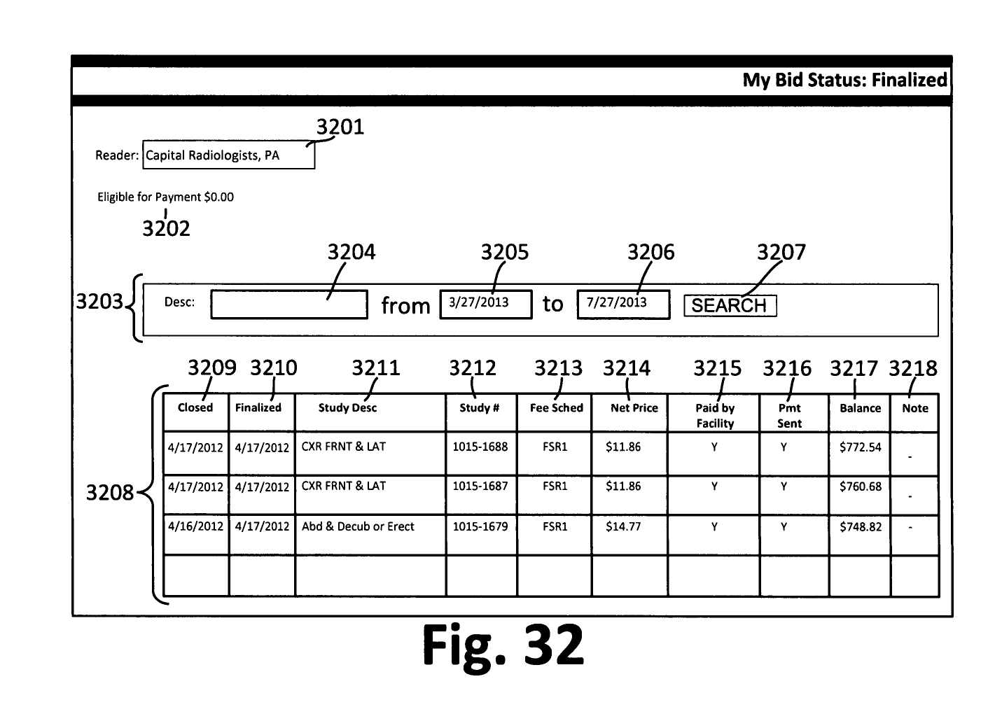

FIG. 32 is the “my bid status: finalized” screen that is displayed for an individual reader (medical image interpreter) 3201. At the top, the finalized accounting screen shows how much money the user has earned that is eligible for payment 3202. This screen can include a search field for individual studies (medical image exams) 3203 that can allow numeric or text search 3204. The reader (medical image interpreter) can also search within a customizable date range, shown at 3205 and 3206. A search button is provided 3207. The accounting information is output in table format 3208. The finalized accounting screen can list the times when studies (medical image exams) completed the auction 3209 (i.e. were closed) and it can list the times the reader (medical image interpreter) finalized the study (medical image exam) by signing the report 3210 in the PACS. Along with the study (medical image exam) description and number 3211, 3212 the finalized accounting screen shows the fee schedule that the system charges to the reader (medical image interpreter) for the auction 3213. This fee schedule is customizable by the administrator for each reader (medical image interpreter). The net price is the price the study (medical image exam) was auctioned for minus the auction fee 3214. The “paid by facility” column indicates whether or not the facility has paid for a study (medical image exam) 3215. This “payments sent” column shows if payments have been sent to the reader (medical image interpreter) 3216. The running balance owed to the reader (medical image interpreter) can also be listed 3217. A note can be entered about each line item 3218.

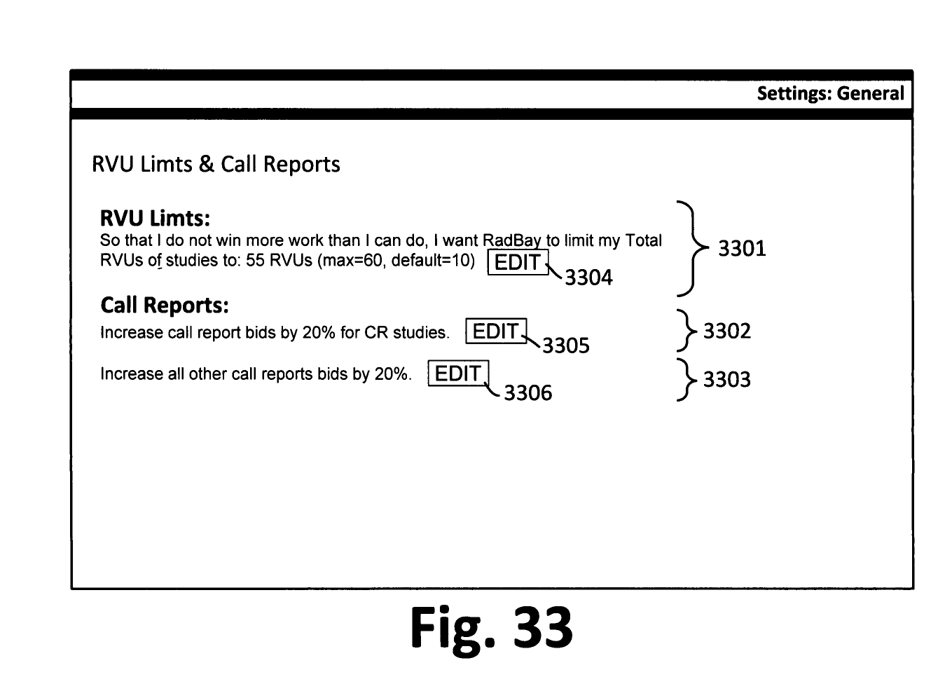

FIG. 33 is the “settings: general” screen that displays current RVU (relative value unit) limits 3301 and bid adjustments for call reports 3302 and 3303. The “settings: general” screen also provides edit buttons that allow the reader (medical image interpreter) to edit his/her current RVU (relative value unit) limit 3304 and to edit his/her bid adjustments for call reports 3305 and 3306, automatically increasing the bid amount by the percentage entered if the study (medical image exam) results need to be called. It can be conceived that in another embodiment of the invention, there can be other types of special factors requiring bid modification by the bidders.

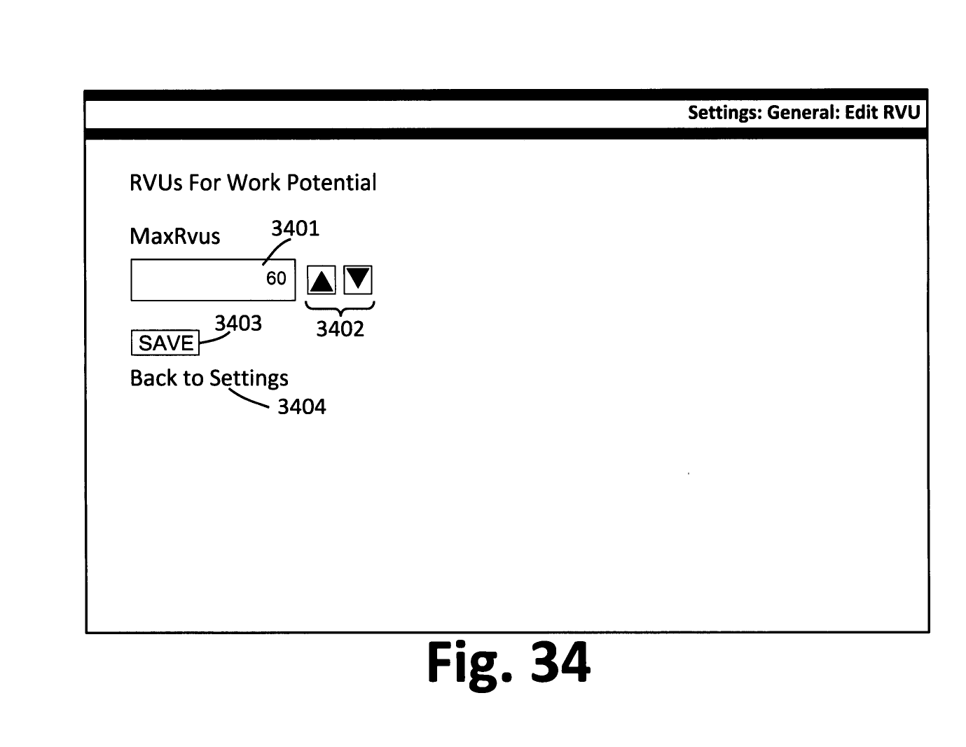

FIG. 34 is the screen where reader (medical image interpreter) can edit his/her RVU (relative value unit) setting 3401 and 3402, which automatically stops bidding before the reader (medical image interpreter) wins more work than he/she is capable of performing. Buttons are provided to save the new settings 3403 and go back to the other settings 3404.

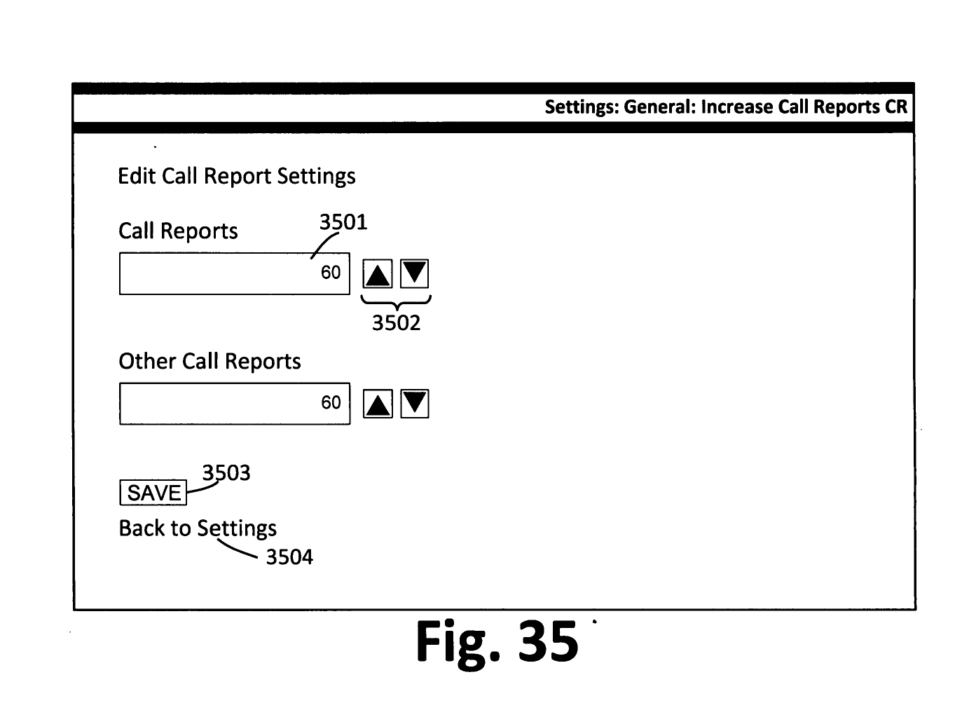

FIG. 35 is the page where the reader (medical image interpreter) can automatically increase his/her default bid for computed radiography (CR) studies (medical image exams) with reports that must be called 3501 and 3502. There are buttons to save the new settings 3503 and go back to the other settings 3504.

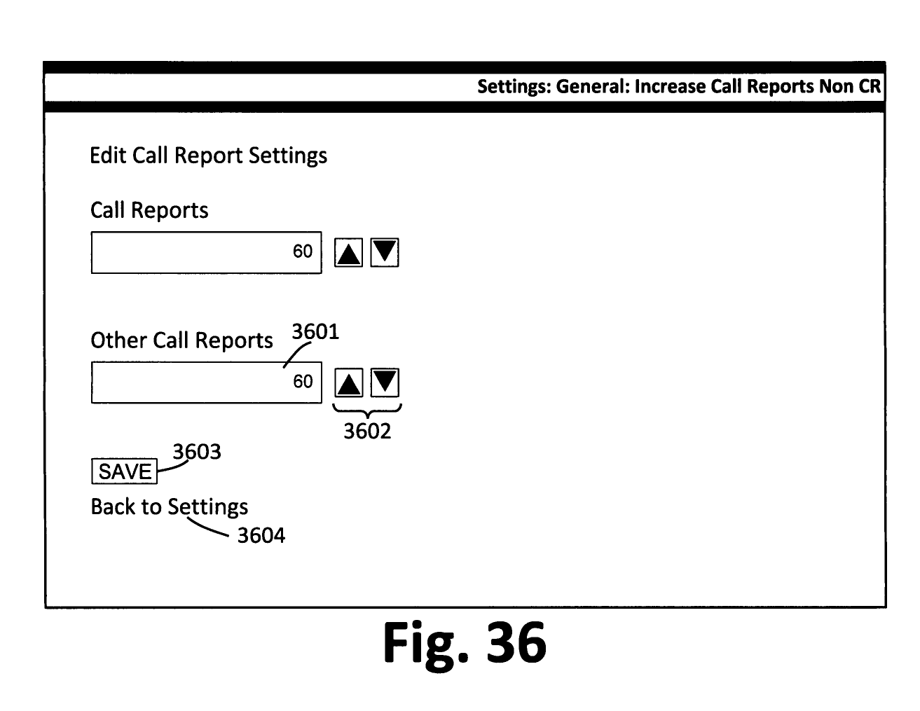

FIG. 36 shows where reader (medical image interpreter) can automatically increase his/her bid for all other modalities (except CR) with studies (medical image exams) that have a report that must be called 3601 and 3602. There are buttons to save the new settings 3603 and go back to the other settings 3604.

FIG. 37 is the “settings: bid settings default values” screen, which includes a filter for showing all Current Procedural Terminology (CPT) codes, the most frequently used codes, or just the codes for which the reader (medical image interpreter) has already set custom relative values 3701. The “settings: bid settings default values” screen could also use other kinds of medical codes, such as those discussed previously with reference to FIG. 1. During initial sign-up or at any time after initial sign-up, a reader (medical image interpreter) can set the default bid settings for every study (medical image exam) type. This bid value is the minimum price for which a reader (medical image interpreter) is willing to interpret a medical image. All the codes are categorized by modality 3702. For each modality, the reader (medical image interpreter) can enter an overriding percentage 3703 to be applied to the reference value for their bids. An update button is provided 3704. Each study (medical image exam) type is listed by an identifying number/code 3705 and description 3706 so that studies (medical image exams) across multiple facilities are standardized. For each study (medical image exam), the RVU (relative value unit) 3707 is listed along with a baseline reference value 3708 for the reader (medical image interpreter). The “settings: bid settings default values” screen lists the default bid amount 3709 that was calculated by applying the percentage 3703 entered by the reader (medical image interpreter) to the reference value 3708. The reader (medical image interpreter) can override each individual default bid value for each study (medical image exam) by entering a specific value (3710). In this case the override mount would be displayed but not the amount determined by percentage. With these two options, the reader (medical image interpreter) can adjust all of the default bid values for a modality at once by applying a percentage, or the reader (medical image interpreter) can set an individual bid amount for each study (medical image exam) type. There is also a link on this screen so the reader (medical image interpreter) can adjust their call report settings. An update button is provided at the bottom of the screen 3711.

Instead of bidding on individual studies (medical image exams) by placing bids on the live exchange page, the reader (medical imager interpreter) can use the Multibid Job tool shown in FIG. 38, which allows the reader (medical image interpreter) to bid on numerous studies (medical image exams) at once, a significant productivity improvement. Facilities entering exams to be auctioned use a specific identifier so that identical items can be auctioned the same. In the current embodiment of the invention, facilities enter a CPT (Current Procedural Terminology) for each study (medical image exam) being sent to the auction, ensuring that identical item types are auctioned the same. Reviewing the “settings: multibid job” screen of FIG. 38 in detail:
Step 1 instructs the reader (medical image interpreter) to be sure his/her default bid settings (bid amounts) are set correctly as was described with reference to FIG. 37. The words “Bid Settings” is a link that goes to the screen that was shown in FIG. 37 in which default bid settings and amounts are used to place the bids uniquely for each type of procedure as determined by CPT in one embodiment of the present invention.
Step 2, shown at 3801, allows the reader (medical image interpreter) to enter a Bid Adjustment Factor. This factor is a percentage that is multiplied by the reader's default bid for each study (medical image exam) type. This allows the reader (medical image interpreter) to customize his/her bids every time the Multibid Job is used so that he/she does not have to go and edit the entire list of default bids individually. The reader (medical image interpreter) can use the Bid Adjustment Factor to refine his/her bids and therefore influence the amount of work he/she is winning.
Step 3, shown at 3802 allows the reader (medical image interpreter) to set an RVU (relative value unit) limit so that he/she doesn't win more work than he/she is capable of doing.
Step 4, shown at 3803 allows the reader (medical image interpreter) to set a time limit for the Multibid Job, which is beneficial, for example, if he/she wants to work for a limited number of hours—the Multibid Job can be set to run for just those hours.
Step 5, shown at 3804, allows the reader (medical image interpreter) to filter which modality and sub modality types he/she currently wants to bid on.
In addition, there is a button 3805 that allows a reader (medical image interpreter) to stop a Multi bid Job that is already running.

FIG. 39 is the screen where the reader (medical image interpreter) can select which facilities (imaging centers) for which he/she is willing to provide services. There is a drop-down menu 3901 where the reader (medical image interpreter) can indicate that he/she will provide services for any facility or an option so the reader (medical image interpreter) can select facilities individually. There is also a search field where the reader (medical image interpreter) can search the facility list by name 3902. Each facility is listed by name 3903. In addition when a facility on the list is selected, the contact information including the phone number and address for each facility is displayed 3904. Buttons are displayed that allow the reader (medical image interpreter) to toggle between will/will not read for each facility 3905. Note that this list of eligible facilities displayed for the reader (medical image interpreter) is also filtered based on the states in which the reader (medical image interpreter) has a medical license. If a reader (medical image interpreter) blocks a facility by selecting “will not” read for the facility, that facility's studies (medical image exams) are no longer displayed on the live exchange page or available for the reader (medical image interpreter) to bid on.

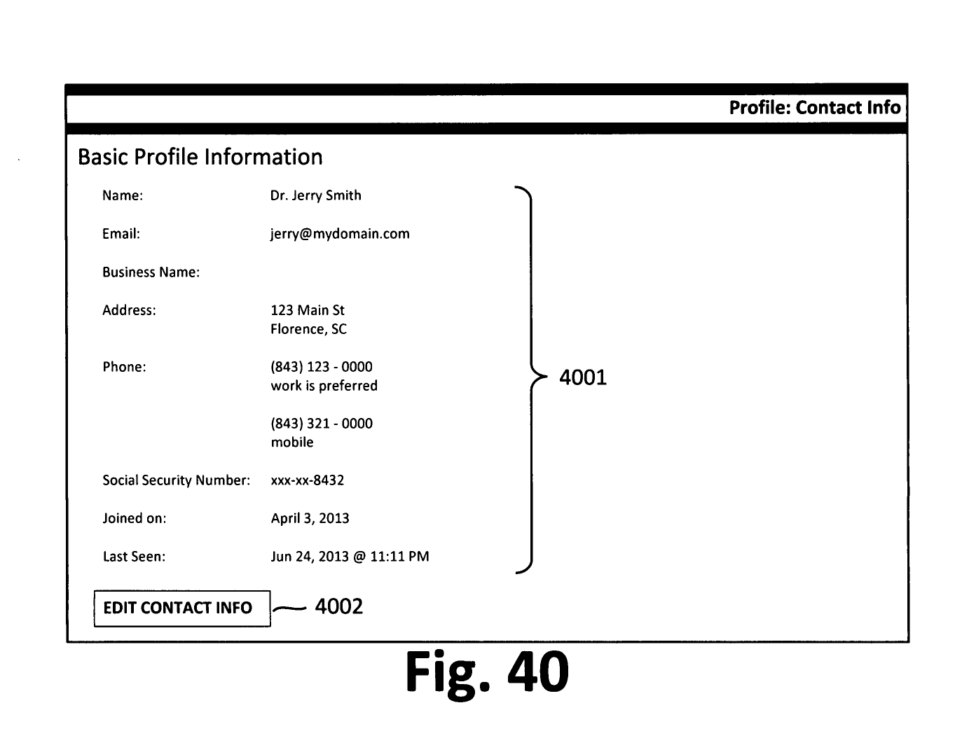

FIG. 40 is the “profile: contact info” screen where the reader (medical image interpreter) can see the personal information 4001 the system stores. The reader (medical image interpreter) is allowed to edit this information 4002.

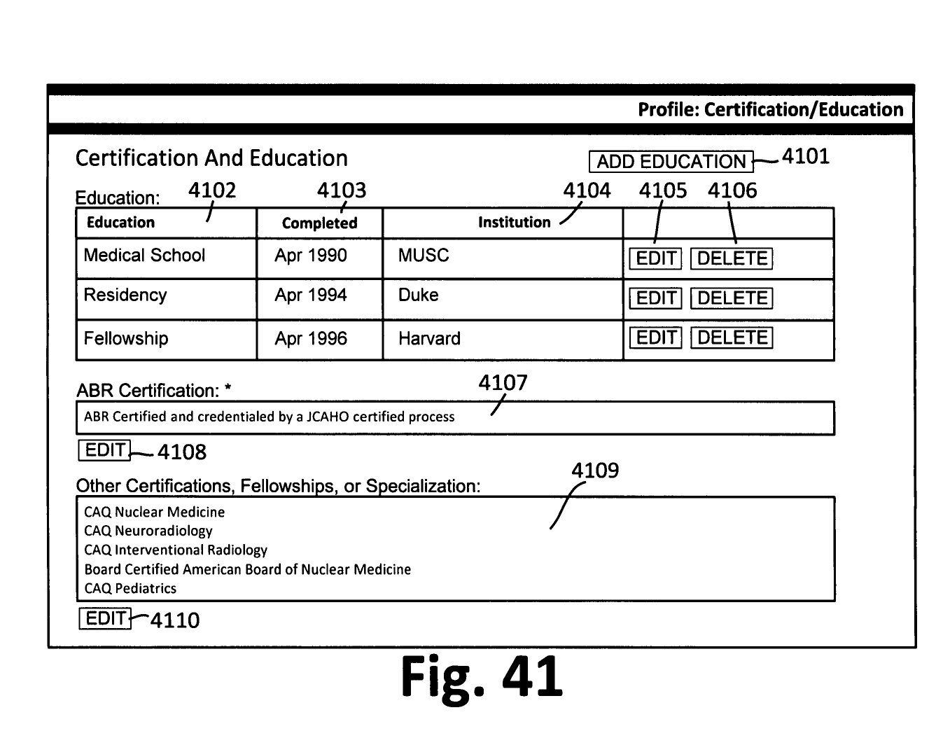

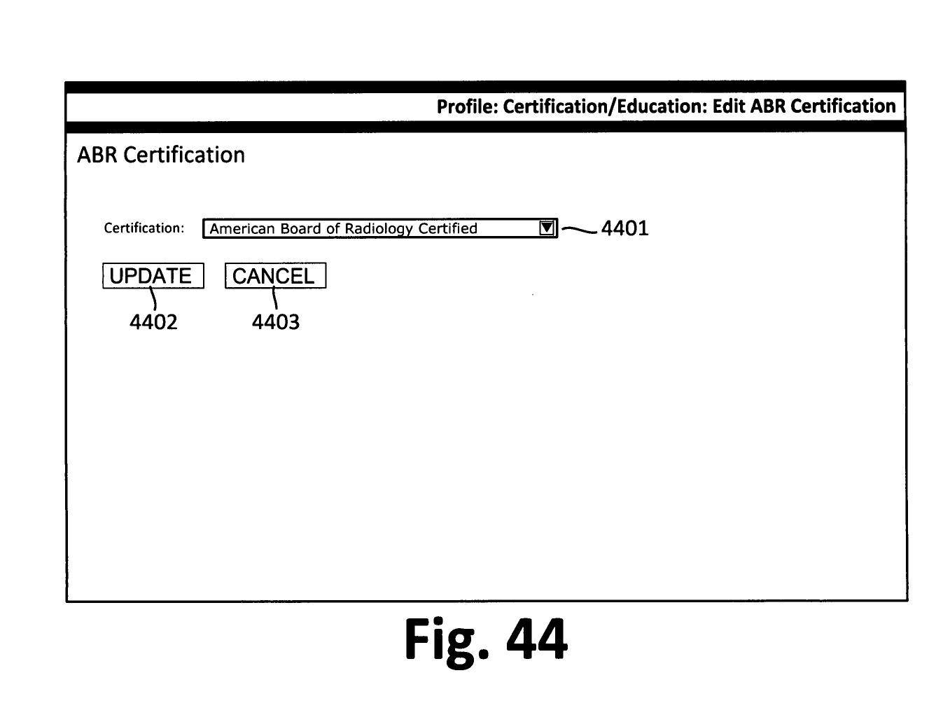

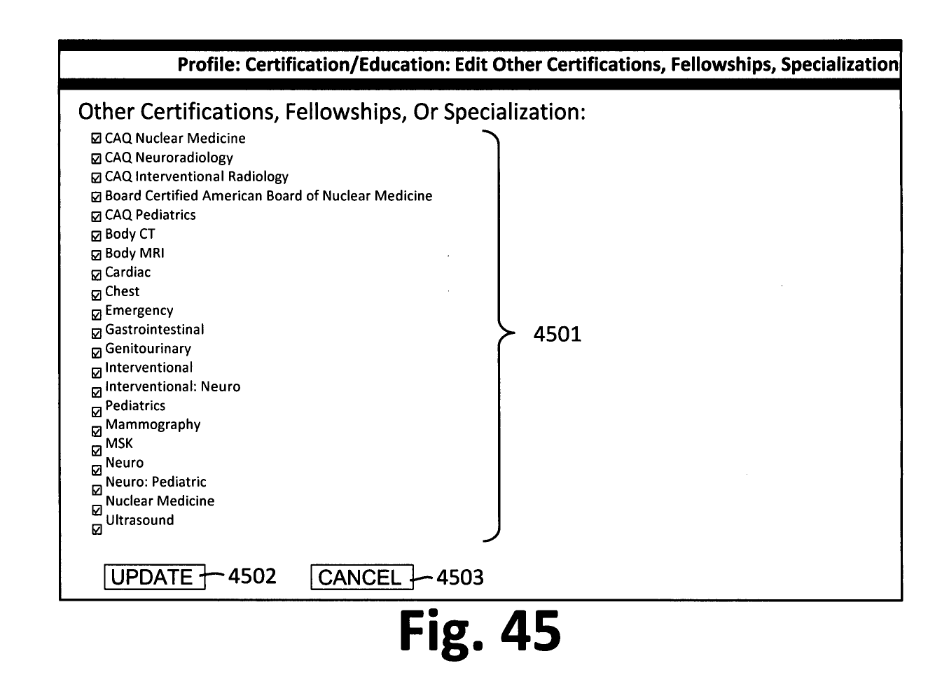

FIG. 41 is the “profile: certification/education screen”. The reader (medical image interpreter) can see and edit 4105 all of their past education 4102 including dates 4103 the education was completed and the institution 4104 where the education was received. The reader (medical image interpreter) can add 4101 education information or delete 4106 information if a mistake is made. The screen can also be customized to display various other levels of certification. In the current example shown 4107, the reader (medical image interpreter) can indicate if they are a resident in training, American Board of Radiology (ABR) certified, or ABR certified and credentialed by a JCAHO (Joint Commission on the Accreditation of Healthcare Organizations) certified process. This level of certification can also be edited 4108. This edit is described with reference to FIG. 44. The reader (medical image interpreter) can see 4109 and edit 4110 other certifications, fellowships, or specialization, as described with reference to FIG. 45.

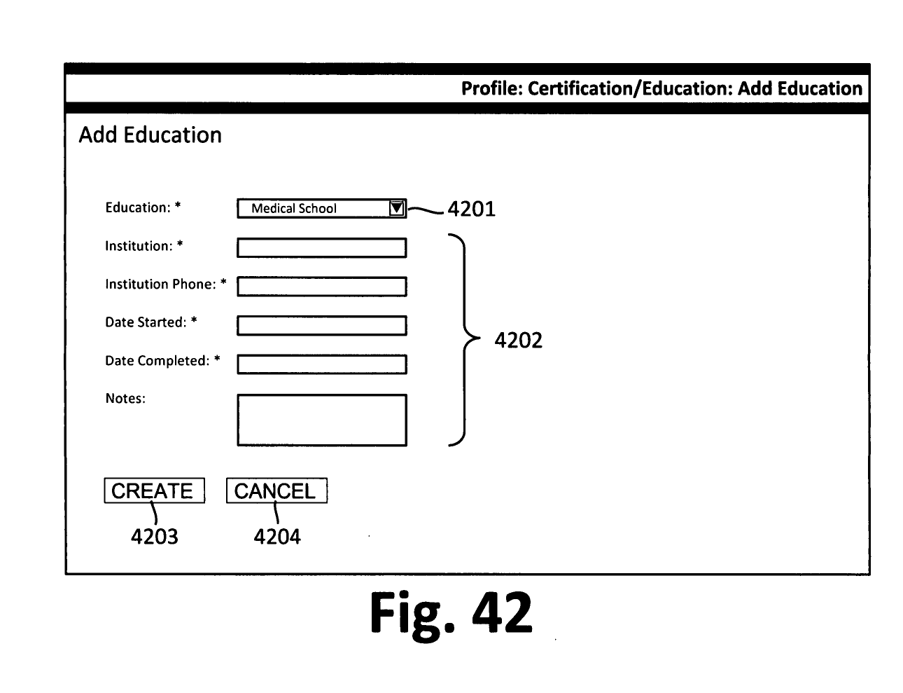

FIG. 42 shows how a reader (medical image interpreter) can add education to his/her profile. The reader (medical image interpreter) would first choose what type of education he/she is adding 4201 and then enter the appropriate institution information 4202. Once complete, the reader (medical image interpreter) can click the create button 4203. The medical image interpreter can also cancel 4204 out of the screen.

In the event that a mistake was made during the addition of education information, the reader (medical image interpreter) can edit the type of education 4301 and any information about the institution 4302. The reader (medical image interpreter) can save this information using the save button 4303 or cancel out the screen using the cancel button 4304.

ABR certification levels are industry-standard and can be selected 4401 by the reader (medical image interpreter). Each option is mutually exclusive. The reader (medical image interpreter) can update using the update button 4402 or cancel out the screen using the cancel button 4403. Current industry-standard options for ABR (American Board of Radiology) certification levels are “resident in training”, “ABR certified”, and “ABR certified and credentialed by JCAHO certified process”. These certification levels can be any set of levels that are relevant to the professional category of the reader (medical image interpreter) field of medical specialization and sub specialization or any other system capable of being understood by anyone skilled in the art.

Since readers (medical image interpreters) can further their education, the system can be configured to allow for a reader (medical image interpreter) to specify any additional certifications, fellowships, or specialization 4501. The reader (medical image interpreter) can choose as many or as few of these options as he/she has achieved. Once complete, the reader (medical image interpreter) can update his/her record using the update button 4502 or cancel out of this screen using the cancel button 4503.

The reader profile allows a reader (medical image interpreter) to see the states in which he/she has a medical license. The system uses this information to filter the studies (medical image exams) in the auction so that the reader (medical image interpreter) can only bid on studies (medical image exams) for which he/she has a medical license. The system can be capable of tracking the state 4601, the license number 4602, the expiration date 4603, and the certifying agency 4604. The reader (medical image interpreter) is allowed to add new licenses 4601 or edit 4605 and delete 4606 incorrect information.

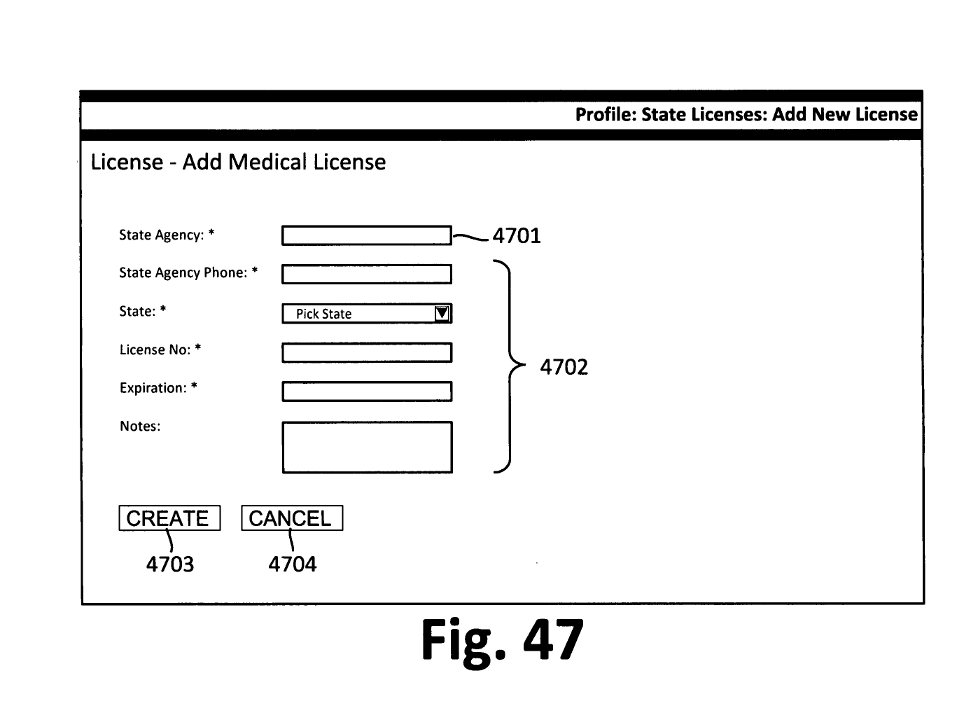

FIG. 47 shows how the system can allow the reader (medical image interpreter) to add a medical license by entering the certifying state agency 4701 as well as contact information and specific information 4702 about his/her license. To add the license to his/her profile, the reader clicks the create button 4703. To cancel out of the screen the reader (medical image interpreter) uses the cancel button 4704.

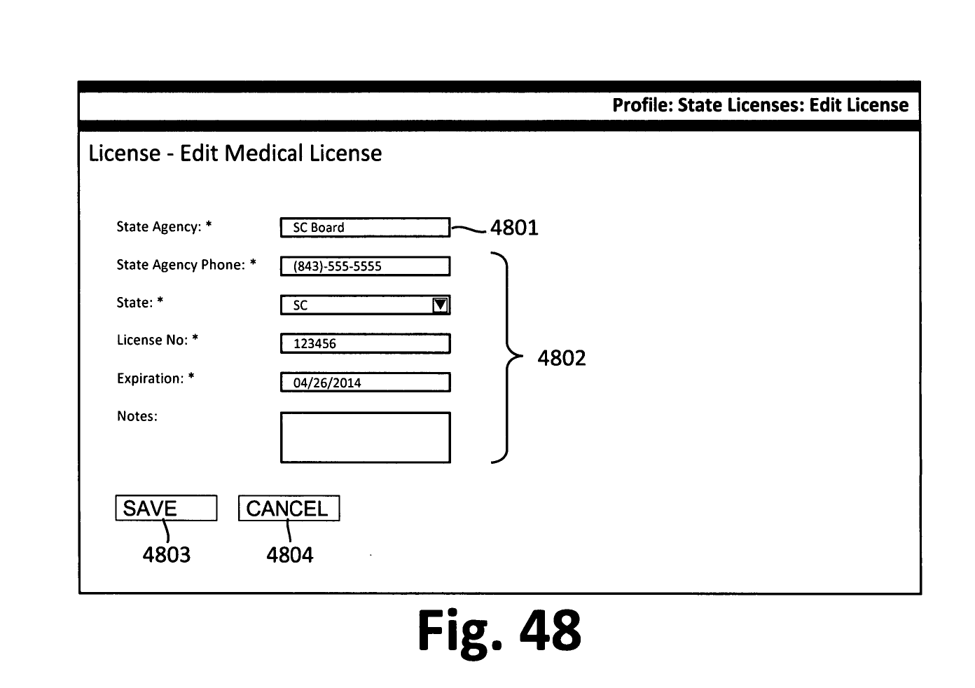

In the event that a reader (medical image interpreter) must edit a state medical license, FIG. 48 shows that he/she is allowed to edit the credentialing state agency 4801 or information about his/her license 4802. The reader (medical image interpreter) can save the updated information using the save button 4803 or cancel out the screen using the cancel button 4804.

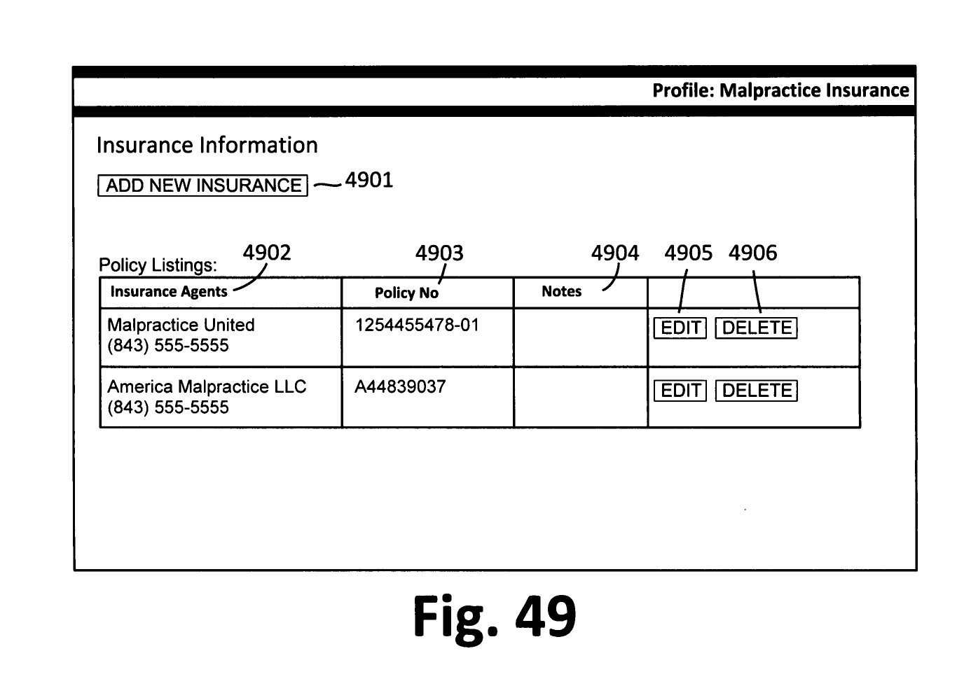

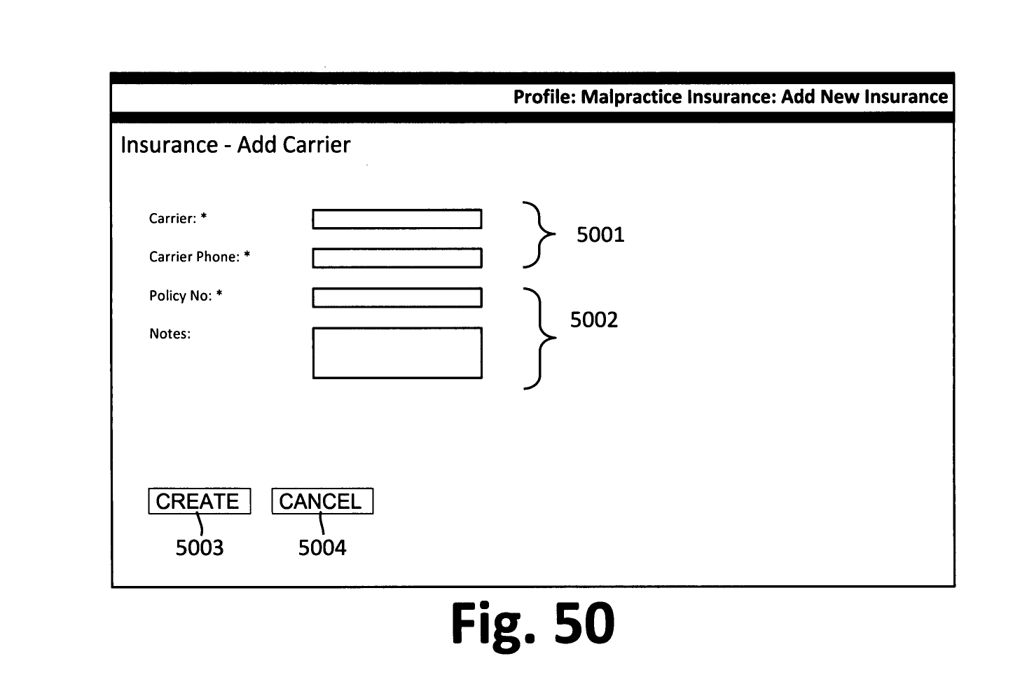

FIG. 49 is the “profile: malpractice” screen where a reader (medical image interpreter) can ensure that he/she has entered the correct malpractice insurance information. The “profile: malpractice” screen can also shows the insurance agent 4902, policy number 4903, and notes 4904. The reader (medical image interpreter) has an opportunity to edit 4905 and delete 4906 this information if it is incorrect. FIG. 50 illustrates how this information can be added 4901. To add a malpractice insurance carrier, the reader (medical image interpreter) would enter the carrier's name and phone number 5001. The reader (medical image interpreter) would also enter the policy information along with any notes 5002. To create this record on his/her profile the reader (medical image interpreter) would use the create button 5003. To cancel out of the screen, the reader (medical image interpreter) would use the cancel button 5004.

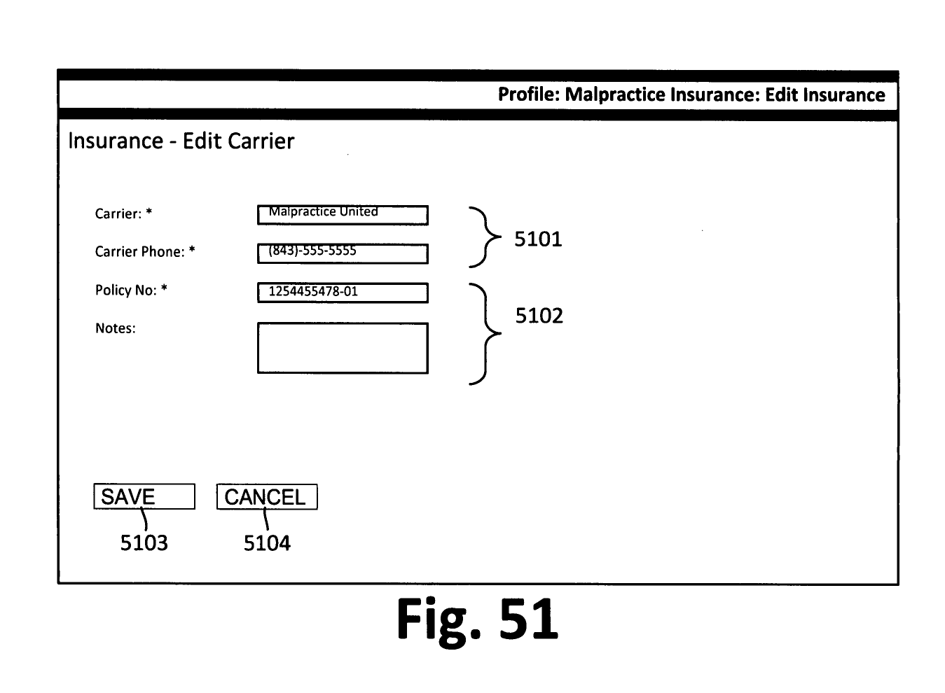

In the event malpractice insurance information must be edited, the reader (medical image interpreter) would change the carrier name and/or phone number 5101, along with the policy number and/or any notes 5102 in the “profile: malpractice insurance: edit insurance” screen shown in FIG. 51. The information entered into this screen can be saved using the save button 5104 or the reader (medical image interpreter could cancel out of the screen using the cancel button 5104.

FIG. 52 through FIG. 65 provide details of functionality that can be available to the staff at medical facilities that purchase image interpretation services in the form of studies (medical image exams) from readers (medical image interpreters) through the purchasing facility interface in the system. Medical facilities staff can include technologists and facility administrators. When facility personnel login to the purchasing facility interface of the system, they only have access to studies (medical image exams) and functionality specific to their facility. Medical facility staff can have multiple levels of privileging and therefore levels of access to the system depending upon their roles at the medical facility as was described with reference to FIG. 3. In one embodiment of the present invention, medical technologists cannot see pricing information or edit who has privileges on the system. The facility administrator however can edit pricing and block/unblock which readers (medical image interpreters) are desired and credentialed to use the system. The facility administrator can also add new technologist and supervisor users.

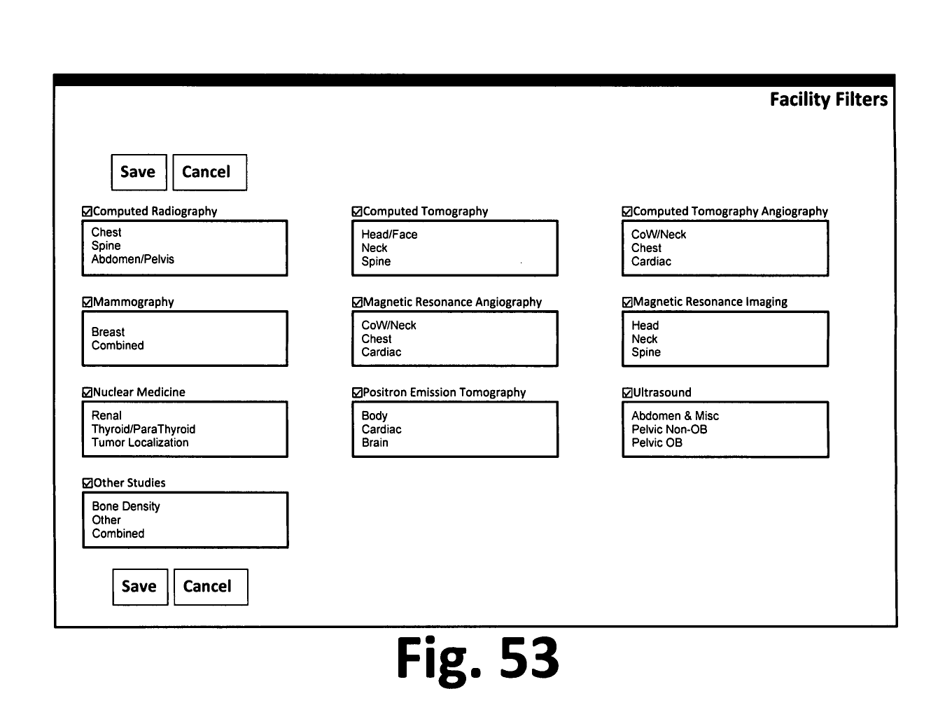

FIG. 52 shows a list of the studies (medical image exams) and study (medical image exam) information being auctioned in one embodiment of the present invention. The screen in FIG. 52 that is part of the purchasing facility interface is similar to the live exchange screen, shown in FIG. 24 that was part of the reader (medical image interpreter) interface, except that the screen in FIG. 52 shows studies (medical image exams) for a specific facility. The filter studies button, shown in FIG. 53, can be selected to further filter the display by modality and sub modality. Details of this are similar to the description that was provided for the equivalent screen in the reader (medical image interpreter) interface that was described with reference to FIG. 26.

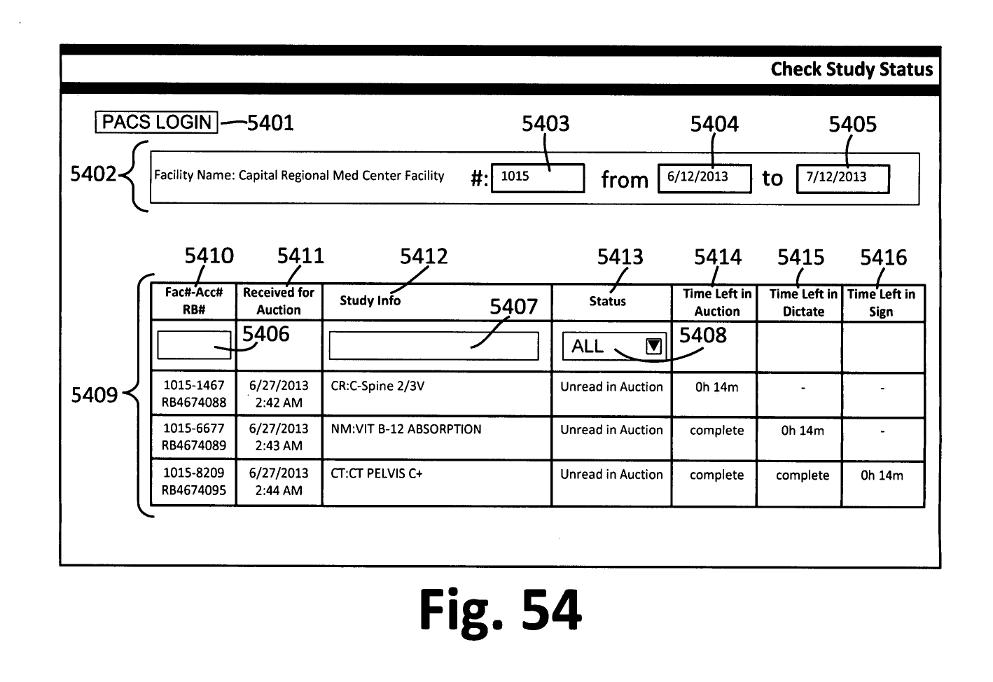

FIG. 54 is the “check study (medical image exam) status” screen where the facility technologist can see the status of all the studies (medical image exams) of the facility. The facility technologist has a link directly to the PACS system 5401. There is a search function available to the facility technologist 5402. The Facility ID 5403 is there for viewing purposes only. The “check study (medical image exam) status” screen can be filtered by start date 5404 and end date 5405. The “check study (medical image exam) status” screen also has search boxes to filter studies (medical image exams) by accession number 5406, study (medical image exam) description or info 5407, or status 5408. The table 5409 on the “check study (medical image exam) status” screen displays identifying information 5410 about each study (medical image exam). This table 5409 also shows when studies (medical image exams) were received for auction 5410. This table 5409 shows study (medical image exam) descriptions 5412, the status of each study (medical image exam) 5413, how long each study (medical image exam) has left in the auction 5414, how long the winner has to dictate the study (medical image exam) 5415, and how long the reader (medical image interpreter) has to sign off the transcribed study (medical image exam) 5416. If the auction has completed for a study (medical image exam), the winning user's name and phone numbers are displayed. The status column shows the current status of each study (medical image exam) and can include the following choices:
a. unread/undictated and still in the auction;
b. unread/undictated status but the auction is finished and it is awaiting dictation;
c. dictated and awaiting transcription;
d. transcribed and waiting for approval by the reader; and
e. approved/finalized and ready for payment.

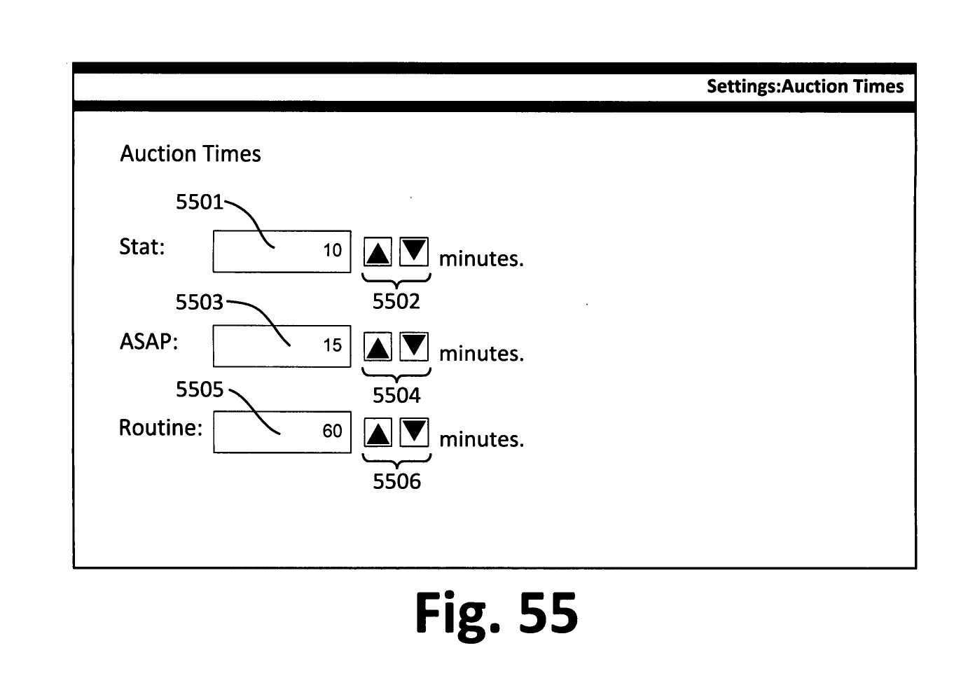

FIG. 55 is the “check study (medical image exam) status: auction time” screen. The facility administrator can set how long each type of study (medical image exam) (for example stat, ASAP, or routine) stays in the auction, either by entering the number or using up down buttons 5501-5506. In addition, the “check study (medical image exam) status: auction time” screen displays the amount of time winning readers (medical image interpreters) have to interpret a study (medical image exam) and how long they have to sign a report once it is transcribed.

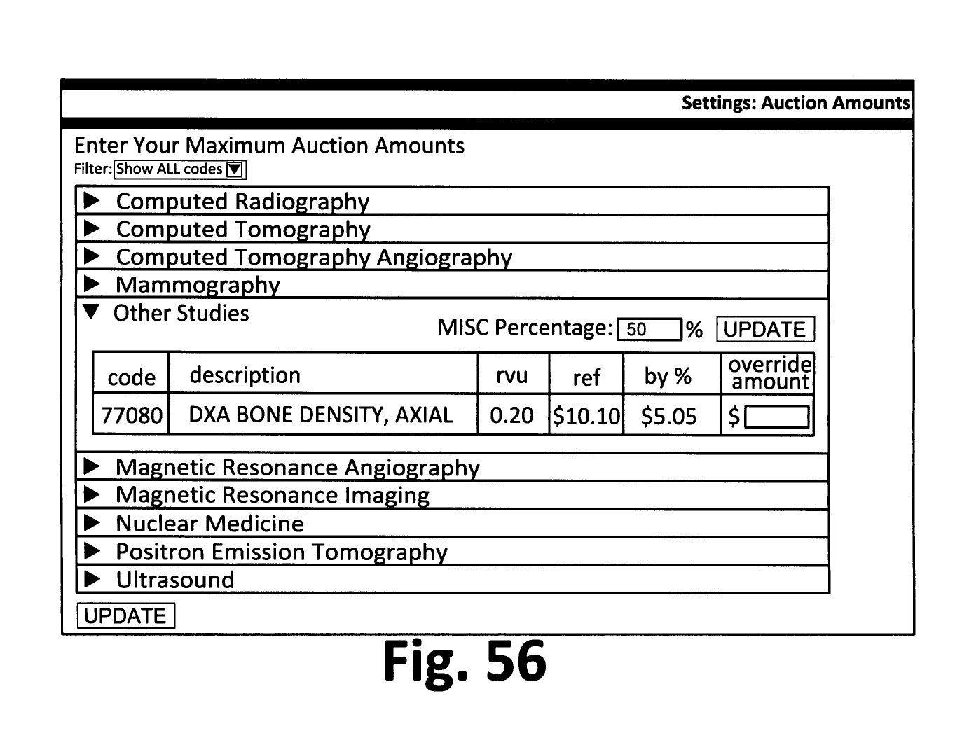

FIG. 56 is the “settings: auction amounts” screen, similar to the “settings: bid settings” screen for the reader (medical image interpreter) that was discussed with reference to FIG. 37. The difference is that the version of this screen in the reader (medical image interpreter) interface allowed the reader/interpreter to enter the minimum price for which he/she is willing to read/interpret a study (medical image exam), whereas the purchasing facility administrator enters the maximum price the purchasing facility is willing to pay to have a study (medical image exam) read/interpreted, or the maximum price the facility is willing to pay for a good or service. On the “settings: auction amounts” screen, the purchasing facility administrator sets the prices that will become the starting auction prices for all studies (medical image exams) this purchasing facility will submit to the system, representing the maximum price the purchasing facility is willing to pay to have a study (medical image exam) read/interpreted. Additional details of this process were presented with reference to FIG. 37.

FIG. 57 is the “settings: readers” screen where the facility administrator can filter which readers (medical image interpreters) are allowed to bid on the studies (medical image exams) submitted to the system by the purchasing facility. The “settings: readers” screen is a mirror of the screen described with reference to FIG. 39. The facility can use the “settings: readers” screen to filter the list of readers (medical image interpreters) by minimum required training levels 5701. The “settings: readers” screen can also be defaulted to allow all new qualified readers (medical image interpreters) to read/interpret the studies (medical image exams) or this screen can allow the purchasing facility administrator to pick specific readers (medical image interpreters) to bid on studies (medical image exams) 5702. The “settings: readers” screen can also have a box to search by reader (medical image interpreter) name 5703, which results in the list of bidders (medical image interpreters) to be displayed below 5704. In addition, when a reader (medical image interpreter) is selected on the list, all of the profile information for this reader (medical image interpreter) including contact information can be displayed, as shown by 5705 and 5707. By toggling between the can/cannot buttons 5706, the facility administrator blocks or unblocks the readers (medical image interpreters) from being able to bid on studies (medical image exams) placed into the system by a specific purchasing facility.

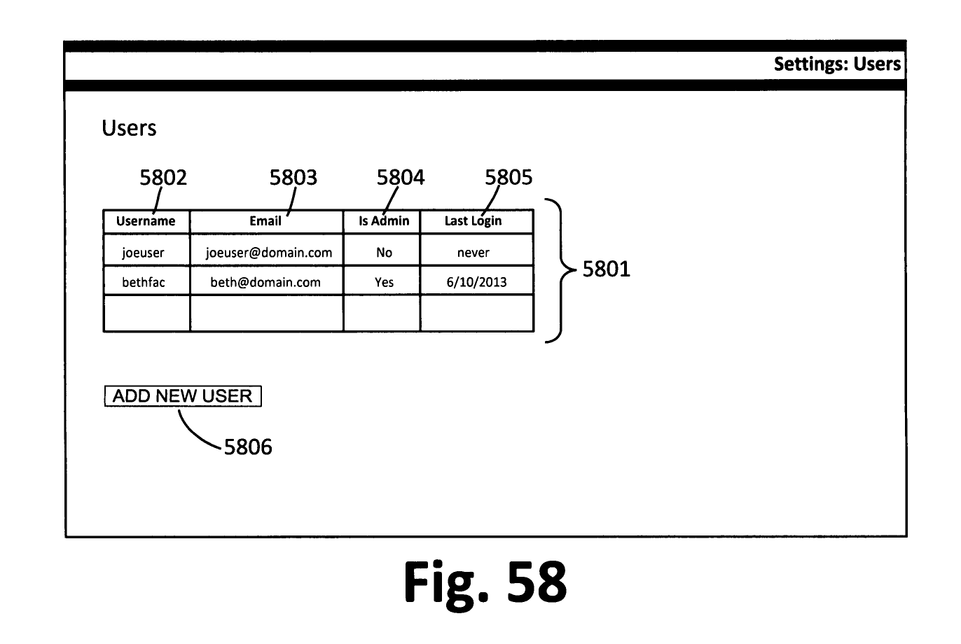

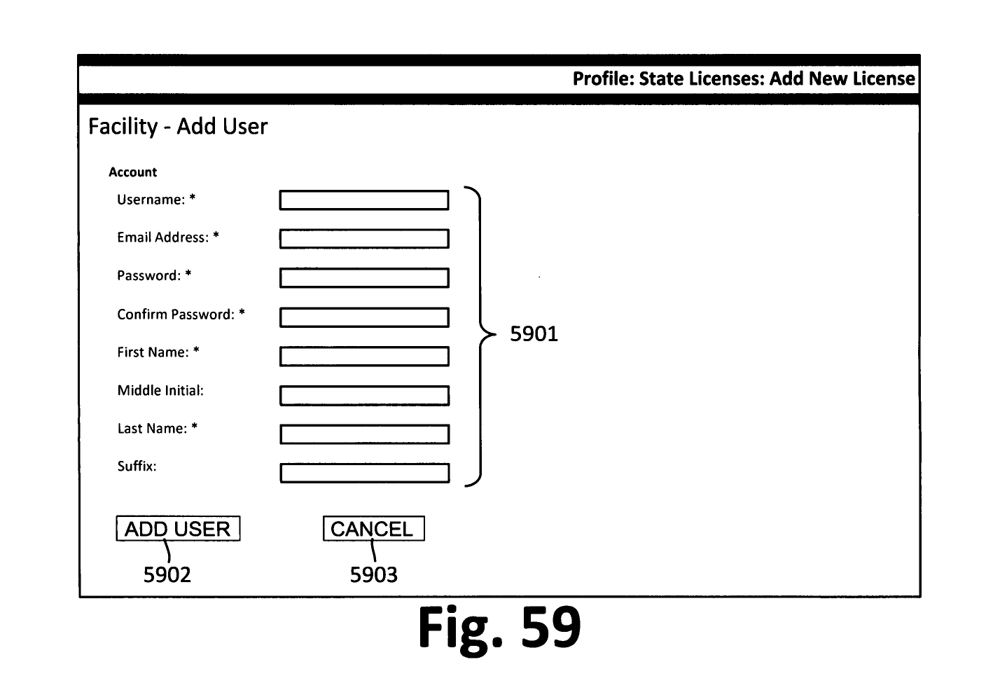

FIG. 58 is the “settings: users screen” that presents a table for managing the authorized users and roles for the personnel at the facility 5801. This table 5801, lists the username 5802, email address 5803, role 5804, and the last date and time of login 5805, for each user authorized to access information for the purchasing facility through the purchasing facility interface. A purchasing facility administrator can add technologists and administrative users using a link to “Add New User” 5806, which takes the purchasing facility administrator to the “add new user” screen shown in FIG. 59. The “add new user” screen allows the facility administrator to add a username, email address, password, confirm password, and complete name for new users 5901. Buttons to add additional users 5902 and cancel 5903 are provided.

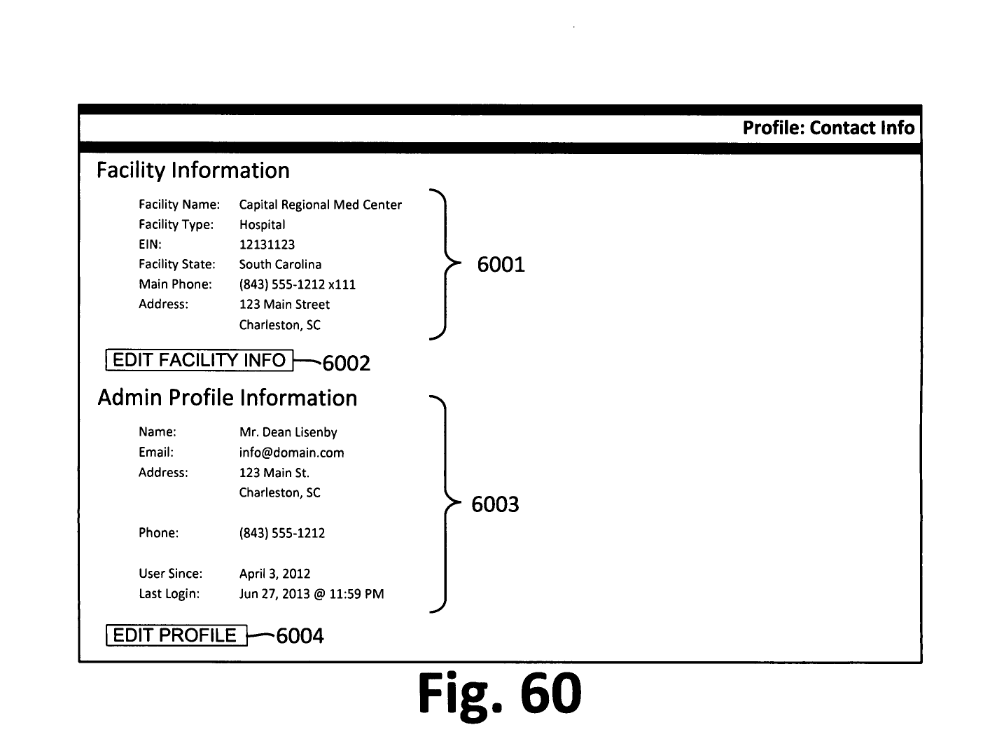

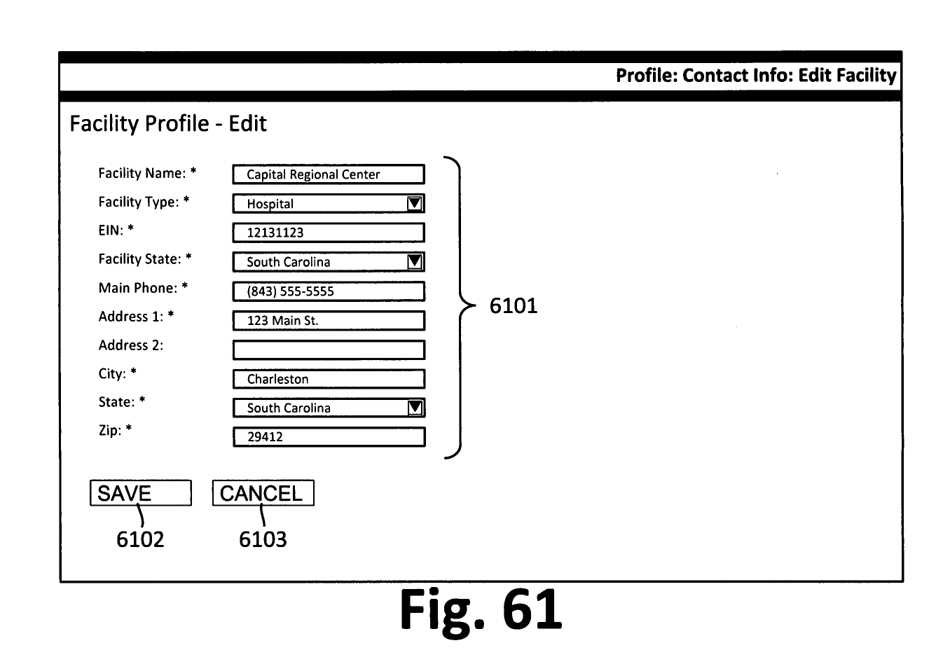

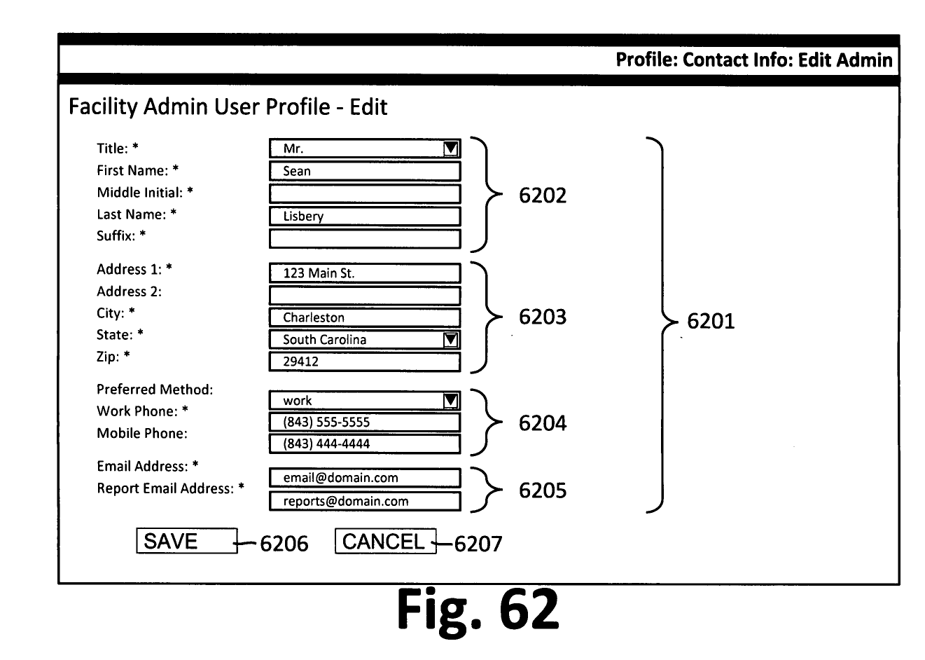

FIG. 60 is the “profile: contact info” screen where a purchasing facility administrator can see the facility information 6001 and click a link 6002 if this information needs to be edited. This edit link 6002 takes the purchasing facility administrator to the “profile: contact info: edit facility” screen showing in FIG. 61 where the purchasing facility administrator can see and edit the facility profile information 6101, save the new data 6102, or cancel 6103 to return to the “profile: contact info” screen of FIG. 60. Further referring to the “profile: contact info” screen of FIG. 60, the purchasing facility administrator can see the admin profile information 6003 and click a link 6004 if this profile information needs to be edited, which takes the purchasing facility administrator to the “profile: contact info: edit admin” screen shown in FIG. 62 where the purchasing facility administrator can see and edit the facility admin user profile information, shown at 6201/6202/6203/6204/6205, and save the new data 6206, or cancel 6207 to return to the “profile: contact info” screen of FIG. 60.

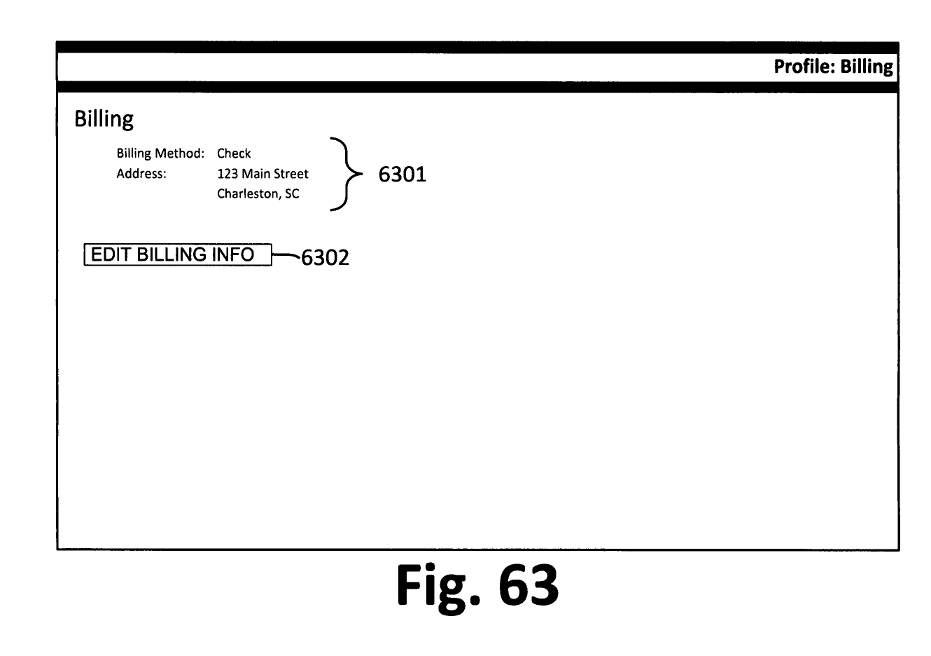

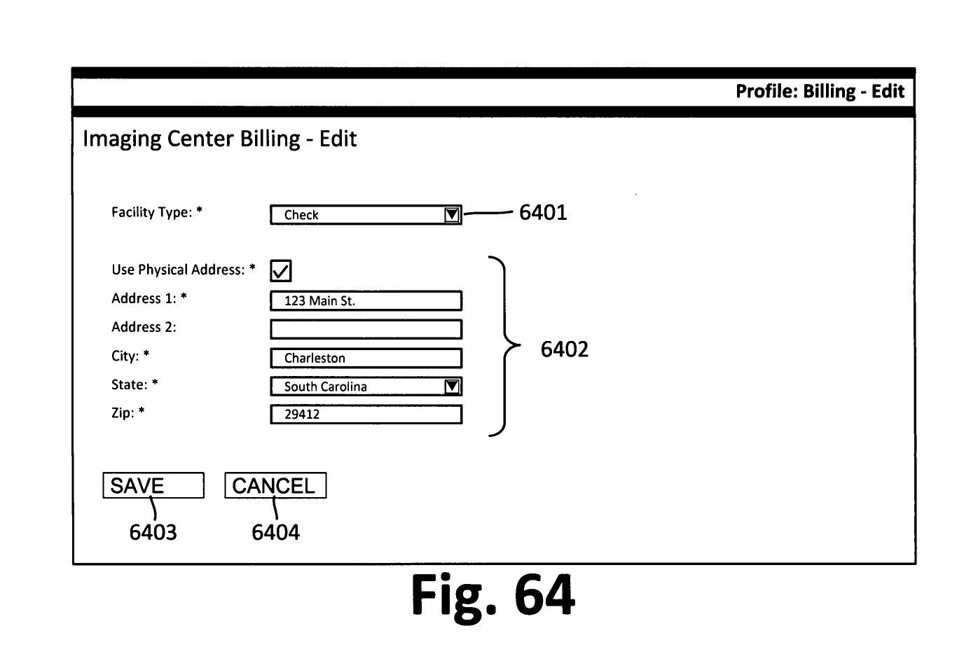

FIG. 63 is the “profile: billing” screen where the purchasing facility administrator can see the facility's current billing information 6301 and edit it 6302, which takes him/her to the “profile: billing—edit” screen shown in FIG. 64, where he/she can edit: the whether the purchasing facility wishes to pay by check, credit card, electronic draft, or other method (6401); and the purchasing facility's physical address (6402). Save 6403 and cancel 6404 buttons are also provided on the “profile: billing—edit” screen.

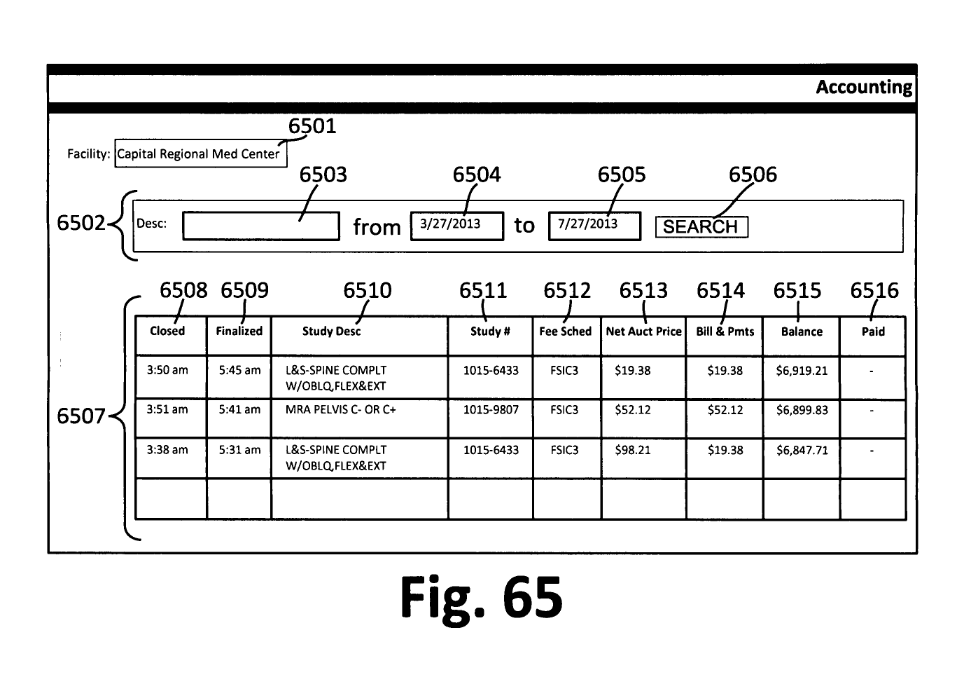

FIG. 65 is the “accounting” screen for the purchasing facility. This “accounting” screen is similar to the “my bid status: finalized” screen that was described with reference to FIG. 32 for the reader (medical image interpreter). The “accounting” screen in FIG. 65 shows the facility's name (6501). It includes an area for searching (6502) that includes a search box to search for studies (medical image exams) of a particular description 6503, within a date range, shown at 6504 and 6505, and includes a search button 6506. The search yields a list of studies (medical image exams) 6507, each of which can have the time each auction closed 6508, the time each written report was signed 6509, a description of each study (medical image exam) 6510, an identifying number fore each study (medical image exam) 6511, which fee schedule is being applied 6512, the net auction price 6513, bills and payments 6514, the outstanding balance 6515, and a column to indicate whether payments have been made 6516.

FIG. 66 through FIG. 74 provide details of functionality that can be available to system administrators, responsible for maintaining the auction software system. The system administrators have numerous tools to monitor and control workflow and accounting capabilities. When readers (medical image interpreters) report problems on studies (medical image exams), as was discussed with reference to FIG. 31, these problems are tabulated on an “administration: quality control” screen shown in FIG. 66. The “administration: quality control” screen can include fields for filtering the problem list 6601, and these fields for filtering the problem list 6601 can show the number of problems pending 6602, as well as having a drop-down box for the different types of problems 6603, a capability to searching by date range, shown at 6604 and 6605, a capability to search by identification number 6606 and by facility number 6607, and a search button 6608 to execute the desired search. Clicking the search button 6608 produces a table 6609 based on the search information that lists the studies (medical image exams) and associated information, shown in 6610 to 6618. For most problem studies (medical image exams), the system processes or reroutes the studies (medical image exams) automatically. All of the problems reported generate an automatic email to the facility administrator and are tabulated in a database for regular reporting. For each study (medical image exam), readers (medical image interpreters) have a certain amount of time to report the study (medical image exam) and then a certain amount of time to sign the study (medical image exam) once it is transcribed. These times are different based on the priority (stat, ASAP, routine, etc.). If the reader (medical image interpreter) does not do the work in the allotted time, his/her ability to bid on studies (medical image exams) is automatically suspended by the system and a “reader failed to deliver” can be displayed on the appropriate screens. In addition, if a study (medical image exam) is not reported on time, it is unassigned from the reader and re-auctioned automatically. If a study (medical image exam) is sent to the PACs with incomplete electronic data, this is also flagged on the administrator screen.

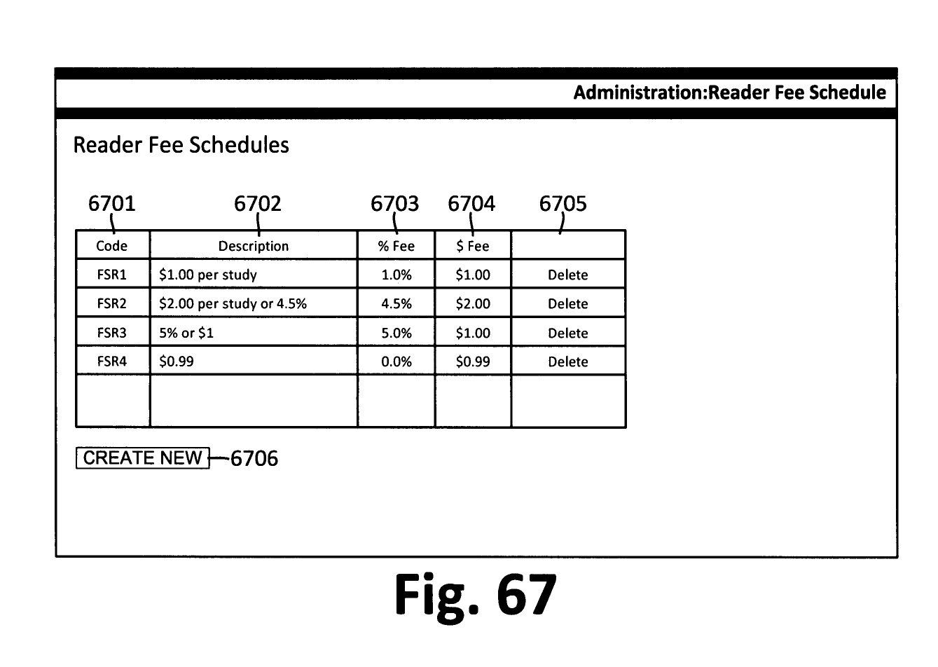

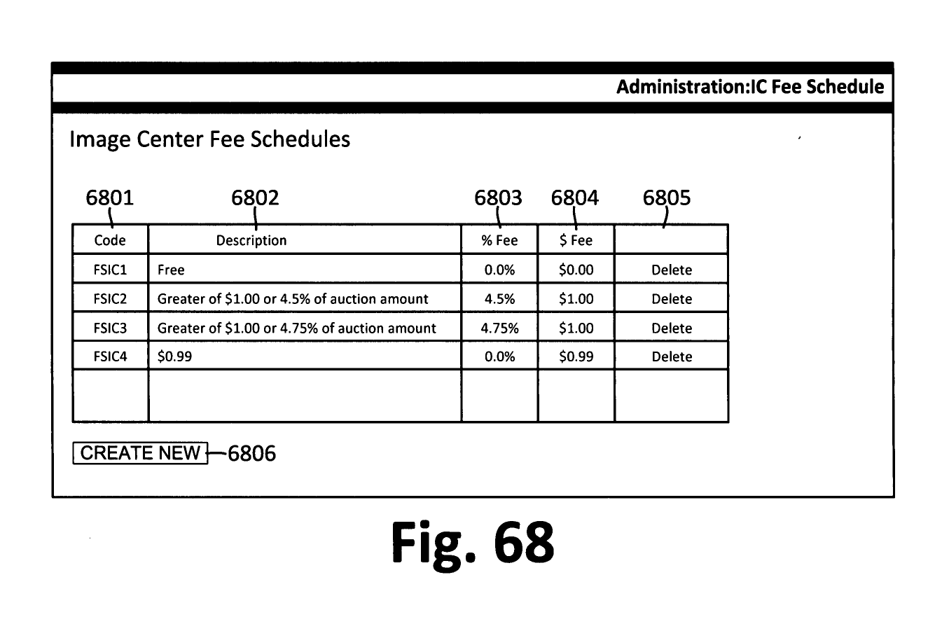

FIG. 67 shows an “administration: reader fee schedule” screen that allows a system administrator to set the auction fee schedule for readers (medical image interpreters) and FIG. 68 shows an “administration: image center fee schedule screen” that allows a system administrator to set the auction fee schedule for purchasing facilities. Referring to FIG. 67 and FIG. 68, a different fee schedule can be set for each reader and each facility, as shown at 6701 and 6801. Each fee schedule can be listed as a code, as shown at 6701 and 6801, followed by a description, shown at 6702 and 6802. Each fee schedule can be calculated as a percent of the auction price, shown at 6703 and 6803, or as a fixed amount, shown at 6704 and 6804, whichever is higher. Other fee schedule formulas could be used, that are capable of being understood by anyone skilled in the art. Unneeded fee schedules can be deleted, as shown at 6705 and 6805, and a system administrator can adding new fee schedules, as shown at 6706 and 6806.

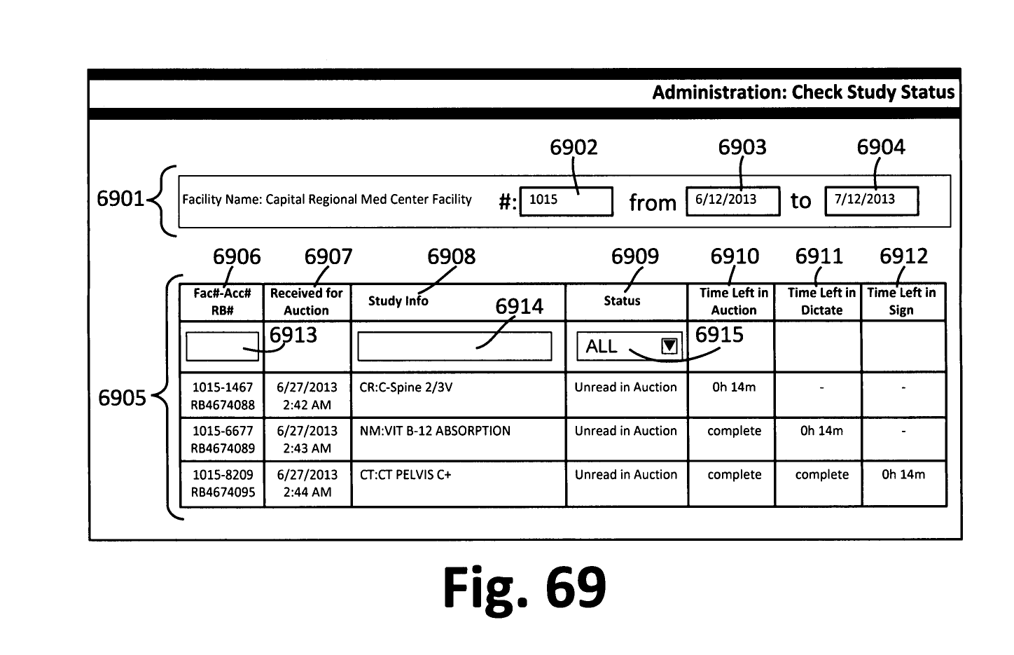

FIG. 69 shows that the system administrator can check the status of each study (medical image exam) on the system for each facility using an “administration: check study (medical image exam) status” screen that is similar to the “check study (medical image exam) status” described with reference to FIG. 54. The “administration: check study (medical image exam) status” screen can include a filter box 6901, that allows for searching by facility number and date, as shown at 6902 to 6904, which yields a table 6905 that shows study (medical image exam) information, status, and timer data, shown at 6906 to 6915. Note that studies (medical image exams) can be searched with the facility and facilities accession number along with the system number 6913 or with the study (medical image exam) description 6914.

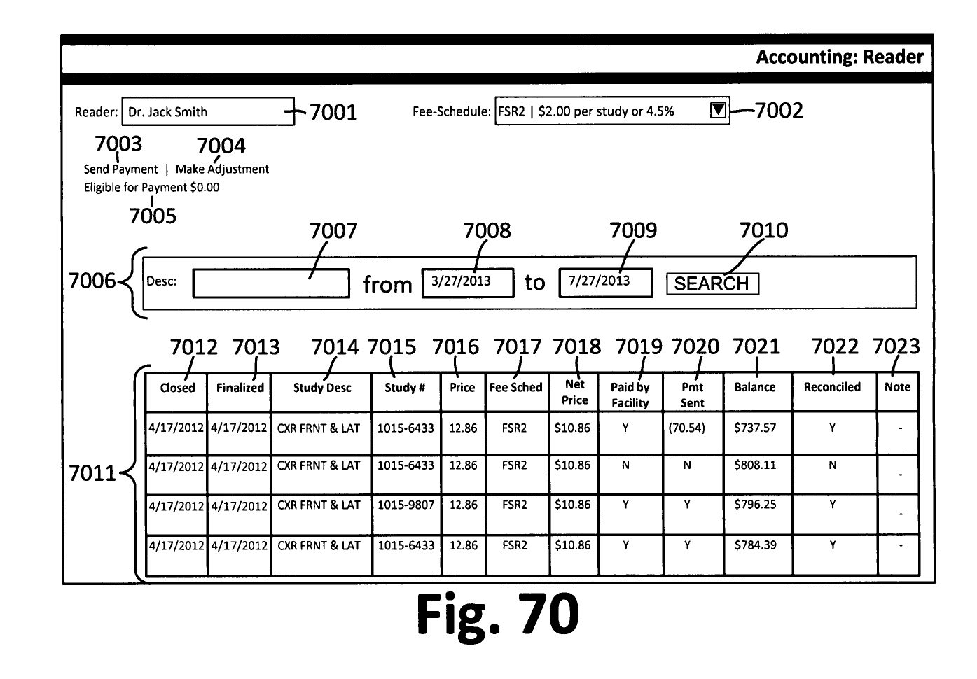

FIG. 70 shows an “accounting: reader” screen that allows a system administrator to search for 7001 and determine how much money is owed to each reader (medical image interpreter) 7005. This screen allows the fee schedule 7002 to be can be changed. There are buttons for sending payments 7003 and making adjustments to the balance 7004. There are additional search fields 7006 allow for a search by study (medical image exam) description/number 7007, date range 7008-7009, and a search button 7010. The search yields a table 7011 with data on each study (medical image exam), shown at 7012 to 7023. The data in this table 7011 can be matched to payments made by the facilities on a study (medical image exam)-by-study (medical image exam) basis 7019. Matching the payments ensures that the readers (medical image interpreters) are not paid until the facility has paid for the service. Each study (medical image exam) completed by the reader (medical image interpreter) is listed as well as the date/time completed and the time it was auctioned. Payments can also be reconciled 7022 and notes can be added by date 7023.

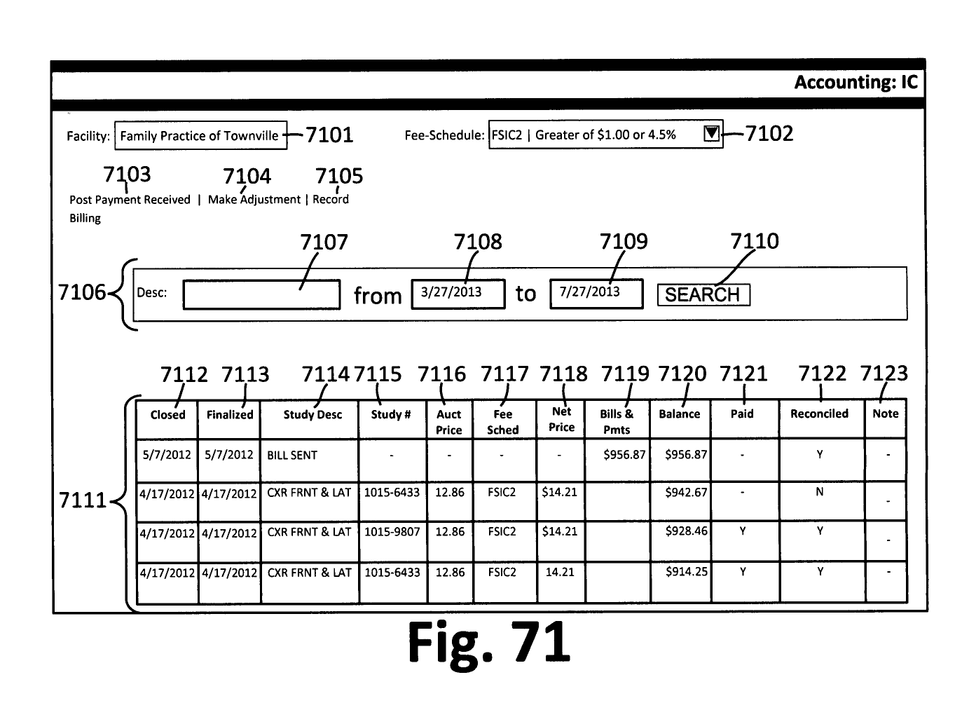

FIG. 71 shows an “accounting: image center facility” screen that allows the system administrator to determine how much money is to be billed to each facility by tabulating the auction amount and fees from each study (medical image exam) and is similar to the “accounting: reader” screen described with reference to FIG. 70. The screen “accounting: image center facility” can first be filtered by the name of the facility 7101. The fee schedule can be changed 7102, payments received can be posted 7103, adjustments can be made 7104, and bills recorded 7105. There is a filter box 7106 that can be used to filters by study (medical image exam) description/number 7107, date range 7108-7109, and a search button 7110. The search yields a table 7111 with data on each study (medical image exam) and can include the fields shown in 7112 to 7123.

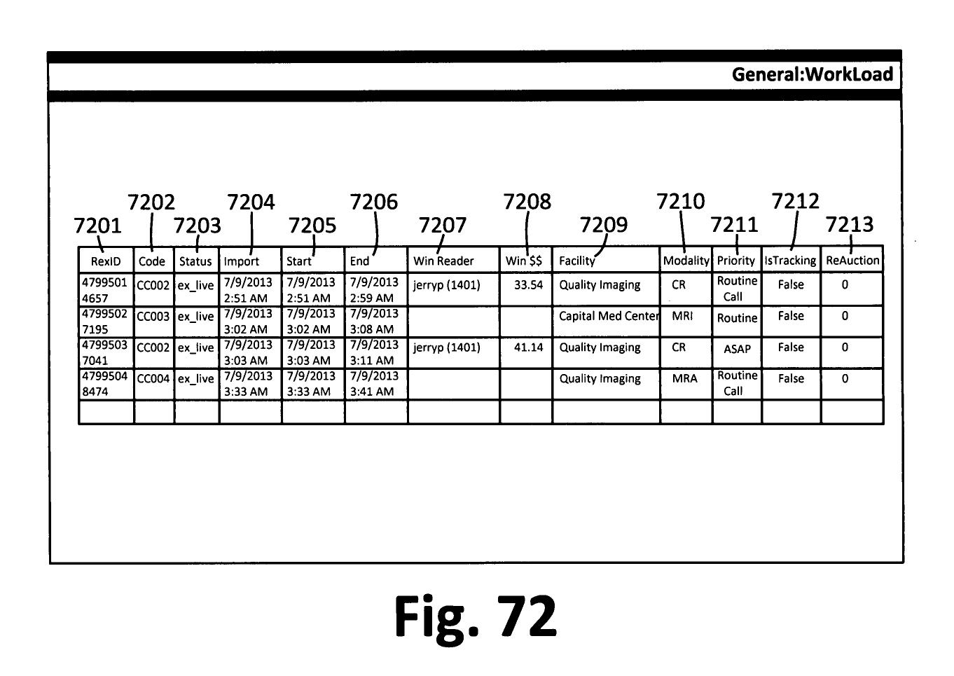

FIG. 72 is a “general: workload” screen and that lists each study (medical image exam) being tracked through the system, displaying the ID number 7201, code such as CPT 7202, status 7203, date and time the study (medical image exam) was imported 7204, start time 7205, end time 7206, name and phone number of winning reader (medical image interpreter) 7207, auction amount 7208, facility name 7209, modality 7210, priority 7211, if the study (medical image exam) is still being tracked 7212, whether/how many times the study (medical image exam) was re-auctioned 7213.

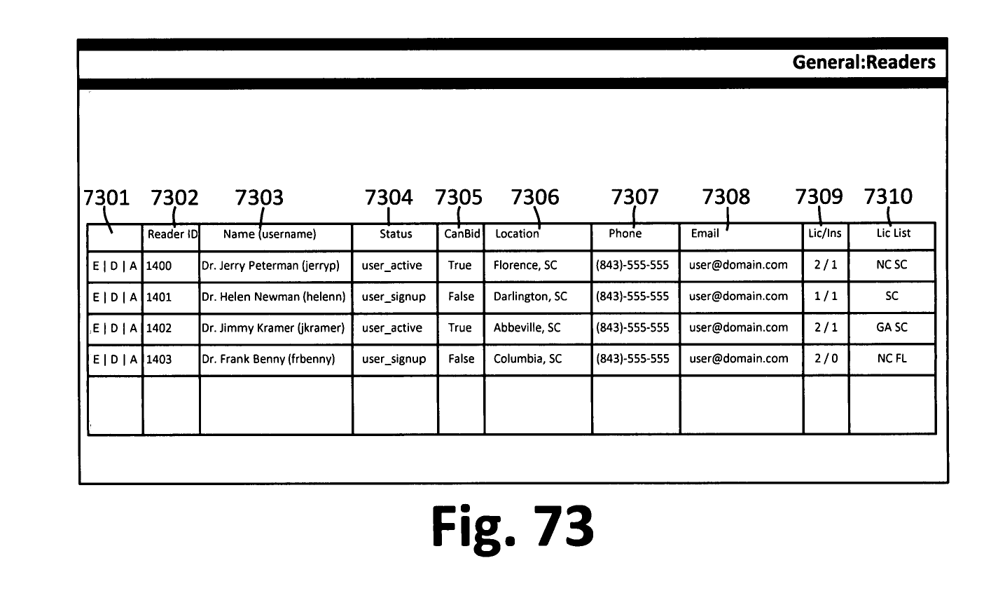

FIG. 73 lists each reader (medical image interpreter) that has signed up on the system and allows his/her profile information to be viewed and edited 7301 by a system administrator. This “general: readers” screen shows the ID number 7302, name/username 7303, status 7304, whether or not they are allowed to bid 7305, location 7306, phone number 7307, email address 7308, number of licenses 7309, insurance 7309, and licensed states 7310 for each reader (medical image interpreter) in the system.

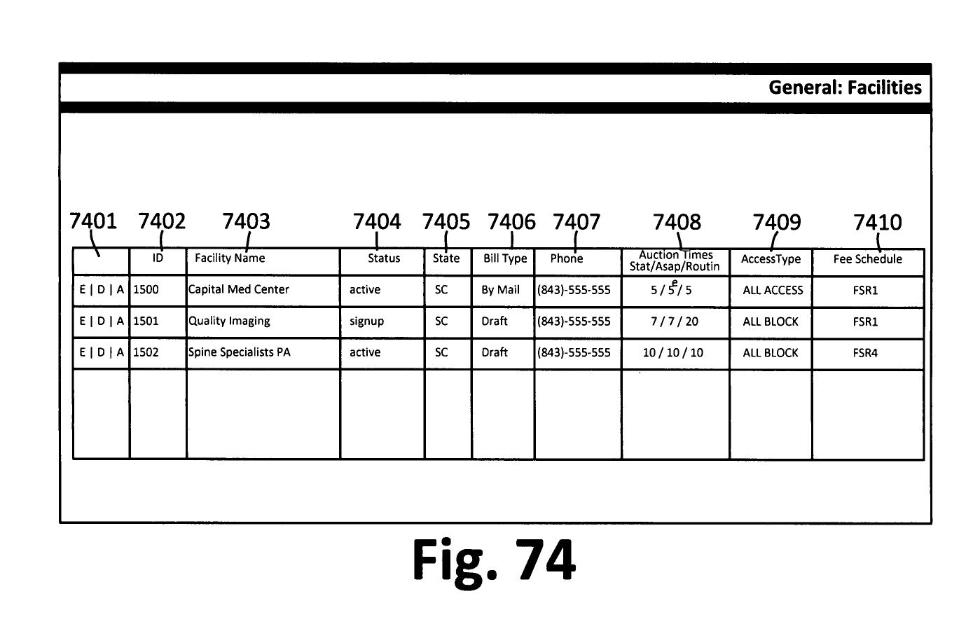

FIG. 74 lists each purchasing facility that has signed up on the system and allows key purchasing facility information to be viewed and edited 7401 by a system administrator. This “general: facilities” screen is similar to the “general: readers” screen described with reference to FIG. 73 and shows the facility ID number 7402, facility name 7403, status 7404, location 7405, billing type 7406, phone number 7407, auction times 7408, access type 7409, and fee schedule 7410 for each purchasing facility in the system.

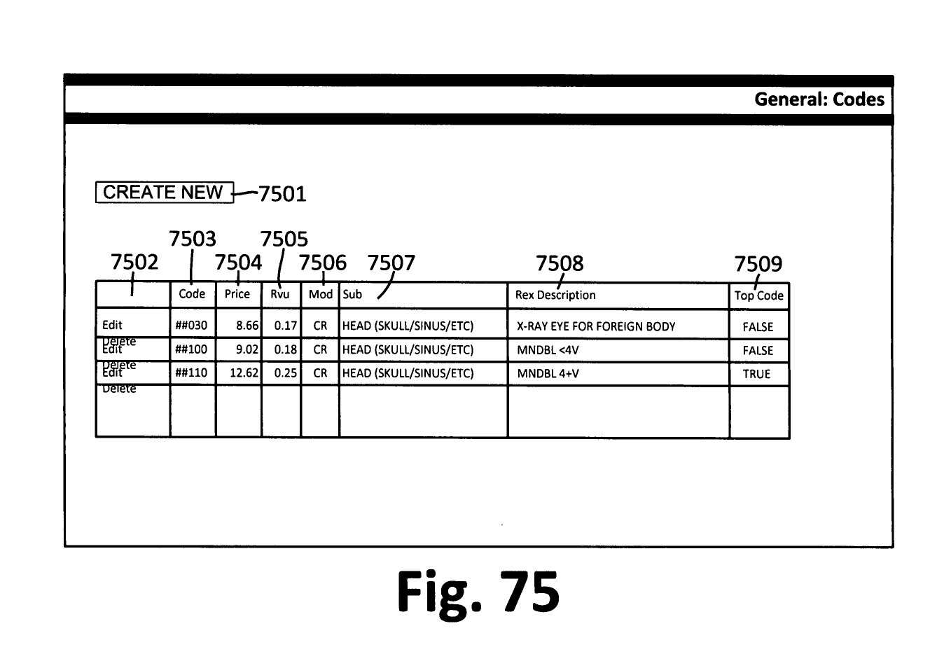

FIG. 75 is a list of every study (medical image exam) type/code on the system. This “general: codes” screen includes a button for creating new codes 7501. In the embodiment shown in FIG. 75, the codes are CPT codes, but these codes could be any unique identifier. Custom codes can also be created as combinations of multiple individual codes so that studies (medical image exams) that are typically performed and reported together can also be auctioned together. The “general: codes” screen allows each code to be edited or deleted individually, as shown in 7502. For each code the screen lists the code number 7503, reference price 7504, RVU (relative value units) 7505, modality 7506, sub modality 7507, description 7508, and whether or not it is a frequently used code (labeled as “top code”) 7509. If a technologist or other purchasing facility user enters two codes together that are not already assigned to a custom code, a custom code is automatically generated. The “general: custom codes” screen, shown in FIG. 76, allows for the entering of new custom codes 7601, the editing of custom codes 7602, the listing of all the custom codes 7603, and whether or not the custom codes were manually entered or automatically generated by the system. In addition the “general: custom codes” screen, shown in FIG. 76, lists the custom code number 7603, index (which is the combination of underlying codes) 7604, and date and time of creation 7605, and any associated notes 7606.

In the foregoing specification, the invention has been described with reference to specific embodiments thereof. However, various modifications and changes may be made thereto without departing from the broader spirit and scope of the invention. The specification and drawings are, accordingly, to be regarded in an illustrative sense rather than a restrictive sense.

We claim:

1. A computer-implemented client-server medical image interpretation services auction management system, the system comprising:
a database on a server comprising:
medical procedure value data that relates medical codes to workload values;
a work data storage element suitable for storing a plurality of work data records wherein a work data record comprises:
a medical image interpreter identifier storage element; and
medical image exam meta data, wherein the exam meta data comprises:
an exam meta data identifier;
a medical code;
a purchasing facility identifier; and
image exam status data;
a medical image interpreter data storage element suitable for storing interpreter meta data for a plurality of medical image interpreters, the interpreter meta data comprising an image interpreter identifier;
a first bid data storage element suitable for storing bids from a plurality of medical image interpreters;
a first interface wherein the first interface is suitable for receiving the exam meta data;
a second interface suitable for use by a plurality of medical image interpreters on a plurality of client computers wherein the second interface comprises:
a medical image interpreter meta data input form presented on an electronic display wherein the interpreter meta data input form can be used to enter the interpreter meta data into the database;
a first bid information input form presented on an electronic display wherein the first bid information input form can be used to enter a bid parameter into the database;
a means for submitting a medical image interpreter workload limit;
a workload calculator wherein the workload calculator uses the medical procedure value data to compute a medical image interpreter projected workload in response to the workload values associated with the medical codes for work data records where:
the medical image interpreter storage element contains the medical image interpreter identifier; and
the medical image exam status data indicates that image interpretation work is incomplete;
a communications controller suitable for electronic transmission of data between the database, the first interface, and the second interface; and
a bid manager that places a bid into the first bid storage element in response to the bid parameter submitted through the second interface if a medical image examiner projected workload is less than the medical image examiner workload limit.

2. The system of claim 1 wherein:
the medical code comprises a current procedural terminology code;
the workload value comprises a value responsive to the relative value units maintained by the American Medical Association;
the purchasing facility is selected from the group of a hospital, a medical imaging center, and a doctor's office;
the medical image interpreter is selected from the group of a radiologist, a pathologist, and a dermatologist; and
the medical image interpreter is certified to interpret an image selected from the group of an x-ray image, a digital radiography image, an ultrasound image, a magnetic resonance image, a positron emission tomography image, a computed tomography image, an endoscopy image, a mammogram, a nuclear medicine image, a computed radiography image, and a digital image.

3. The system of claim 1 wherein:
the work data record further comprises an auction start time and the database further comprises an auction duration storage element whereby an auction expiration time for a work data record can be calculated by adding the value stored in the auction duration storage element to the auction start time;
the database further comprises a medical image exam work duration limit;
the system further comprises:
an auction monitor responsive to a comparison of the current time with the auction expiration time;
a winning bid selector configured to:
pick a winning bid for the work data record in response to the auction monitor and in response to information stored in the first bid storage element;
add the medical image examiner identifier associated with the winning bid into the medical image examiner identifier storage element; and
add a work start time to the work data record; and
an exam interpretation status monitor wherein the exam interpretation status monitor:
connects through the first interface to a picture archive communication system;
receives image exam status data from the picture archive communication system wherein the image exam status data comprises image exam interpretation completion status information:
finds overdue work data records in response to the image exam interpretation completion status information, the work start time, the medical image exam work duration limit, and the current time; and
changes the data stored in the medical image examiner storage element of a work data record if the work data record is an overdue work data record.

4. The system of claim 1, wherein:
the second interface further comprises a means for entering a medical image interpreter time limit; and
the bid manager places bids in response to the medical image interpreter time limit;
whereby a medical image interpreter can specify the amount of time the bid manager automatically bids to generate work for the medical image interpreter.

5. The system of claim 1, wherein:
the medical procedure value data further comprises reference prices;
the first bid information input form comprises:
a medical code, a workload value, and a reference price wherein the medical code, the workload value, and the reference price are responsive to the medical procedure value data;
a price adjustment factor input field;
a bid parameter display field wherein the bid parameter display field is responsive to the bid adjustment factor input field and the reference price;
the second interface directly places the bid parameter into a second bid storage element in the database; and
the bid manager automatically places the bid into the first bid storage element in response to a comparison of the medical code stored in a work data record and the medical code stored with the bid parameter.

6. The system of claim 1, wherein:
the database further comprises a purchasing facility location identifier comprising a state identifier whereby a work data record can be identified as originating from a specific US state;
the medical image interpreter meta data further comprises an image interpreter licensure information whereby a medical image interpreter can be identified as being licensed to practice medical interpretation services for medical images originating from a specific US state;
the system further comprises a state licensure filter whereby a medical image interpreter is prevented from bidding on a medical image exam originating in a state wherein the medical image interpreter is not licensed.

7. The system of claim 6, wherein:
the medical procedure value data further comprises reference prices and the reference prices are responsive to the reimbursement rates established by the US Medicare program;
the first bid information input form comprises:
work data record information wherein the work record data information is responsive to the state licensure filter and the work data record information comprises a medical code;
a workload value for the medical code wherein the workload value is responsive to the workload value for the medical code that is stored in the medical procedure value data;
a comparative price value for the medical code wherein the comparative price value is responsive to the comparative price value for the medical code that is stored in the medical procedure value data; and
a direct bid input field;
whereby a medical image interpreter can directly place a bid into the first bid storage element.

8. The system of claim 6, wherein:
the bid parameter is a default bid amount for a medical code;
the bid parameter is placed into a second bid storage element in the database; and
the bid manager automatically places the bid into the first bid storage element in response to:
a comparison of the medical code stored with the exam meta data and the medical code stored with the bid parameter; and
the state licensure filter.

9. The system of claim 8, wherein the second interface further comprises a second bid information input form wherein the second bid information input form comprises:
work data record information wherein the work record data information is responsive to the state licensure filter and the work data record information comprises a medical code;
a workload value for the medical code in the medical record data information wherein the workload value is responsive to the workload value for the medical code that is stored in the medical procedure value data; and
a direct bid input field;
whereby a medical image interpreter can directly place a bid into the first bid storage element.

10. The system of claim 9 wherein:
the medical image exam meta data further comprises:
a modality identifier wherein the modality identifier comprises an imaging device identifier and sub modality data wherein the sub modality data comprises a part of the human body;
an urgency identifier whereby a medical image interpreter can determine whether the image interpretation work needs to be completed immediately; and
a phone results indicator whereby a medical image interpreter can determine whether the medical image exam results must be phoned to a purchasing facility;
the medical image interpreter meta data further comprises:
a government identification number selected from the group of a Social Security Number and a US Employer ID;
contact information selected from the group of a phone number and an address;
insurance information further comprising a malpractice insurance policy number; and
certification information further comprising medical board certification information and Joint Commission on the Accreditation of Healthcare Organizations certification information;
the database further comprises purchasing facility meta data wherein the purchasing facility meta data further comprises:
a government identification number selected from the group of a Social Security Number and US Employer ID;
contact information selected from the group of a phone number and an address;
billing information further comprising a billing address;
payment information further comprising payment terms;
time information comprising an auction duration and a work duration limit whereby the auction duration and the work duration limit can be separately specified for work data records wherein the urgency identifier specifies that work must be completed immediately and for work data records wherein the urgency identifier specifies that work does not need to be completed immediately;
medical image examiner certification requirements further comprising medical board certification requirements and Joint Commission on the Accreditation of Healthcare Organizations certification requirements; and
pricing information; and
the system further comprises a third interface suitable for use by a plurality of purchasing facilities on a plurality of client computers wherein the third interface comprises a purchasing facility meta data input form presented on an electronic display whereby the facility meta data input form can be used to enter the purchasing facility meta data into the database.

11. The system of claim 1 wherein:
the work data record further comprises an auction start time and the database further comprises an auction duration storage element whereby an auction expiration time for a work data record can be calculated by adding the value stored in the auction duration storage element to the auction start time;
the system further comprises:
an auction monitor responsive to a comparison of the current time with the auction expiration time; and
a winning bid selector configured to:
pick a winning bid for the work data record in response to the auction monitor and in response to information stored in the first bid storage element; and
add the medical image examiner identifier associated with the winning bid into the medical image examiner identifier storage element in the work data record;
the database further comprises a problem data storage location suitable for storing problem data wherein the problem data comprises a problem type identifier and a problem description;
the second interface further comprises a problem reporting input form wherein the problem reporting form can be used to enter the problem data into the database; and
a problem manager wherein the problem manager is responsive to the problem type.

12. The system of claim 1 further comprising a code input form presented on an electronic display wherein:
an authorized system user can enter a medical code, a medical code description, and a workload value; and
the information stored in the medical procedure value data is responsive to the code input form.

13. The system of claim 1 wherein the second interface further comprises a filter studies input module whereby a medical image interpreter can select the work data records to be displayed by the second interface based on a filter criterion selected from the group of a modality, and a sub modality.

14. A method for auctioning medical image interpretation services, the method comprising the steps of:
establishing an electronic database comprising:
a medical procedure value table that associates medical codes and workload values;
a medical image interpreter data table that associates medical image interpreter names and unique medical image interpreter identifiers;
work data records comprising:
a medical procedure code;
a medical image interpreter identifier;
a work status code;
computing a first medical image interpreter workload by using a first unique medical image interpreter identifier for a first medical image interpreter to look up and add the associated workload values for all work data records wherein:
the work status code indicates that the medical image interpretation service has not been completed; and
the medical image interpreter identifier is the first unique medical image identifier;
computing a second medical image interpreter workload by using a second unique medical image interpreter identifier for a second medical image interpreter to look up and add the associated workload values for all work data records wherein:
the work status code indicates that the medical image interpretation service has not been completed; and
the medical image interpreter identifier is the second unique medical image identifier;
receiving a medical image interpretation services request wherein the medical image interpretation services request comprises a request identifier and a medical code;
placing a first bid in response to:
the medical code in the medical image interpreter services request;
a first medical image interpreter workload; and
a workload limit;
placing a second bid in response to:
the medical code in the medical image interpreter services request;
a second medical image interpreter workload; and
a workload limit;
selecting a best bid in response to the first bid and the second bid;
storing the unique medical image interpreter identifier associated with the best bid into a work data record wherein the work data record further comprises the request identifier and the medical code from the received medical image interpretation services request.

15. The method of claim 14 wherein:
receiving further comprises receiving an urgency identifier;
selecting is responsive to an auction time monitor wherein the auction time monitor is responsive to:
a time when a medical image services request is received; and
an auction duration, and the auction duration is responsive to the urgency identifier.

16. The method of claim 14 wherein:
establishing an electronic database further comprises establishing a purchasing facility data table wherein the purchasing facility data table further comprises image interpreter certification requirements;
establishing a medical image interpreter data table further comprises establishing medical image interpreter certification information; and
placing a first bid and placing a second bid are responsive to the image interpreter certification requirements and the medical image interpreter certification information.

17. The method of claim 14 wherein:
establishing a medical image interpreter data table further comprises establishing malpractice insurance information; and
placing a first bid and placing a second bid are responsive to the malpractice insurance information.

18. The method of claim 14 further comprising the step of receiving a medical image interpreter blocking request from a purchasing facility whereby the medical image interpreter blocking request comprises a list selected from the group of:
a list of blocked medical image interpreters; and
a list of unblocked medical image interpreters;
whereby placing a first bid and placing a second bid are responsive to the medical image interpreter blocking request.

19. A computer program stored on a computer readable memory and adapted to be executed on a processor wherein the computer program performs the following actions:
electronically connecting to:
a medical procedure value table that associates medical codes and workload values;
a medical image interpreter data table that associates medical image interpreter names and unique medical image interpreter identifiers;
work data records comprising:
a medical procedure code;
a medical image interpreter identifier;
a work status code;
computing a first medical image interpreter workload by using a first unique medical image interpreter identifier for a first medical image interpreter to look up and add the associated workload values for all work data records wherein:
the work status code indicates that the medical image interpretation service has not been completed; and
the medical image interpreter identifier is the first unique medical image identifier;
computing a second medical image interpreter workload by using a second unique medical image interpreter identifier for a second medical image interpreter to look up and add the associated workload values for all work data records wherein:
the work status code indicates that the medical image interpretation service has not been completed; and
the medical image interpreter identifier is the second unique medical image identifier;
receiving a medical image interpretation services request wherein the medical image interpretation services request comprises a request identifier and a medical code;
placing a first bid in response to:
the medical code in the medical image interpreter services request;
a first medical image interpreter workload; and
a workload limit;
placing a second bid in response to:
the medical code in the medical image interpreter services request;
a second medical image interpreter workload; and
a workload limit;
selecting a best bid in response to the first bid and the second bid;
storing the unique medical image interpreter identifier associated with the best bid into a work data record wherein the work data record further comprises the request identifier and the medical code from the received medical image interpretation services request.

20. The computer program of claim 19 wherein receiving a medical image interpretation services request comprises receiving a medical image interpretations services request from a picture archive communication system using an encrypted connection using a cryptographic method selected from the group of Transport Layer Security and Secure Sockets Layer.
